(19) United States
(12) Patent Application Publication
(10) Pub. No.: US 2017/0289191 A1
(43) Pub. Date: Oct. 5, 2017

(54) Infiltration Detection and Network Rerouting

(71) Applicant: Acalvio Technologies, Inc., Cupertino, CA (US)

(72) Inventors: Emmanuel Thioux, Santa Cruz, CA (US); Abhishek Singh, Morgan Hill, CA (US)

(73) Assignee: Acalvio Technologies, Inc., Cupertino, CA (US)

(21) Appl. No.: 15/438,573

(22) Filed: Feb. 21, 2017

Related U.S. Application Data
(60) Provisional application No. 62/315,920, filed on Mar. 31, 2016.
(60) Provisional application No. 62/364,723, filed on Jul. 20, 2016.
(60) Provisional application No. 62/344,267, filed on Jun. 1, 2016.

(51) Int. Cl. H04L 29/06; H04L 12/707

(52) U.S. Cl. CPC H04L 63/1441; H04L 63/1416; H04L 63/1491; H04L 63/10; H04L 45/22

(57) ABSTRACT

Provided are methods, network devices, and computer-program products for detecting infiltration of an endpoint, and rerouting network traffic to and from the endpoint when infiltration is detected. In various implementations, a network device on a network can be configured to monitor access to the network device. The network device can further be configured to determine that a condition has occurred. The condition can indicate a suspect access to the network device has occurred. The network device can further be configured to determine a new access protocol for the network device. The network device can further be configured to use the new access protocol to cause communication between the network device and the network to be redirected to a high-interaction network. Redirecting the communication can disable communication between the network device and the network and enables communication between the network device and the high-interaction network.

### CROSS REFERENCES TO RELATED APPLICATIONS

This application claims the benefit of U.S. Provisional Application No. 62/315,920, filed on Mar. 31, 2016; U.S. Provisional Application No. 62/364,723, filed on Jul. 20, 2016; and U.S. Provisional Application No. 62/344,267, filed on Jun. 1, 2016; each of which are incorporated herein by reference in their entirety.

### BRIEF SUMMARY

Network security tools generally protect a site's network by identifying legitimate network packets and questionable network packets. Analyzing suspect network traffic may provide information about an effect the associated packets may have on a network. This information may be useful for determining whether a site's network has already been infiltrated and harmed. This information can also be used to strengthen existing network defenses. This information can also confirm whether suspect network traffic is truly harmful, or whether the suspect network traffic is actually innocent.

Provided are methods, network devices, and computer-program products for detecting infiltration of an endpoint, and rerouting network traffic to and from the endpoint when infiltration is detected. In various implementations, a network device on a network can be configured to monitor access to the network device. The network device can further be configured to determine that a condition has occurred. The condition can indicate a suspect access to the network device has occurred. The network device can further be configured to determine a new access protocol for the network device. The network device can further be configured to use the new access protocol to cause communication between the network device and the network to be redirected to a high-interaction network. Redirecting the communication can disable communication between the network device and the network and enables communication between the network device and the high-interaction network.

In various implementations, decoy data can also be configured for the network device. The decoy data can include a file, a directory, a link, or an application. The decoy data can be associated with a high-interaction network, such that an access to the decoy data is redirected to data in the high-interaction network.

In various implementations, determining that a condition has occurred includes receiving a message over the network. In some implementations, the condition includes modification of an access privilege, where the modification increases the access privilege. In some implementations, the condition includes use of decoy data, where the decoy data is on the network device. In some implementations, the condition includes installation of an unauthorized tool on the network device. In some implementations, the condition includes remote execution of code to gain access to the network device.

In various implementations, determining the new access protocol includes receiving the new access protocol over the network. In some implementations, an access control controls external access to the network device. In some implementations, an access control controls access by the network device to the network.

In various implementations, causing the communication between the network device and the network to be redirected includes directing a network interface of the network device to redirect the communication. In various implementations, causing the communication between the network device and the network to be redirected includes transmitting a request from the network device, the request including instructions to redirect the communication.

### BRIEF DESCRIPTION OF THE DRAWINGS

Illustrative embodiments are described in detail below with reference to the following figures:

FIG. 1 illustrates an example of a network threat detection and analysis system, in which various implementations of a deception-based security system can be used;

FIGS. 2A-2D provide examples of different installation configurations that can be used for different customer networks;

FIG. 3A-3B illustrate examples of customer networks where some of the customer networks' network infrastructure is “in the cloud,” that is, is provided by a cloud services provider;

FIG. 4 illustrates an example of an enterprise network;

FIG. 5 illustrates a general example of an Internet-of-Things network;

FIG. 6 illustrates an example of an Internet-of-Things network, here implemented in a private home;

FIG. 7 illustrates of an Internet-of-Things network, here implemented in a small business;

FIG. 8 illustrates an example of the basic operation of an industrial control system;

FIG. 9 illustrates an example of a SCADA system, here used for distributed monitoring and control;

FIG. 10 illustrates an example of a distributed control;

FIG. 11 illustrates an example of a PLC implemented in a manufacturing control process;

FIG. 12 illustrates an example of a deception center;

FIG. 13 illustrates examples of the data that may be collected over the course of an incident from processes and monitoring tools analyzing suspect network traffic in a emulated network;

FIG. 14 illustrates an example of the operations of an analytic engine;

FIG. 15 illustrates an example of a network protocol analysis engine;

FIG. 16 illustrates an example of a web-based network protocol analysis engine;

FIG. 17 illustrates an example of a file activity analysis engine;

FIG. 18 illustrates an example of a log file analysis engine;

FIG. 19 illustrates an example of the order or sequence in which analysis engines can be run, as well as a correlation engine for correlating the results from the various analysis engines;

FIG. 20A illustrates an example of a system including an endpoint and a high-interaction network;

FIG. 20B illustrates an example of infiltration of the system at the endpoint;

FIG. 20C illustrates another example of infiltration of the system, where, in this case, the infiltrator is attempting to access the endpoint through the endpoint's network connection;

FIG. 20D illustrates another example of infiltration of the system by an infiltrator attempting to use the endpoint's network connection to infiltrate the endpoint;

FIG. 21A illustrates an example of a system including an endpoint and a high-interaction network;

FIG. 21B illustrates an example of infiltration of the system at the endpoint;

FIG. 21C illustrates another example of infiltration of the system, where the infiltrator is located outside the site network;

FIG. 22 illustrates an example of the operation of an endpoint analytic engine in an endpoint, as well as an alternate implementation for detected whether the endpoint has been infiltrated;

FIGS. 23A-23B illustrate an example of privilege escalation;

FIG. 24 illustrates an example of use of decoy passwords;

FIG. 25 illustrates installation of administrative tools or other unauthorized tools;

FIG. 26A-26B illustrate an example of remote code execution;

FIG. 27 illustrates several examples of decoy data that can be configured on an endpoint;

FIG. 28 illustrates another example of an endpoint configured with decoy data in the form of an application;

FIG. 29 illustrates another example of configuring decoy data to redirect an infiltrator as the infiltrator logs into an endpoint;

FIG. 30 illustrates another example of a way in which decoy data can be configured for an endpoint;

FIG. 31 illustrates another example of using an application's stored data as decoy data;

FIG. 32 illustrates examples of the data that may be captured by a high-interaction network as the high-interaction network interacts with and analyzes suspect network traffic;

FIG. 33A-33C illustrate example configurations of a high-interaction network;

FIG. 34 illustrates an example of a correlation process;

FIG. 35 illustrates an example of the information that may be available in an incident report, and how the information may be provided to a network administrator; and

FIG. 36 illustrates examples of ways in which the threat intelligence engine may use indicators generated by its analytic engine.

### DETAILED DESCRIPTION

Network deception mechanisms, often referred to as “honeypots,” “honey tokens,” and “honey nets,” among others, defend a network from threats by distracting or diverting the threat. Honeypot-type deception mechanisms can be installed in a network for a particular site, such as a business office, to act as decoys in the site's network. Honeypot-type deception mechanisms are typically configured to be indistinguishable from active, production systems in the network. Additionally, such deception mechanisms are typically configured to be attractive to a network threat by having seemingly valuable data and/or by appearing vulnerable to infiltration. Though these deception mechanisms can be indistinguishable from legitimate parts of the site network, deception mechanisms are not part of the normal operation of the network, and would not be accessed during normal, legitimate use of the site network. Because normal users of the site network would not normally use or access a deception mechanism, any use or access to the deception mechanism is suspected to be a threat to the network.

“Normal” operation of a network generally includes network activity that conforms with the intended purpose of a network. For example, normal or legitimate network activity can include the operation of a business, medical facility, government office, education institution, or the ordinary network activity of a private home. Normal network activity can also include the non-business-related, casual activity of users of a network, such as accessing personal email and visiting web sites on personal time, or using network resources for personal use. Normal activity can also include the operations of network security devices, such as firewalls, anti-virus tools, intrusion detection systems, intrusion protection systems, email filters, adware blockers, and so on. Normal operations, however, exclude deceptions mechanisms, in that deception mechanisms are not intended to take part in business operations or casual use. As such, network users and network systems do not normally access deceptions mechanisms except perhaps for the most routine network administrative tasks. Access to a deception mechanism, other than entirely routine network administration, may thus indicate a threat to the network.

Threats to a network can include active attacks, where an attacker interacts or engages with systems in the network to steal information or do harm to the network. An attacker may be a person, or may be an automated system. Examples of active attacks include denial of service (DoS) attacks, distributed denial of service (DDoS) attacks, spoofing attacks, “man-in-the-middle” attacks, attacks involving malformed network requests (e.g. Address Resolution Protocol (ARP) poisoning, “ping of death,” etc.), buffer, heap, or stack overflow attacks, and format string attacks, among others. Threats to a network can also include self-driven, self-replicating, and/or self-triggering malicious software. Malicious software can appear innocuous until activated, upon which the malicious software may attempt to steal information from a network and/or do harm to the network. Malicious software is typically designed to spread itself to other systems in a network. Examples of malicious software include ransomware, viruses, worms, Trojan horses, spyware, keyloggers, rootkits, and rogue security software, among others.

A malicious actor may attempt to hack into an endpoint. As used here, an endpoint is a network device, such as a desktop computer, a laptop computer, a tablet computer, a personal digital assistant, a smart phone, some other hand-held computing device, a server, or some other computing system that has an operating system, is capable of executing user applications, and is connected to a network. These devices will be referred to herein as an “endpoint” to distinguish these devices from other network devices that do not execute either or both an operating system and user applications.

A malicious actor may be attempting to infiltrate an endpoint in order to infiltrate the network, steal information, install malware, and/or cause harm to the endpoint and/or the network in some other way. The infiltrator may first attempt to gain access to the endpoint using various techniques. Once the infiltrator has access to the endpoint, the infiltrator may next attempt to access valuable information located on the endpoint, and/or may attempt to infiltrate the network to do damage to the network and/or to steal information from devices on the network.

Access to the endpoint can be monitored to detect suspect accesses, and defenses can be put on place in the event of a possible infiltration. A defense against infiltration may include isolating the endpoint from the network, once a suspect access to the endpoint is detected. By isolating the endpoint from the network, an infiltrator would be unable to access the network and do harm to the network. Understanding, however, what harm the infiltrator intends and how the infiltrator aims to accomplish that harm is useful, for example, for finding security holes, understanding network attacks, and improving overall network security, among other things. Allowing the infiltrator access to the network may provide this information, but providing this access should not cause actual harm to the network.

In various implementations, an endpoint may be configured with an endpoint analytic engine. The endpoint analytic engine may monitor access to the endpoint, and watch for a condition to occur. The condition may indicate that an access to the endpoint has occurred and that this access occurred in such a way that the access is suspect. Upon detecting the condition, the endpoint analytic engine may cause communications between the endpoint and the network to be redirected to a high-interaction network. Redirecting communications may result in the endpoint's ability to communicate with the network being disabled, and the endpoint's ability to communicate with the high-interaction network to be enabled. In this way, the endpoint may be isolated from the network. The high-interaction network is a closely monitored, isolated system that is capable of emulating all or part of the network that the endpoint is connected to. By redirecting the endpoint's network communications to the high-interaction network, the infiltrator's network activity can be closely monitored. The high-interaction network may subsequently provide data that can be used to generate indicators. These indicators may identify and describe the activity, and may even describe how the infiltrator gained access to the endpoint. These indicators can be used to improve the security of the endpoint and the network.

In various implementations, a network device may monitor one or more endpoints for suspect accesses. The network device may be configured to control communications between an endpoint and the network. The network device may detect a suspect access to an endpoint, where the suspect access indicates that a possible infiltrator has gained access to the endpoint or is attempting to gain access to the endpoint. The network device may redirect communications between the endpoint and the network to a high-interaction network, which may disable communications between the endpoint and the network. In this way, the endpoint may be isolated from the network. The high-interaction network may monitor the activity of the supposed infiltrator, and data provided by the high-interaction network can be used to produce indicators that describe and/or identify the activity.

In various implementations, an endpoint can be configured with decoy data, as a way to detect and redirect a suspect access to the endpoint. The decoy data may be a file, a directory, an application, and/or a link to a file, directory, or application. The decoy data may be associated with a high-interaction network, so that access to the decoy data is redirected to the high-interaction network. The decoy data is configured to look like legitimate and probably valuable data. Accessing the decoy data, however, results in access to data in the high-interaction network. The high-interaction network may capture activity that results from access to the decoy data. Output from the high-interaction network can be used to produce indicators that describe and/or identify the activity.

### I. Deception-Based Security Systems

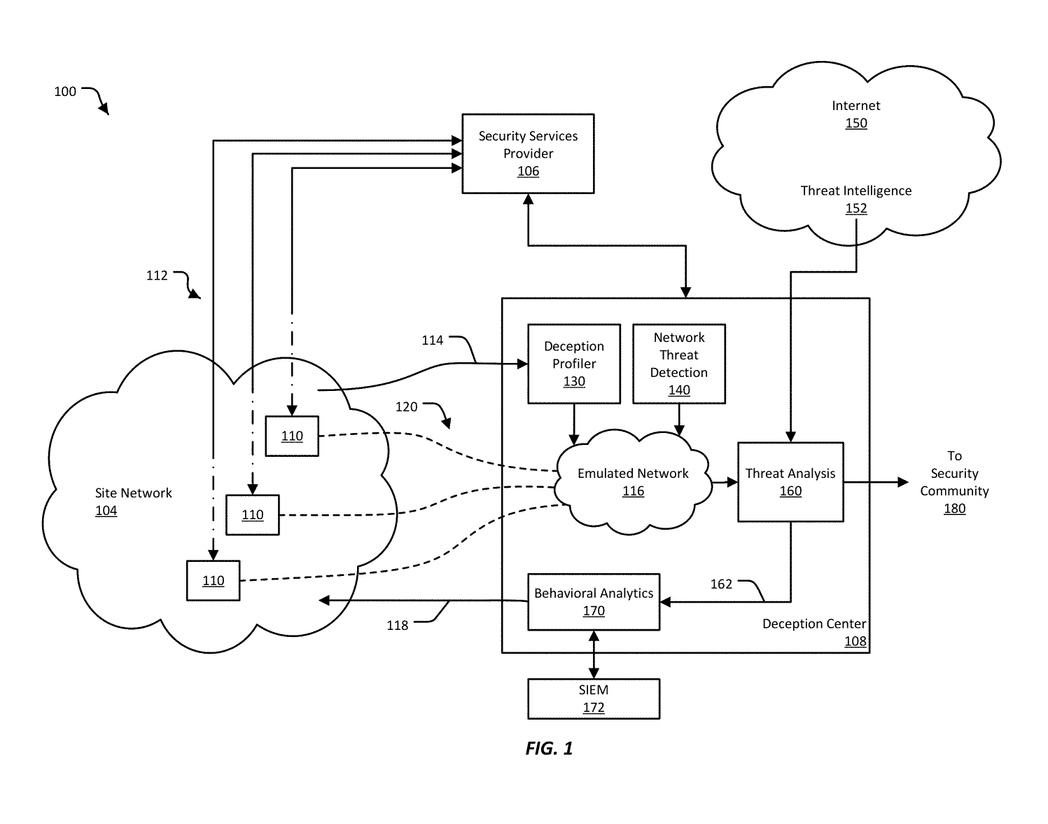

FIG. 1 illustrates an example of a network threat detection and analysis system 100, in which various implementations of a deception-based security system can be used. The network threat detection and analysis system 100, or, more briefly, network security system 100, provides security for a site network 104 using deceptive security mechanisms, a variety of which may be called “honeypots.” The deceptive security mechanisms may be controlled by and inserted into the site network 104 using a deception center 108 and sensors 110, which may also be referred to as deception sensors, installed in the site network 104. In some implementations, the deception center 108 and the sensors 110 interact with a security services provider 106 located outside of the site network 104. The deception center 108 may also obtain or exchange data with sources located on the Internet 150.

Security mechanisms designed to deceive, sometimes referred to as “honeypots,” may also be used as traps to divert and/or deflect unauthorized use of a network away from the real network assets. A deception-based security mechanism may be a computer attached to the network, a process running on one or more network systems, and/or some other device connected to the network. A security mechanism may be configured to offer services, real or emulated, to serve as bait for an attack on the network. Deception-based security mechanisms that take the form of data, which may be called “honey tokens,” may be mixed in with real data in devices in the network. Alternatively or additionally, emulated data may also be provided by emulated systems or services.

Deceptive security mechanisms can also be used to detect an attack on the network. Deceptive security mechanisms are generally configured to appear as if they are legitimate parts of a network. These security mechanisms, however, are not, in fact, part of the normal operation of the network. Consequently, normal activity on the network is not likely to access the security mechanisms. Thus any access over the network to the security mechanism is automatically suspect.

The network security system 100 may deploy deceptive security mechanisms in a targeted and dynamic fashion. Using the deception center 108 the system 100 can scan the site network 104 and determine the topology of the site network 104. The deception center 108 may then determine devices to emulate with security mechanisms, including the type and behavior of the device. The security mechanisms may be selected and configured specifically to attract the attention of network attackers. The security mechanisms may also be selected and deployed based on suspicious activity in the network. Security mechanisms may be deployed, removed, modified, or replaced in response to activity in the network, to divert and isolate network activity related to an apparent attack, and to confirm that the network activity is, in fact, part of a real attack.

The site network 104 is a network that may be installed among the buildings of a large business, in the office of a small business, at a school campus, at a hospital, at a government facility, or in a private home. The site network 104 may be described as a local area network (LAN) or a group of LANS. The site network 104 may be one site belonging to an organization that has multiple site networks 104 in one or many geographical locations. In some implementations, the deception center 108 may provide network security to one site network 104, or to multiple site networks 104 belonging to the same entity.

The site network 104 is where the networking devices and users of the an organizations network may be found. The site network 104 may include network infrastructure devices, such as routers, switches hubs, repeaters, wireless base stations, and/or network controllers, among others. The site network 104 may also include computing systems, such as servers, desktop computers, laptop computers, tablet computers, personal digital assistants, and smart phones, among others. The site network 104 may also include other analog and digital electronics that have network interfaces, such as televisions, entertainment systems, thermostats, refrigerators, and so on.

The deception center 108 provides network security for the site network 104 (or multiple site networks for the same organization) by deploying security mechanisms into the site network 104, monitoring the site network 104 through the security mechanisms, detecting and redirecting apparent threats, and analyzing network activity resulting from the apparent threat. To provide security for the site network 104, in various implementations the deception center 108 may communicate with sensors 110 installed in the site network 104, using network tunnels 120. As described further below, the tunnels 120 may allow the deception center 108 to be located in a different sub-network (“subnet”) than the site network 104, on a different network, or remote from the site network 104, with intermediate networks (possibly including the Internet 150) between the deception center 108 and the site network 104.

In some implementations, the network security system 100 includes a security services provider 106. In these implementations, the security services provider 106 may act as a central hub for providing security to multiple site networks, possibly including site networks controlled by different organizations. For example, the security services provider 106 may communicate with multiple deception centers 108 that each provide security for a different site network 104 for the same organization. In some implementations, the security services provider 106 is located outside the site network 104. In some implementations, the security services provider 106 is controlled by a different entity than the entity that controls the site network. For example, the security services provider 106 may be an outside vendor. In some implementations, the security services provider 106 is controlled by the same entity as that controls the site network 104.

In some implementations, when the network security system 100 includes a security services provider 106, the sensors 110 and the deception center 108 may communicate with the security services provider 106 in order to be connected to each other. For example, the sensors 110, which may also be referred to as deception sensors, may, upon powering on in the site network 104, send information over a network connection 112 to the security services provider 106, identifying themselves and the site network 104 in which they are located. The security services provider 106 may further identify a corresponding deception center 108 for the site network 104. The security services provider 106 may then provide the network location of the deception center 108 to the sensors 110, and may provide the deception center 108 with the network location of the sensors 110. A network location may take the form of, for example, an Internet Protocol (IP) address. With this information, the deception center 108 and the sensors 110 may be able to configure tunnels 120 to communicate with each other.

In some implementations, the network security system 100 does not include a security services provider 106. In these implementations, the sensors 110 and the deception center 108 may be configured to locate each other by, for example, sending packets that each can recognize as coming for the other. Using these packets, the sensors 110 and deception center 108 may be able to learn their respective locations on the network. Alternatively or additionally, a network administrator can configure the sensors 110 with the network location of the deception center 108, and vice versa.

In various implementations, the sensors 110 are a minimal combination of hardware and/or software, sufficient to form a network connection with the site network 104 and a tunnel 120 with the deception center 108. For example, a sensor 110 may be constructed using a low-power processor, a network interface, and a simple operating system. In various implementations, the sensors 110 provide the deception center 108 with visibility into the site network 104, such as for example being able to operate as a node in the site network 104, and/or being able to present or project deceptive security mechanisms into the site network 104, as described further below. Additionally, in various implementations, the sensors 110 may provide a portal through which a suspected attack on the site network 104 can be redirected to the deception center 108, as is also described below.

In various implementations, the deception center 108 may be configured to profile the site network 104, deploy deceptive security mechanisms for the site network 104, detect suspected threats to the site network 104, analyze the suspected threat, and analyze the site network 104 for exposure and/or vulnerability to the supposed threat.

To provide the site network 104, the deception center 108 may include a deception profiler 130. In various implementations, the deception profiler may 130 derive information 114 from the site network 104, and determine, for example, the topology of the site network 104, the network devices included in the site network 104, the software and/or hardware configuration of each network device, and/or how the network is used at any given time. Using this information, the deception profiler 130 may determine one or more deceptive security mechanisms to deploy into the site network 104.

In various implementations, the deception profiler may configure an emulated network 116 to emulate one or more computing systems. Using the tunnels 120 and sensors 110, the emulated computing systems may be projected into the site network 104, where they serve as deceptions. The emulated computing systems may include address deceptions, low-interaction deceptions, and/or high-interaction deceptions. In some implementations, the emulated computing systems may be configured to resemble a portion of the network. In these implementations, this network portion may then be projected into the site network 104.

In various implementations, a network threat detection engine 140 may monitor activity in the emulated network 116, and look for attacks on the site network 104. For example, the network threat detection engine 140 may look for unexpected access to the emulated computing systems in the emulated network 116. The network threat detection engine 140 may also use information 114 extracted from the site network 104 to adjust the emulated network 116, in order to make the deceptions more attractive to an attack, and/or in response to network activity that appears to be an attack. Should the network threat detection engine 140 determine that an attack may be taking place, the network threat detection engine 140 may cause network activity related to the attack to be redirected to and contained within the emulated network 116.

In various implementations, the emulated network 116 is a self-contained, isolated, and closely monitored network, in which suspect network activity may be allowed to freely interact with emulated computing systems. In various implementations, questionable emails, files, and/or links may be released into the emulated network 116 to confirm that they are malicious, and/or to see what effect they have. Outside actors can also be allowed to access emulated system, steal data and user credentials, download malware, and conduct any other malicious activity. In this way, the emulated network 116 not only isolated a suspected attack from the site network 104, but can also be used to capture information about an attack. Any activity caused by suspect network activity may be captured in, for example, a history of sent and received network packets, log files, and memory snapshots.

In various implementations, activity captured in the emulated network 116 may be analyzed using a targeted threat analysis engine 160. The threat analysis engine 160 may examine data collected in the emulated network 116 and reconstruct the course of an attack. For example, the threat analysis engine 160 may correlate various events seen during the course of an apparent attack, including both malicious and innocuous events, and determine how an attacker infiltrated and caused harm in the emulated network 116. In some cases, the threat analysis engine 160 may use threat intelligence 152 from the Internet 150 to identify and/or analyze an attack contained in the emulated network 116. The threat analysis engine 160 may also confirm that suspect network activity was not an attack. The threat analysis engine 160 may produce indicators that describe the suspect network activity, including indicating whether the suspect activity was or was not an actual threat. The threat analysis engine 160 may share these indicators with the security community 180, so that other networks can be defended from the attack. The threat analysis engine 160 may also send the indicators to the security services provider 106, so that the security services provider 106 can use the indicators to defend other site networks.

In various implementations, the threat analysis engine 160 may also send threat indicators, or similar data, to a behavioral analytics engine 170. The behavioral analytics engine 170 may be configured to use the indicators to probe 118 the site network 104, and see whether the site network 104 has been exposed to the attack, or is vulnerable to the attack. For example, the behavioral analytics engine 170 may search the site network 104 for computing systems that resemble emulated computing systems in the emulated network 116 that were affected by the attack. In some implementations, the behavioral analytics engine 170 can also repair systems affected by the attack, or identify these systems to a network administrator. In some implementations, the behavioral analytics engine 170 can also reconfigure the site network's 104 security infrastructure to defend against the attack.

The behavioral analytics engine 170 can work in conjunction with a Security Information and Event Management (SIEM) 172 system. In various implementations, SIEM includes software and/or services that can provide real-time analysis of security alerts generates by network hardware and applications. In various implementations, the deception center 108 can communicate with the SIEM 172 system to obtain information about computing and/or networking systems in the site network 104.

Using deceptive security mechanisms, the network security system 100 may thus be able to distract and divert attacks on the site network 104. The network security system 100 may also be able to allow, using the emulated network 116, and attack to proceed, so that as much can be learned about the attack as possible. Information about the attack can then be used to find vulnerabilities in the site network 104. Information about the attack can also be provided to the security community 180, so that the attack can be thwarted elsewhere.

### II. Customer Installations

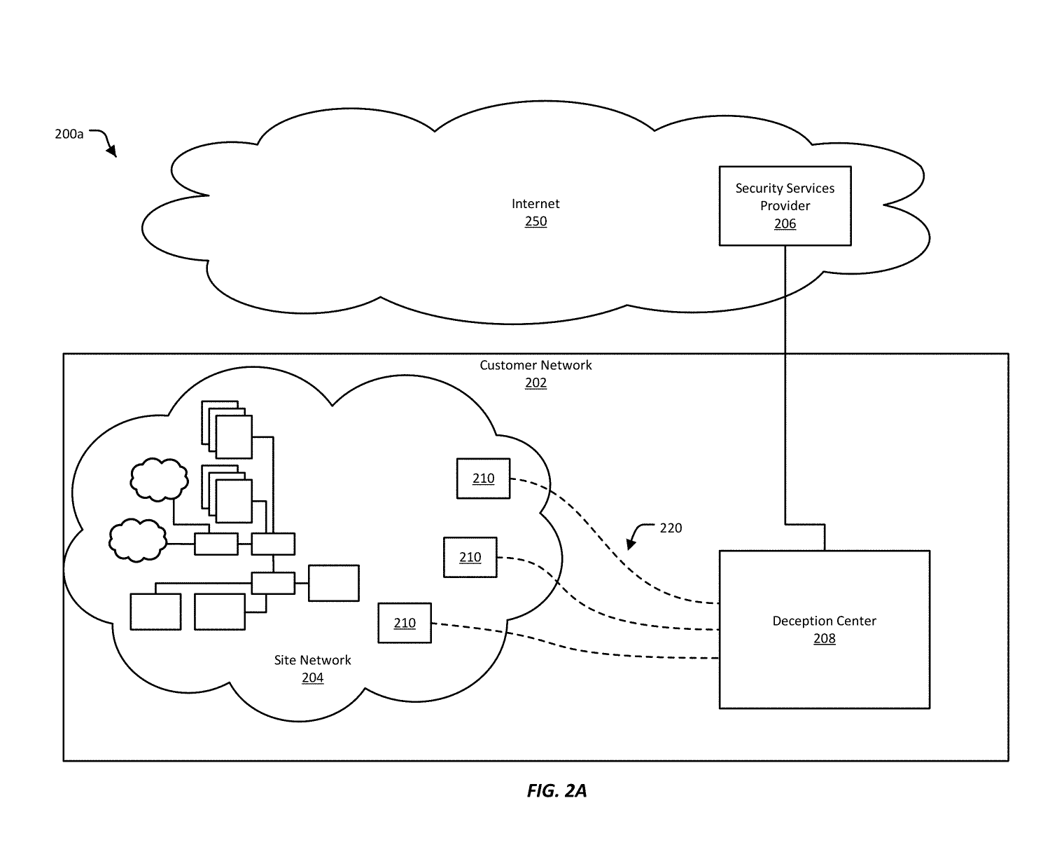

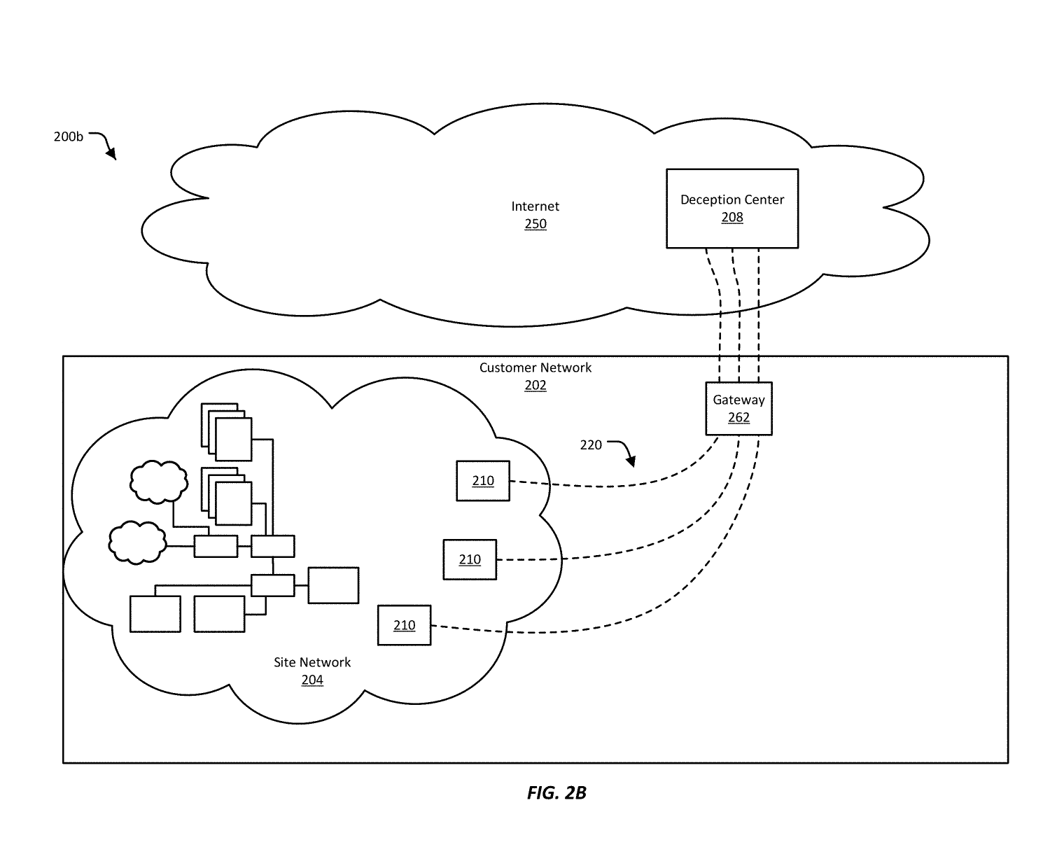

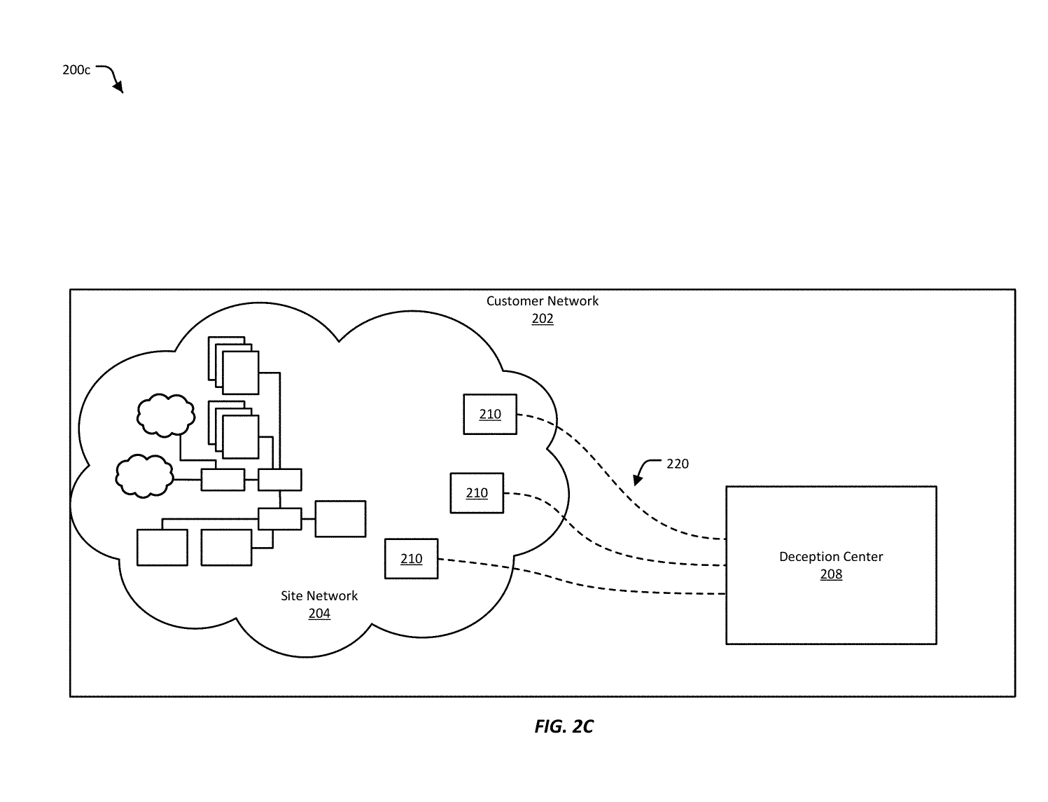

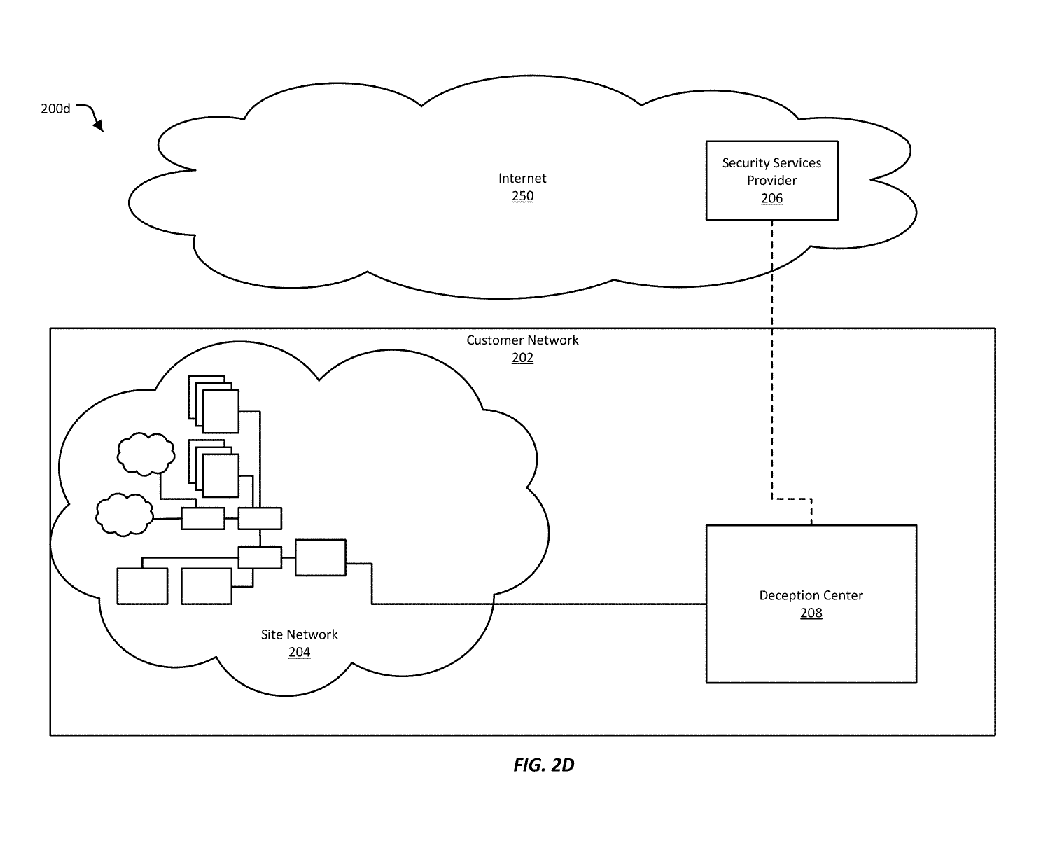

The network security system, such as the deception-based system described above, may be flexibly implemented to accommodate different customer networks. FIGS. 2A-2C provide examples of different installation configurations 200a-200c that can be used for different customer networks 202. A customer network 202 may generally be described as a network or group of networks that is controlled by a common entity, such as a business, a school, or a person. The customer network 202 may include one or more site networks 204. The customer network's 202 site networks 204 may be located in one geographic location, may be behind a common firewall, and/or may be multiple subnets within one network. Alternatively or additionally, a customer network's 202 site networks 204 may be located in different geographic locations, and be connected to each other over various private and public networks, including the Internet 250.

Different customer networks 202 may have different requirements regarding network security. For example, some customer networks 202 may have relatively open connections to outside networks such as the Internet 250, while other customer networks 202 have very restricted access to outside networks. The network security system described in FIG. 1 may be configurable to accommodate these variations.

FIG. 2A illustrates one example of an installation configuration 200a, where a deception center 208 is located within the customer network 202. In this example, being located within the customer network 202 means that the deception center 208 is connected to the customer network 202, and is able to function as a node in the customer network 202. In this example, the deception center 208 may be located in the same building or within the same campus as the site network 204. Alternatively or additionally, the deception center 208 may be located within the customer network 202 but at a different geographic location than the site network 204. The deception center 208 thus may be within the same subnet as the site network 204, or may be connected to a different subnet within the customer network.

In various implementations, the deception center 208 communicates with sensors 210, which may also be referred to as deception sensors, installed in the site network over network tunnels 220 In this example, the network tunnels 220 may cross one or more intermediate within the customer network 202.

In this example, the deception center 208 is able to communicate with a security services provider 206 that is located outside the customer network 202, such as on the Internet 250. The security services provider 206 may provide configuration and other information for the deception center 208. In some cases, the security services provider 206 may also assist in coordinating the security for the customer network 202 when the customer network 202 includes multiple site networks 204 located in various geographic areas.

FIG. 2B illustrates another example of an installation configuration 200b, where the deception center 208 is located outside the customer network 202. In this example, the deception center 208 may connected to the customer network 202 over the Internet 250. In some implementations, the deception center 208 may be co-located with a security services provider, and/or may be provided by the security services provider.

In this example, the tunnels 220 connect the deception center 208 to the sensors 210 through a gateway 262. A gateway is a point in a network that connects the network to another network. For example, in this example, the gateway 262 connects the customer network 202 to outside networks, such as the Internet 250. The gateway 262 may provide a firewall, which may provide some security for the customer network 202. The tunnels 220 may be able to pass through the firewall using a secure protocol, such as Secure Socket Shell (SSH) and similar protocols. Secure protocols typically require credentials, which may be provided by the operator of the customer network 202.

FIG. 2C illustrates another example of an installation configuration 200c, where the deception center 208 is located inside the customer network 202 but does not have access to outside networks. In some implementations, the customer network 202 may require a high level of network security. In these implementations, the customer network's 202 connections to the other networks may be very restricted. Thus, in this example, the deception center 208 is located within the customer network 202, and does not need to communicate with outside networks. The deception center 208 may use the customer networks 202 internal network to coordinate with and establish tunnels 220 to the sensors 210. Alternatively or additionally, a network administrator may configure the deception center 208 and sensors 210 to enable them to establish the tunnels 220.

FIG. 2D illustrates another example of an installation configuration 200d. In this example, the deception center 208 is located inside the customer network 202, and further is directly connected to the site network 204. Directly connected, in this example, can mean that the deception center 208 is connected to a router, hub, switch, repeater, or other network infrastructure device that is part of the site network 204. Directly connected can alternatively or additionally mean that the deception center 208 is connected to the site network 204 using a Virtual Local Area Network (VLAN). For example, the deception center 208 can be connected to VLAN trunk port. In these examples, the deception center 208 can project deceptions into the site network 204 with or without the use of sensors, such as are illustrated in FIGS. 2A-2C.

In the example of FIG. 2D, the deception center 208 can also optionally be connected to an outside security services provider 206. The security services provider 206 can manage the deception center 208, including providing updated security data, sending firmware upgrades, and/or coordinating different deception centers 208 for different site networks 204 belonging to the same customer network 202. In some implementations, the deception center 208 can operate without the assistances of an outside security services provider 206.

### III. Customer Networks

The network security system, such as the deception-based system discussed above, can be used for variety of customer networks. As noted above, customer networks can come in wide variety of configurations. For example, a customer network may have some of its network infrastructure “in the cloud.” A customer network can also include a wide variety of devices, including what may be considered “traditional” network equipment, such as servers and routers, and non-traditional, “Internet-of-Things” devices, such as kitchen appliances. Other examples of customer networks include established industrial networks, or a mix of industrial networks and computer networks.

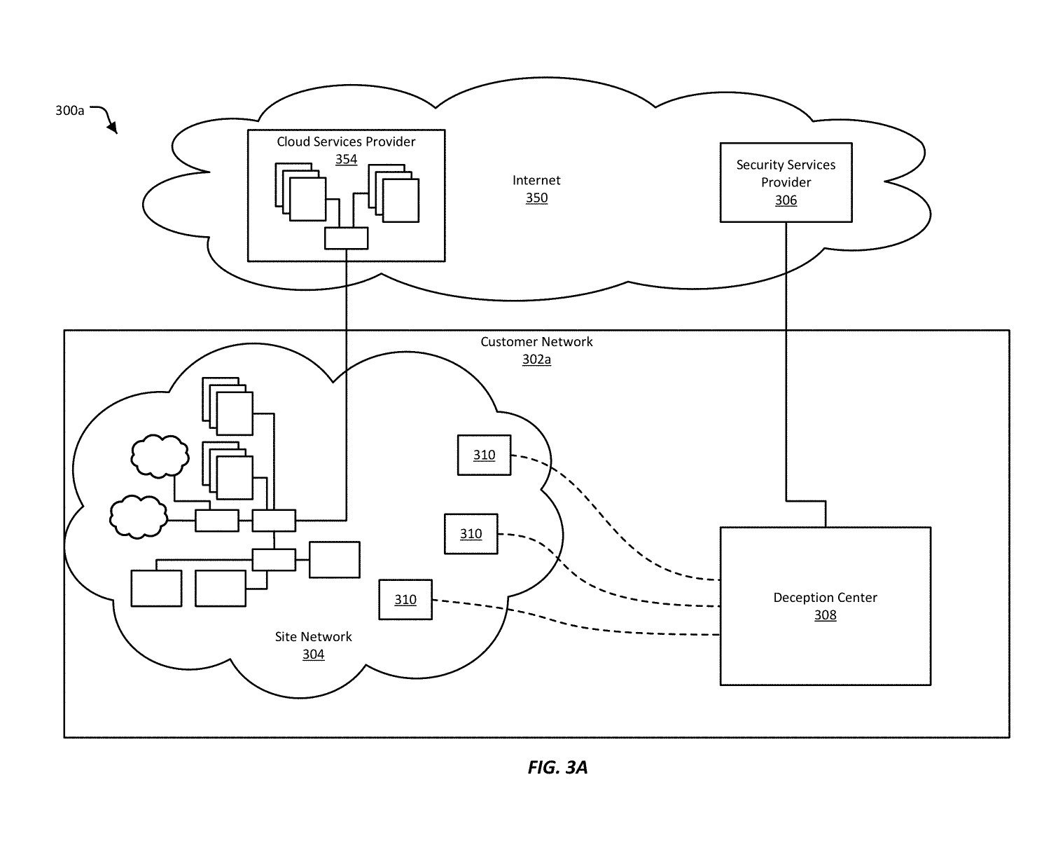

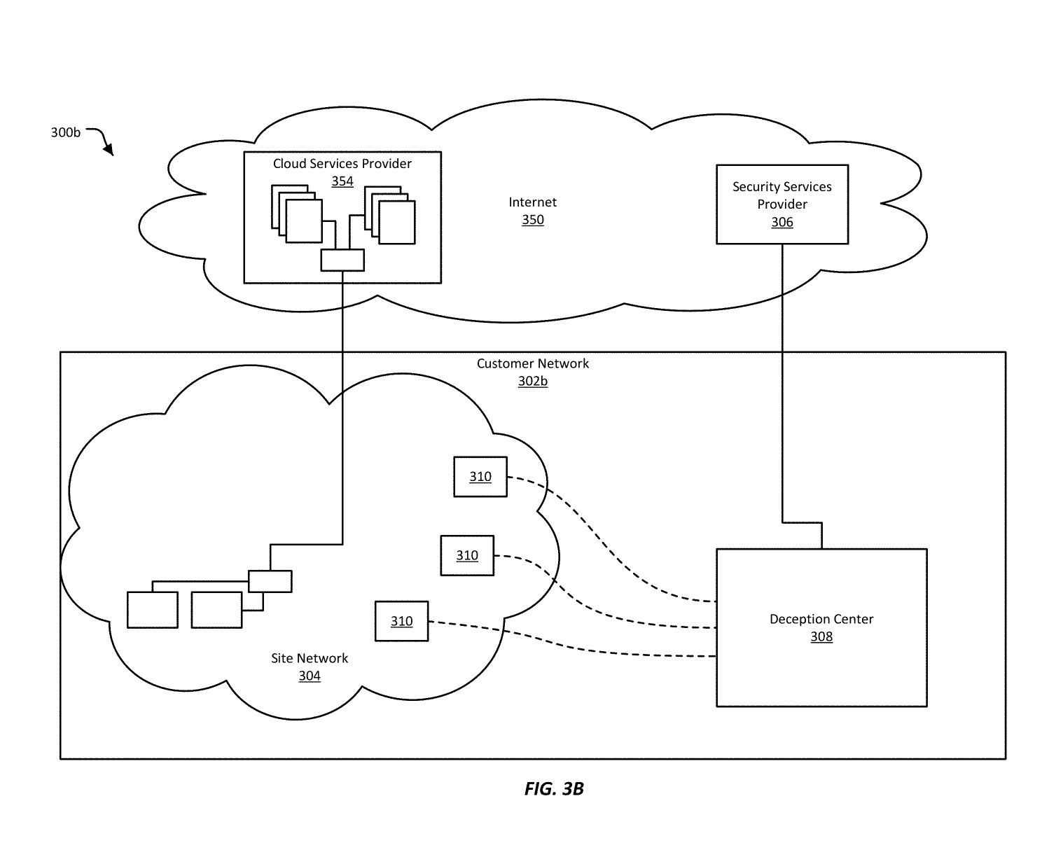

FIG. 3A-3B illustrate examples of customer networks 302a-302b where some of the customer networks' 302a-302b network infrastructure is “in the cloud,” that is, is provided by a cloud services provider 354. These example customer networks 302a-302b may be defended by a network security system that includes a deception center 308 and sensors 310, which may also be referred to as deception sensors, and may also include an off-site security services provider 306.

A cloud services provider is a company that offers some component of cloud computer—such as Infrastructure as a Service (IaaS), Software as a Service (SaaS) or Platform as Service (PaaS)—to other businesses and individuals. A cloud services provider may have a configurable pool of computing resources, including, for example, networks, servers, storage, applications, and services. These computing resources can be available on demand, and can be rapidly provisioned. While a cloud services provider's resources may be shared between the cloud service provider's customers, from the perspective of each customer, the individual customer may appear to have a private network within the cloud, including for example having dedicated subnets and IP addresses.

In the examples illustrated in FIGS. 3A-3B, the customer networks' 302a-302b network is partially in a site network 304, and partially provided by the cloud services provider 354. In some cases, the site network 304 is the part of the customer networks 302a-302b that is located at a physical site owned or controlled by the customer network 302a-302b. For example, the site network 304 may be a network located in the customer network's 302a-302b office or campus. Alternatively or additionally, the site network 304 may include network equipment owned and/or operated by the customer network 302 that may be located anywhere. For example, the customer networks' 302a-302b operations may consist of a few laptops owned by the customer networks 302a-302b, which are used from the private homes of the lap tops' users, from a co-working space, from a coffee shop, or from some other mobile location.

In various implementations, sensors 310 may be installed in the site network 304. The sensors 310 can be used by the network security system to project deceptions into the site network 304, monitor the site network 304 for attacks, and/or to divert suspect attacks into the deception center 308.

In some implementations, the sensors 310 may also be able to project deceptions into the part of the customer networks 302a-302b network that is provided by the cloud services provider 354. In most cases, it may not be possible to install sensors 310 inside the network of the cloud services provider 354, but in some implementations, this may not be necessary. For example, as discussed further below, the deception center 308 can acquire the subnet address of the network provided by the cloud services provider 354, and use that subnet address the create deceptions. Though these deceptions are projected form the sensors 310 installed in the site network 304, the deceptions may appear to be within the subnet provided by the cloud services provider 354.

In illustrated examples, the deception center 308 is installed inside the customer networks 302a-302b. Though not illustrated here, the deception center 308 can also be installed outside the customer networks 302a-302b, such as for example somewhere on the Internet 350. In some implementations, the deception center 308 may reside at the same location as the security service provider 306. When located outside the customer networks 302a-302b, the deception center 308 may connect to the sensors 310 in the site network 304 over various public and/or private networks.

FIG. 3A illustrates an example of a configuration 300a where the customer network's 302a network infrastructure is located in the cloud and the customer network 302a also has a substantial site network 304. In this example, the customer may have an office where the site network 304 is located, and where the customer's employees access and use the customer network 302a. For example, developers, sales and marketing personnel, human resources and finance employees, may access the customer network 302a from the site network 304. In the illustrated example, the customer may obtain applications and services from the cloud services provider 354. Alternatively or additionally, the cloud services provider 354 may provide data center services for the customer. For example, the cloud services provider 354 may host the customer's repository of data (e.g., music provided by a streaming music service, or video provided by a streaming video provider). In this example, the customer's own customers may be provided data directly from the cloud services provider 354, rather than from the customer network 302a.

FIG. 3B illustrates and example of a configuration 300b where the customer network's 302b network is primarily or sometimes entirely in the cloud. In this example, the customer network's 302b site network 304 may include a few laptops, or one or two desktop servers. These computing devices may be used by the customer's employees to conduct the customer's business, while the cloud services provider 354 provides the majority of the network infrastructure needed by the customer. For example, a very small company may have no office space and no dedicated location, and have as computing resources only the laptops used by its employees. This small company may use the cloud services provider 354 to provide its fixed network infrastructure. The small company may access this network infrastructure by connecting a laptop to any available network connection (e.g, in a co-working space, library, or coffee shop). When no laptops are connected to the cloud services provider 354, the customer network 302 may be existing entirely within the cloud.

In the example provided above, the site network 304 can be found wherever the customer's employees connect to a network and can access the cloud services provider 354. Similarly, the sensors 310 can be co-located with the employees' laptops. For example, whenever an employee connects to a network, she can enable a sensor 310, which can then project deceptions into the network around her. Alternatively or additionally, sensors 310 can be installed in a fixed location (such as the home of an employee of the customer) from which they can access the cloud services provider 354 and project deceptions into the network provided by the cloud services provider 354.

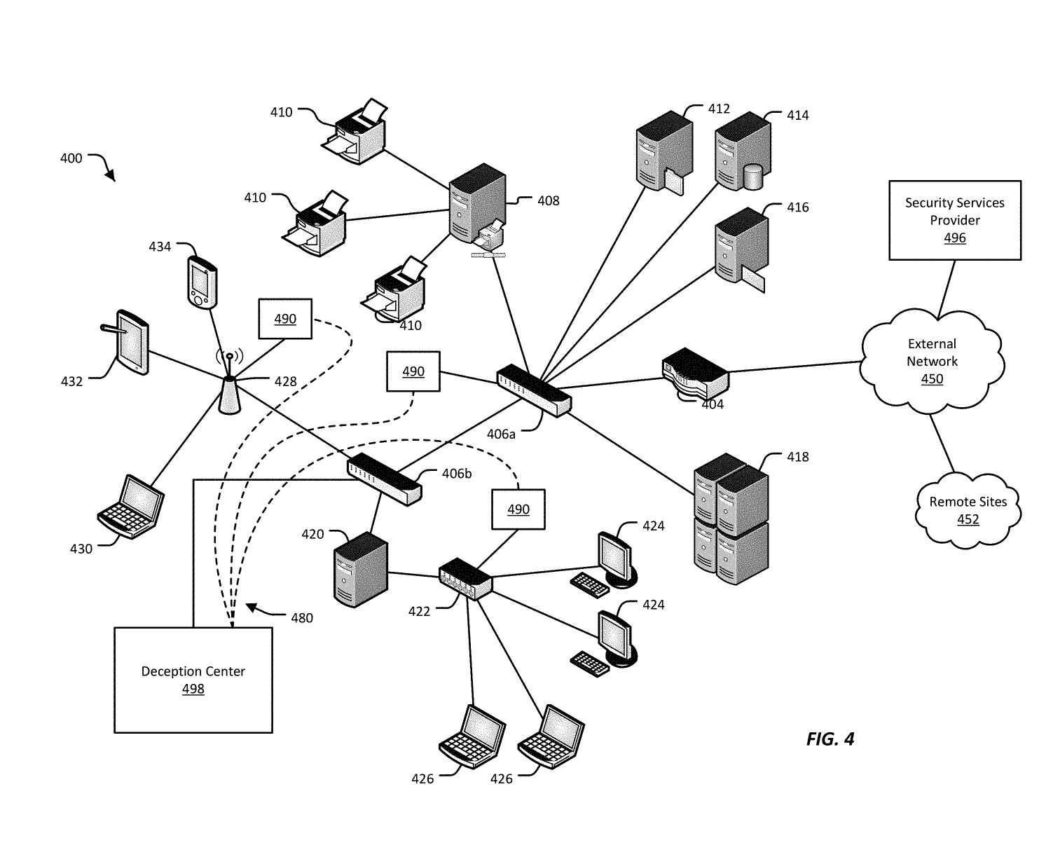

The network security system, such as the deception-based system discussed above, can provide network security for a variety of customer networks, which may include a diverse array of devices. FIG. 4 illustrates an example of an enterprise network 400, which is one such network that can be defended by a network security system. The example enterprise network 400 illustrates examples of various network devices and network clients that may be included in an enterprise network. The enterprise network 400 may include more or fewer network devices and/or network clients, and/or may include network devices, additional networks including remote sites 452, and/or systems not illustrated here. Enterprise networks may include networks installed at a large site, such as a corporate office, a university campus, a hospital, a government office, or a similar entity. An enterprise network may include multiple physical sites. Access to an enterprise networks is typically restricted, and may require authorized users to enter a password or otherwise authenticate before using the network. A network such as illustrated by the example enterprise network 400 may also be found at small sites, such as in a small business.

The enterprise network 400 may be connected to an external network 450. The external network 450 may be a public network, such as the Internet. A public network is a network that has been made accessible to any device that can connect to it. A public network may have unrestricted access, meaning that, for example, no password or other authentication is required to connect to it. The external network 450 may include third-party telecommunication lines, such as phone lines, broadcast coaxial cable, fiber optic cables, satellite communications, cellular communications, and the like. The external network 450 may include any number of intermediate network devices, such as switches, routers, gateways, servers, and/or controllers that are not directly part of the enterprise network 400 but that facilitate communication between the network 400 and other network-connected entities, such as a remote site 452.

Remote sites 452 are networks and/or individual computers that are generally located outside the enterprise network 400, and which may be connected to the enterprise network 400 through intermediate networks, but that function as if within the enterprise network 400 and connected directly to it. For example, an employee may connect to the enterprise network 400 while at home, using various secure protocols, and/or by connecting to a Virtual Private Network (VPN) provided by the enterprise network 400. While the employee's computer is connected, the employee's home is a remote site 452. Alternatively or additionally, the enterprise network's 400 owner may have a satellite office with a small internal network. This satellite office's network may have a fixed connection to the enterprise network 400 over various intermediate networks. This satellite office can also be considered a remote site.

The enterprise network 400 may be connected to the external network 450 using a gateway device 404. The gateway device 404 may include a firewall or similar system for preventing unauthorized access while allowing authorized access to the enterprise network 400. Examples of gateway devices include routers, modems (e.g. cable, fiber optic, dial-up, etc.), and the like.

The gateway device 404 may be connected to a switch 406a. The switch 406a provides connectivity between various devices in the enterprise network 400. In this example, the switch 406a connects together the gateway device 404, various servers 408, 412, 414, 416, 418, an another switch 406b. A switch typically has multiple ports, and functions to direct packets received on one port to another port. In some implementations, the gateway device 404 and the switch 406a may be combined into a single device.

Various servers may be connected to the switch 406a. For example, a print server 408 may be connected to the switch 406a. The print server 408 may provide network access to a number of printers 410. Client devices connected to the enterprise network 400 may be able to access one of the printers 410 through the printer server 408.

Other examples of servers connected to the switch 406a include a file server 412, database server 414, and email server 416. The file server 412 may provide storage for and access to data. This data may be accessible to client devices connected to the enterprise network 400. The database server 414 may store one or more databases, and provide services for accessing the databases. The email server 416 may host an email program or service, and may also store email for users on the enterprise network 400.

As yet another example, a server rack 418 may be connected to the switch 406. The server rack 418 may house one or more rack-mounted servers. The server rack 418 may have one connection to the switch 406a, or may have multiple connections to the switch 406a. The servers in the server rack 418 may have various purposes, including providing computing resources, file storage, database storage and access, and email, among others.

An additional switch 406b may also be connected to the first switch 406a. The additional switch 406b may be provided to expand the capacity of the network. A switch typically has a limited number of ports (e.g., 8, 16, 32, 64 or more ports). In most cases, however, a switch can direct traffic to and from another switch, so that by connecting the additional switch 406b to the first switch 406a, the number of available ports can be expanded.

In this example, a server 420 is connected to the additional switch 406b. The server 420 may manage network access for a number of network devices or client devices. For example, the server 420 may provide network authentication, arbitration, prioritization, load balancing, and other management services as needed to manage multiple network devices accessing the enterprise network 400. The server 420 may be connected to a hub 422. The hub 422 may include multiple ports, each of which may provide a wired connection for a network or client device. A hub is typically a simpler device than a switch, and may be used when connecting a small number of network devices together. In some cases, a switch can be substituted for the hub 422. In this example, the hub 422 connects desktop computers 424 and laptop computers 426 to the enterprise network 400. In this example, each of the desktop computers 424 and laptop computers 426 are connected to the hub 422 using a physical cable.

In this example, the additional switch 406b is also connected to a wireless access point 428. The wireless access point 428 provides wireless access to the enterprise network 400 for wireless-enabled network or client devices. Examples of wireless-enabled network and client devices include laptops 430, tablet computers 432, and smart phones 434, among others. In some implementations, the wireless access point 428 may also provide switching and/or routing functionality.

The example enterprise network 400 of FIG. 4 is defended from network threats by a network threat detection and analysis system, which uses deception security mechanisms to attract and divert attacks on the network. The deceptive security mechanisms may be controlled by and inserted into the enterprise network 400 using a deception center 498 and sensors 490, which may also be referred to as deception sensors, installed in various places in the enterprise network 400. In some implementations, the deception center 498 and the sensors 490 interact with a security services provider 496 located outside of the enterprise network 400. The deception center 498 may also obtain or exchange data with sources located on external networks 450, such as the Internet.

In various implementations, the sensors 490 are a minimal combination of hardware and/or software, sufficient to form a network connection with the enterprise network 400 and a network tunnel 480 with the deception center 498. For example, a sensor 490 may be constructed using a low-power processor, a network interface, and a simple operating system. In some implementations, any of the devices in the enterprise network (e.g., the servers 408, 412, 416, 418 the printers 410, the computing devices 424, 426, 430, 432, 434, or the network infrastructure devices 404, 406a, 406b, 428) can be configured to act as a sensor.

In various implementations, one or more sensors 490 can be installed anywhere in the enterprise network 400, include being attached switches 406a, hubs 422, wireless access points 428, and so on. The sensors 490 can further be configured to be part of one or more VLANs. The sensors 490 provide the deception center 498 with visibility into the enterprise network 400, such as for example being able to operate as a node in the enterprise network 400, and/or being able to present or project deceptive security mechanisms into the enterprise network 400. Additionally, in various implementations, the sensors 490 may provide a portal through which a suspected attack on the enterprise network 400 can be redirected to the deception center 498.

The deception center 498 provides network security for the enterprise network 400 by deploying security mechanisms into the enterprise network 400, monitoring the enterprise network 400 through the security mechanisms, detecting and redirecting apparent threats, and analyzing network activity resulting from the apparent threat. To provide security for the enterprise network 400, in various implementations the deception center 498 may communicate with sensors 490 installed in the enterprise network 400, using, for example, network tunnels 480. The tunnels 480 may allow the deception center 498 to be located in a different sub-network (“subnet”) than the enterprise network 400, on a different network, or remote from the enterprise network 400, with intermediate networks between the deception center 498 and the enterprise network 400. In some implementations, the enterprise network 400 can include more than one deception center 498. In some implementations, the deception center may be located off-site, such as in an external network 450.

In some implementations, the security services provider 496 may act as a central hub for providing security to multiple site networks, possibly including site networks controlled by different organizations. For example, the security services provider 496 may communicate with multiple deception centers 498 that each provide security for a different enterprise network 400 for the same organization. As another example, the security services provider 496 may coordinate the activities of the deception center 498 and the sensors 490, such as enabling the deception center 498 and the sensors 490 to connect to each other. In some implementations, the security services provider 496 is located outside the enterprise network 400. In some implementations, the security services provider 496 is controlled by a different entity than the entity that controls the site network. For example, the security services provider 496 may be an outside vendor. In some implementations, the security services provider 496 is controlled by the same entity as that controls the enterprise network 400. In some implementations, the network security system does not include a security services provider 496.

FIG. 4 illustrates one example of what can be considered a “traditional” network, that is, a network that is based on the interconnection of computers. In various implementations, a network security system, such as the deception-based system discussed above, can also be used to defend “non-traditional” networks that include devices other than traditional computers, such as for example mechanical, electrical, or electromechanical devices, sensors, actuators, and control systems. Such “non-traditional” networks may be referred to as the Internet of Things (IoT). The Internet of Things encompasses newly-developed, every-day devices designed to be networked (e.g., drones, self-driving automobiles, etc.) as well as common and long-established machinery that has augmented to be connected to a network (e.g., home appliances, traffic signals, etc.).

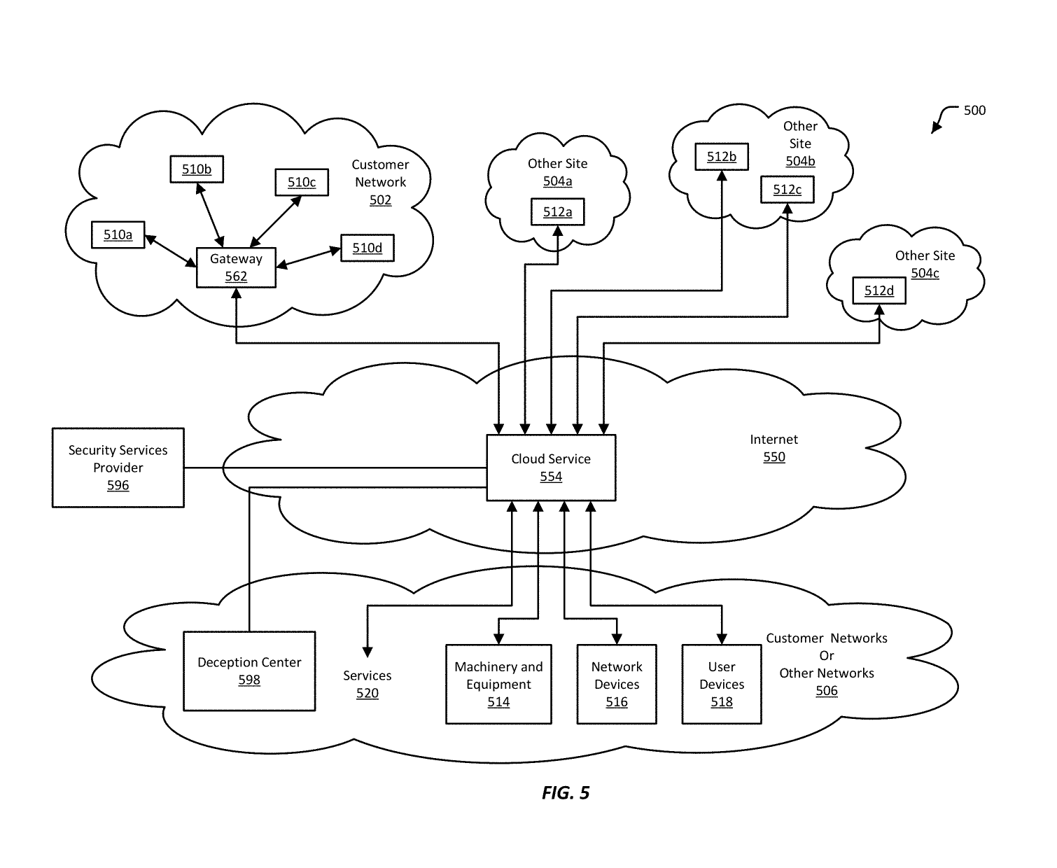

FIG. 5 illustrates a general example of an IoT network 500. The example IoT network 500 can be implemented wherever sensors, actuators, and control systems can be found. For example, the example IoT network 500 can be implemented for buildings, roads and bridges, agriculture, transportation and logistics, utilities, air traffic control, factories, and private homes, among others. In various implementations, the IoT network 500 includes cloud service 554 that collects data from various sensors 510a-510d, 512a-512d, located in various locations. Using the collected data, the cloud service 554 can provide services 520, control of machinery and equipment 514, exchange of data with traditional network devices 516, and/or exchange of data with user devices 518. In some implementations, the cloud service 554 can work with a deception center 528 and/or a security service provider 526 to provide security for the network 500.

A cloud service, such as the illustrated cloud service 554, is a resource provided over the Internet 550. Sometimes synonymous with “cloud computing,” the resource provided by the cloud services is in the “cloud” in that the resource is provided by hardware and/or software at some location remote from the place where the resource is used. Often, the hardware and software of the cloud service is distributed across multiple physical locations. Generally, the resource provided by the cloud service is not directly associated with specific hardware or software resources, such that use of the resource can continue when the hardware or software is changed. The resource provided by the cloud service can often also be shared between multiple users of the cloud service, without affecting each user's use. The resource can often also be provided as needed or on-demand. Often, the resource provided by the cloud service 554 is automated, or otherwise capable of operating with little or no assistance from human operators.

Examples of cloud services include software as a service (SaaS), infrastructure as a service (IaaS), platform as a service (PaaS), desktop as a service (DaaS), managed software as a service (MSaaS), mobile backend as a service (MBaaS), and information technology management as a service (ITMaas). Specific examples of cloud services include data centers, such as those operated by Amazon Web Services and Google Web Services, among others, that provide general networking and software services. Other examples of cloud services include those associated with smartphone applications, or “apps,” such as for example apps that track fitness and health, apps that allow a user to remotely manage her home security system or thermostat, and networked gaming apps, among others. In each of these examples, the company that provides the app may also provide cloud-based storage of application data, cloud-based software and computing resources, and/or networking services. In some cases, the company manages the cloud services provided by the company, including managing physical hardware resources. In other cases, the company leases networking time from a data center provider.

In some cases, the cloud service 554 is part of one integrated system, run by one entity. For example, the cloud service 554 can be part of a traffic control system. In this example, sensors 510a-510d, 512a-512d can be used to monitor traffic and road conditions. In this example, the cloud service 554 can attempt to optimize the flow of traffic and also provide traffic safety. For example, the sensors 510a-510d, 512a-512d can include a sensor 512a on a bridge that monitors ice formation. When the sensor 512a detects that ice has formed on the bridge, the sensor 512a can alert the cloud service 554. The cloud service 554, can respond by interacting with machinery and equipment 514 that manages traffic in the area of the bridge. For example, the cloud service 554 can turn on warning signs, indicating to drivers that the bridge is icy. Generally, the interaction between the sensor 512, the cloud service 554, and the machinery and equipment 514 is automated, requiring little or no management by human operators.

In various implementations, the cloud service 554 collects or receives data from sensors 510a-510d, 512a-512d, distributed across one or more networks. The sensors 510a-510d, 512a-512d include devices capable of “sensing” information, such as air or water temperature, air pressure, weight, motion, humidity, fluid levels, noise levels, and so on. The sensors 510a-510d, 512a-512d can alternatively or additionally include devices capable of receiving input, such as cameras, microphones, touch pads, keyboards, key pads, and so on. In some cases, a group of sensors 510a-510d may be common to one customer network 502. For example, the sensors 510a-510d may be motion sensors, traffic cameras, temperature sensors, and other sensors for monitoring traffic in a city's metro area. In this example, the sensors 510a-510d can be located in one area of the city, or be distribute across the city, and be connected to a common network. In these cases, the sensors 510a-510d can communicate with a gateway device 562, such as a network gateway. The gateway device 562 can further communicate with the cloud service 554.

In some cases, in addition to receiving data from sensors 510a-510d in one customer network 502, the cloud service 554 can also receive data from sensors 512a-512d in other sites 504a-504c. These other sites 504a-504c can be part of the same customer network 502 or can be unrelated to the customer network 502. For example, the other sites 504a-504c can each be the metro area of a different city, and the sensors 512a-512d can be monitoring traffic for each individual city.

Generally, communication between the cloud service 554 and the sensors 510a-510d, 512a-512d is bidirectional. For example, the sensors 510a-510d, 512a-512d can send information to the cloud service 554. The cloud service 554 can further provide configuration and control information to the sensors 510a-510d, 512a-512d. For example, the cloud service 554 can enable or disable a sensor 510a-510d, 512a-512d or modify the operation of a sensor 510a-510d, 512a-512d, such as changing the format of the data provided by a sensor 510a-510d, 512a-512d or upgrading the firmware of a sensor 510a-510d, 512a-512d.

In various implementations, the cloud service 554 can operate on the data received from the sensors 510a-510d, 512a-512d, and use this data to interact with services 520 provided by the cloud service 554, or to interact with machinery and equipment 514, network devices 516, and/or user devices 518 available to the cloud service 554. Services 520 can include software-based services, such as cloud-based applications, website services, or data management services. Services 520 can alternatively or additionally include media, such as streaming video or music or other entertainment services. Services 520 can also include delivery and/or coordination of physical assets, such as for example package delivery, direction of vehicles for passenger pick-up and drop-off, or automate re-ordering and re-stocking of supplies. In various implementations, services 520 may be delivered to and used by the machinery and equipment 514, the network devices 516, and/or the user devices 518.

In various implementations, the machinery and equipment 514 can include physical systems that can be controlled by the cloud service 554. Examples of machinery and equipment 514 include factory equipment, trains, electrical street cars, self-driving cars, traffic lights, gate and door locks, and so on. In various implementations, the cloud service 554 can provide configuration and control of the machinery and equipment 514 in an automated fashion.

The network devices 516 can include traditional networking equipment, such as server computers, data storage devices, routers, switches, gateways, and so on. In various implementations, the cloud service 554 can provide control and management of the network devices 516, such as for example automated upgrading of software, security monitoring, or asset tracking. Alternatively or additionally, in various implementations the cloud service 554 can exchange data with the network devices 516, such as for example providing websites, providing stock trading data, or providing online shopping resources, among others. Alternatively or additionally, the network devices 516 can include computing systems used by the cloud service provider to manage the cloud service 554.

The user devices 518 can include individual personal computers, smart phones, tablet devices, smart watches, fitness trackers, medical devices, and so on that can be associated with an individual user. The cloud service 554 can exchange data with the user devices 518, such as for example provide support for applications installed on the user devices 518, providing websites, providing streaming media, providing directional navigation services, and so on. Alternatively or additionally, the cloud service 554 may enable a user to use a user device 518 to access and/or view other devices, such as the sensors 510a-510d, 512a-512d, the machinery and equipment 514, or the network devices 516.

In various implementations, the services 520, machinery and equipment 514, network devices 516, and user devices 518 may be part of one customer network 506. In some cases, this customer network 506 is the same as the customer network 502 that includes the sensors 510a-510d. In some cases, the services 520, machinery and equipment 514, network devices 516, and user devices 518 are part of the same network, and may instead be part of various other networks 506.

In various implementations, customer networks can include a deception center 598. The deception center 598 provides network security for the IoT network 500 by deploying security mechanisms into the IoT network 500, monitoring the IoT network 500 through the security mechanisms, detecting and redirecting apparent threats, and analyzing network activity resulting from the apparent threat. To provide security for the IoT network 500, in various implementations the deception center 598 may communicate with the sensors 510a-5106d, 512a-5012 installed in the IoT network 500, for example through the cloud service 554. In some implementations, the IoT network 500 can include more than one deception center 598. For example, each of customer network 502 and customer networks or other networks 506 can include a deception center 528.

In some implementations, the deception center 598 and the sensors 510a-510d, 512a-512d interact with a security services provider 596. In some implementations, the security services provider 596 may act as a central hub for providing security to multiple site networks, possibly including site networks controlled by different organizations. For example, the security services provider 596 may communicate with multiple deception centers 598 that each provide security for a different IoT network 500 for the same organization. As another example, the security services provider 596 may coordinate the activities of the deception center 598 and the sensors 510a-510d, 512a-512d, such as enabling the deception center 598 and the sensors 510a-510d, 512a-512d to connect to each other. In some implementations, the security services provider 596 is integrated into the cloud service 554. In some implementations, the security services provider 596 is controlled by a different entity than the entity that controls the site network. For example, the security services provider 596 may be an outside vendor. In some implementations, the security services provider 596 is controlled by the same entity as that controls the IoT network 500. In some implementations, the network security system does not include a security services provider 596.

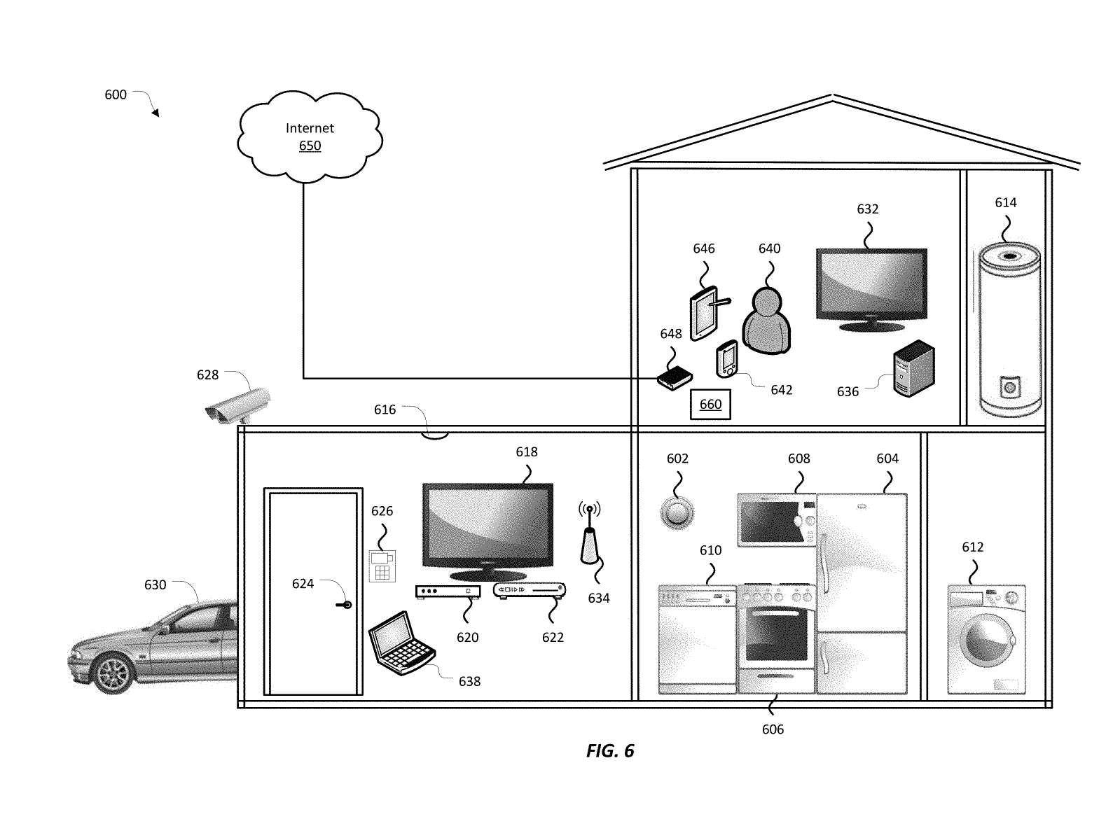

IoT networks can also include small networks of non-traditional devices. FIG. 6 illustrates an example of a customer network that is a small network 600, here implemented in a private home. A network for a home is an example of small network that may have both traditional and non-traditional network devices connected to the network 600, in keeping with an Internet of Things approach. Home networks are also an example of networks that are often implemented with minimal security. The average homeowner is not likely to be a sophisticated network security expert, and may rely on his modem or router to provide at least some basic security. The homeowner, however, is likely able to at least set up a basic home network. A deception-based network security device may be as simple to set up as a home router or base station, yet provide sophisticated security for the network 600.

The example network 600 of FIG. 6 may be a single network, or may include multiple sub-networks. These sub-networks may or may not communicate with each other. For example, the network 600 may include a sub-network that uses the electrical wiring in the house as a communication channel. Devices configured to communicate in this way may connect to the network using electrical outlets, which also provide the devices with power. The sub-network may include a central controller device, which may coordinate the activities of devices connected to the electrical network, including turning devices on and off at particular times. One example of a protocol that uses the electrical wiring as a communication network is X10.

The network 600 may also include wireless and wired networks, built into the home or added to the home solely for providing a communication medium for devices in the house. Examples of wireless, radio-based networks include networks using protocols such as Z-Wave™, Zigbee™ (also known as Institute of Electrical and Electronics Engineers (IEEE) 802.15.4), Bluetooth™, and Wi-Fi (also known as IEEE 802.11), among others. Wireless networks can be set up by installing a wireless base station in the house. Alternatively or additionally, a wireless network can be established by having at least two devices in the house that are able to communicate with each other using the same protocol.

Examples of wired networks include Ethernet (also known as IEEE 802.3), token ring (also known as IEEE 802.5), Fiber Distributed Data Interface (FDDI), and Attached Resource Computer Network (ARCNET), among others. A wired network can be added to the house by running cabling through the walls, ceilings, and/or floors, and placing jacks in various rooms that devices can connect to with additional cables. The wired network can be extended using routers, switches, and/or hubs. In many cases, wired networks may be interconnected with wireless networks, with the interconnected networks operating as one seamless network. For example, an Ethernet network may include a wireless base station that provides a Wi-Fi signal for devices in the house.

As noted above, a small network 600 implemented in a home is one that may include both traditional network devices and non-traditional, everyday electronics and appliances that have also been connected to the network 600. Examples of rooms where one may find non-traditional devices connected to the network are the kitchen and laundry rooms. For example, in the kitchen a refrigerator 604, oven 606, microwave 608, and dishwasher 610 may be connected to the network 600, and in the laundry room a washing machine 612 may be connected to the network 600. By attaching these appliances to the network 600, the homeowner can monitor the activity of each device (e.g., whether the dishes are clean, the current state of a turkey in the oven, or the washing machine cycle) or change the operation of each device without needing to be in the same room or even be at home. The appliances can also be configured to resupply themselves. For example, the refrigerator 604 may detect that a certain product is running low, and may place an order with a grocery delivery service for the product to be restocked.

The network 600 may also include environmental appliances, such as a thermostat 602 and a water heater 614. By having these devices connected to the network 600, the homeowner can monitor the current environment of the house (e.g., the air temperature or the hot water temperature), and adjust the settings of these appliances while at home or away. Furthermore, software on the network 600 or on the Internet 650 may track energy usage for the heating and cooling units and the water heater 614. This software may also track energy usage for the other devices, such as the kitchen and laundry room appliances. The energy usage of each appliance may be available to the homeowner over the network 600.

In the living room, various home electronics may be on the network 600. These electronics may have once been fully analog or may have been standalone devices, but now include a network connection for exchanging data with other devices in the network 600 or with the Internet 650. The home electronics in this example include a television 618, a gaming system 620, and a media device 622 (e.g., a video and/or audio player). Each of these devices may play media hosted, for example, on network attached storage 636 located elsewhere in the network 600, or media hosted on the Internet 650.

The network 600 may also include home safety and security devices, such as a smoke detector 616, an electronic door lock 624, and a home security system 626. Having these devices on the network may allow the homeowner to track the information monitored and/or sensed by these devices, both when the homeowner is at home and away from the house. For example, the homeowner may be able to view a video feed from a security camera 628. When the safety and security devices detect a problem, they may also inform the homeowner. For example, the smoke detector 616 may send an alert to the homeowner's smartphone when it detects smoke, or the electronic door lock 624 may alert the homeowner when there has been a forced entry. Furthermore, the homeowner may be able to remotely control these devices. For example, the homeowner may be able to remotely open the electronic door lock 624 for a family member who has been locked out. The safety and security devices may also use their connection to the network to call the fire department or police if necessary.

Another non-traditional device that may be found in the network 600 is the family car 630. The car 630 is one of many devices, such as laptop computers 638, tablet computers 646, and smartphones 642, that connect to the network 600 when at home, and when not at home, may be able to connect to the network 600 over the Internet 650. Connecting to the network 600 over the Internet 650 may provide the homeowner with remote access to his network. The network 600 may be able to provide information to the car 630 and receive information from the car 630 while the car is away. For example, the network 600 may be able to track the location of the car 630 while the car 630 is away.

In the home office and elsewhere around the house, this example network 600 includes some traditional devices connected to the network 600. For example, the home office may include a desktop computer 632 and network attached storage 636. Elsewhere around the house, this example includes a laptop computer 638 and handheld devices such as a tablet computer 646 and a smartphone 642. In this example, a person 640 is also connected to the network 600. The person 640 may be connected to the network 600 wirelessly through personal devices worn by the person 640, such as a smart watch, fitness tracker, or heart rate monitor. The person 640 may alternatively or additionally be connected to the network 600 through a network-enabled medical device, such as a pacemaker, heart monitor, or drug delivery system, which may be worn or implanted.

The desktop computer 632, laptop computer 638, tablet computer 646, and/or smartphone 642 may provide an interface that allows the homeowner to monitor and control the various devices connected to the network. Some of these devices, such as the laptop computer 638, the tablet computer 646, and the smartphone 642 may also leave the house, and provide remote access to the network 600 over the Internet 650. In many cases, however, each device on the network may have its own software for monitoring and controlling only that one device. For example, the thermostat 602 may use one application while the media device 622 uses another, and the wireless network provides yet another. Furthermore, it may be the case that the various sub-networks in the house do not communicate with each other, and/or are viewed and controlled using software that is unique to each sub-network. In many cases, the homeowner may not have one unified and easily understood view of his entire home network 600.

The small network 600 in this example may also include network infrastructure devices, such as a router or switch (not shown) and a wireless base station 634. The wireless base station 634 may provide a wireless network for the house. The router or switch may provide a wired network for the house. The wireless base station 634 may be connected to the router or switch to provide a wireless network that is an extension of the wired network. The router or switch may be connected to a gateway device 648 that connects the network 600 to other networks, including the Internet 650. In some cases, a router or switch may be integrated into the gateway device 648. The gateway device 648 is a cable modem, digital subscriber line (DSL) modem, optical modem, analog modem, or some other device that connects the network 600 to an ISP. The ISP may provide access to the Internet 650. Typically, a home network only has one gateway device 648. In some cases, the network 600 may not be connected to any networks outside of the house. In these cases, information about the network 600 and control of devices in the network 600 may not be available when the homeowner is not connected to the network 600; that is, the homeowner may not have access to his network 600 over the Internet 650.

Typically, the gateway device 648 includes a hardware and/or software firewall. A firewall monitors incoming and outgoing network traffic and, by applying security rules to the network traffic, attempts to keep harmful network traffic out of the network 600. In many cases, a firewall is the only security system protecting the network 600. While a firewall may work for some types of intrusion attempts originating outside the network 600, the firewall may not block all intrusion mechanisms, particularly intrusions mechanisms hidden in legitimate network traffic. Furthermore, while a firewall may block intrusions originating on the Internet 650, the firewall may not detect intrusions originating from within the network 600. For example, an infiltrator may get into the network 600 by connecting to signal from the Wi-Fi base station 634. Alternatively, the infiltrator may connect to the network 600 by physically connecting, for example, to the washing machine 612. The washing machine 612 may have a port that a service technician can connect to service the machine. Alternatively or additionally, the washing machine 612 may have a simple Universal Serial Bus (USB) port. Once an intruder has gained access to the washing machine 612, the intruder may have access to the rest of the network 600.

To provide more security for the network 600, a deception-based network security device 660 can be added to the network 600. In some implementations, the security device 660 is a standalone device that can be added to the network 600 by connecting it to a router or switch. In some implementations, the security device 660 can alternatively or additionally be connected to the network's 600 wireless sub-network by powering on the security device 660 and providing it with Wi-Fi credentials. The security device 660 may have a touchscreen, or a screen and a keypad, for inputting Wi-Fi credentials. Alternatively or additionally, the homeowner may be able to enter network information into the security device by logging into the security device 660 over a Bluetooth™ or Wi-Fi signal using software on a smartphone, tablet, or laptop, or using a web browser. In some implementations, the security device 660 can be connected to a sub-network running over the home's electrical wiring by connecting the security device 660 to a power outlet. In some implementations, the security device 660 may have ports, interfaces, and/or radio antennas for connecting to the various sub-networks that can be included in the network 600. This may be useful, for example, when the sub-networks do not communicate with each other, or do not communicate with each other seamlessly. Once powered on and connected, the security device 660 may self-configure and monitor the security of each sub-network in the network 600 that it is connected to.

In some implementations, the security device 660 may be configured to connect between the gateway device 648 and the network's 600 primary router, and/or between the gateway device 648 and the gateway device's 648 connection to the wall. Connected in one or both of these locations, the security device 652 may be able to control the network's 600 connection with outside networks. For example, the security device can disconnect the network 600 from the Internet 650.

In some implementations, the security device 660, instead of being implemented as a standalone device, may be integrated into one or more of the appliances, home electronics, or computing devices (in this example network 600), or in some other device not illustrated here. For example, the security device 660—or the functionality of the security device 660—may be incorporated into the gateway device 648 or a desktop computer 632 or a laptop computer 638. As another example, the security device 660 can be integrated into a kitchen appliance (e.g., the refrigerator 604 or microwave 608), a home media device (e.g., the television 618 or gaming system 620), or the home security system 626. In some implementations, the security device 660 may be a printed circuit board that can be added to another device without requiring significant changes to the other device. In some implementations, the security device 660 may be implemented using an Application Specific Integrated Circuit (ASIC) or Field Programmable Gate Array (FPGA) that can be added to the electronics of a device. In some implementations, the security device 660 may be implemented as a software module or modules that can run concurrently with the operating system or firmware of a networked device. In some implementations, the security device 660 may have a physical or virtual security barrier that prevents access to it by the device that it is integrated into. In some implementations, the security device's 660 presence in another device may be hidden from the device into which the security device 660 is integrated.

In various implementations, the security device 660 may scan the network 600 to determine which devices are present in the network 600. Alternatively or additionally, the security device 660 may communicate with a central controller in the network 600 (or multiple central controllers, when there are sub-networks, each with their own central controller) to learn which devices are connected to the network 600. In some implementations, the security device 660 may undergo a learning period, during which the security device 660 learns the normal activity of the network 600, such as what time of day appliances and electronics are used, what they are used for, and/or what data is transferred to and from these devices. During the learning period, the security device 660 may alert the homeowner to any unusual or suspicious activity. The homeowner may indicate that this activity is acceptable, or may indicate that the activity is an intrusion. As described below, the security device 660 may subsequently take preventive action against the intrusion.

Once the security device 660 has learned the topology and/or activity of the network 600, the security device 660 may be able to provide deception-based security for the network 600. In some implementations, the security device 660 may deploy security mechanisms that are configured to emulate devices that could be found in the network 600. In some implementations, the security device 660 may monitor activity on the network 600, including watching the data sent between the various devices on the network 600, and between the devices and the Internet 650. The security device 660 may be looking for activity that is unusual, unexpected, or readily identifiable as suspect. Upon detecting suspicious activity in the network 600, the security device 660 may deploy deceptive security mechanisms.

In some implementations, the deceptive security mechanisms are software processes running on the security device 660 that emulate devices that may be found in the network 600. In some implementations, the security device 660 may be assisted in emulating the security devices by another device on the network 600, such as the desktop computer 632. From the perspective of devices connected to the network 600, the security mechanisms appear just like any other device on the network, including, for example, having an Internet Protocol (IP) address, a Media Access Control (MAC) address, and/or some other identification information, having an identifiable device type, and responding to or transmitting data just as would the device being emulated. The security mechanisms may be emulated by the security device 660 itself; thus, while, from the point of view of the network 600, the network 600 appears to have additional devices, no physical equivalent (other than the security device 660) can be found in the house.

The devices and data emulated by a security mechanism are selected such that the security mechanism is an attractive target for intrusion attempts. Thus, the security mechanism may emulate valuable data, and/or devices that are easily hacked into, and/or devices that provide easy access to the reset of the network 600. Furthermore, the security mechanisms emulate devices that are likely to be found in the network 600, such as a second television, a second thermostat, or another laptop computer. In some implementations, the security device 660 may contact a service on the Internet 650 for assistance in selecting devices to emulate and/or for how to configure emulated devices. The security devices 660 may select and configure security mechanisms to be attractive to intrusions attempts, and to deflect attention away from more valuable or vulnerable network assets. Additionally, the security mechanisms can assist in confirming that an intrusion into the network 600 has actually taken place.

In some implementations, the security device 660 may deploy deceptive security mechanisms in advance of detecting any suspicious activity. For example, having scanned the network, the security device 660 may determine that the network 600 includes only one television 618 and one smoke detector 616. The security device 660 may therefore choose to deploy security mechanisms that emulate a second television and a second smoke detector. With security mechanisms preemptively added to the network, when there is an intrusion attempt, the intruder may target the security mechanisms instead of valuable or vulnerable network devices. The security mechanisms thus may serve as decoys and may deflect an intruder away from the network's 600 real devices.

In some implementations, the security mechanisms deployed by the security device 660 may take into account specific requirements of the network 600 and/or the type of devices that can be emulated. For example, in some cases, the network 600 (or a sub-network) may assign identifiers to each device connected to the network 600, and/or each device may be required to adopt a unique identifier. In these cases, the security device 660 may assign an identifier to deployed security mechanisms that do not interfere with identifiers used by actual devices in the network 600. As another example, in some cases, devices on the network 600 may register themselves with a central controller and/or with a central service on the Internet 650. For example, the thermostat 602 may register with a service on the Internet 650 that monitors energy use for the home. In these cases, the security mechanisms that emulate these types of devices may also register with the central controller or the central service. Doing so may improve the apparent authenticity of the security mechanism, and may avoid conflicts with the central controller or central service. Alternatively or additionally, the security device 660 may determine to deploy security mechanisms that emulate other devices, and avoid registering with the central controller or central service.

In some implementations, the security device 660 may dynamically adjust the security mechanisms that it has deployed. For example, when the homeowner adds devices to the network 600, the security device 660 may remove security mechanisms that conflict with the new devices, or change a security mechanism so that the security mechanism's configuration is not incongruous with the new devices (e.g., the security mechanisms should not have the same MAC address as a new device). As another example, when the network owner removes a device from the network 600, the security device 660 may add a security mechanism that mimics the device that was removed. As another example, the security device may change the activity of a security mechanism, for example, to reflect changes in the normal activity of the home, changes in the weather, the time of year, the occurrence of special events, and so on.

The security device 660 may also dynamically adjust the security mechanisms it has deployed in response to suspicious activity it has detected on the network 600. For example, upon detecting suspicious activity, the security device 660 may change the behavior of a security mechanism or may deploy additional security mechanisms. The changes to the security mechanisms may be directed by the suspicious activity, meaning that if, for example, the suspicious activity appears to be probing for a wireless base station 634, the security device 660 may deploy a decoy wireless base station.

Changes to the security mechanisms are meant not only to attract a possible intrusion, but also to confirm that an intrusion has, in fact occurred. Since the security mechanisms are not part of the normal operation of the network 600, normal occupants of the home are not expected to access the security mechanisms. Thus, in most cases, any access of a security mechanism is suspect. Once the security device 660 has detected an access to a security mechanism, the security device 660 may next attempt to confirm that an intrusion into the network 600 has taken place. An intrusion can be confirmed, for example, by monitoring activity at the security mechanism. For example, login attempts, probing of data emulated by the security mechanism, copying of data from the security mechanism, and attempts to log into another part of the network 600 from the security mechanism indicate a high likelihood that an intrusion has occurred.

Once the security device 660 is able to confirm an intrusion into the network 600, the security device 660 may alert the homeowner. For example, the security device 660 may sound an audible alarm, send an email or text message to the homeowner or some other designated persons, and/or send an alert to an application running on a smartphone or tablet. As another example, the security device 660 may access other network devices and, for example, flash lights, trigger the security system's 626 alarm, and/or display messages on devices that include display screens, such as the television 618 or refrigerator 604. In some implementations, depending on the nature of the intrusion, the security device 660 may alert authorities such as the police or fire department.

In some implementations, the security device 660 may also take preventive actions. For example, when an intrusion appears to have originated outside the network 600, the security device 660 may block the network's 600 access to the Internet 650, thus possibly cutting off the intrusion. As another example, when the intrusion appears to have originated from within the network 600, the security device 660 may isolate any apparently compromised devices, for example by disconnecting them from the network 600. When only its own security mechanisms are compromised, the security device 660 may isolate itself from the rest of the network 600. As another example, when the security device 660 is able to determine that the intrusion very likely included physical intrusion into the house, the security device 660 may alert the authorities. The security device 660 may further lock down the house by, for example, locking any electronic door locks 624.

In some implementations, the security device 660 may be able to enable a homeowner to monitor the network 600 when a suspicious activity has been detected, or at any other time. For example, the homeowner may be provided with a software application that can be installed on a smartphone, tablet, desktop, and/or laptop computer. The software application may receive information from the security device 660 over a wired or wireless connection. Alternatively or additionally, the homeowner may be able to access information about his network through a web browser, where the security device 660 formats webpages for displaying the information. Alternatively or additionally, the security device 660 may itself have a touchscreen or a screen and key pad that provide information about the network 600 to the homeowner.

The information provided to the homeowner may include, for example, a list and/or graphic display of the devices connected to the network 600. The information may further provide a real-time status of each device, such as whether the device is on or off, the current activity of the device, data being transferred to or from the device, and/or the current user of the device, among other things. The list or graphic display may update as devices connect and disconnect from the network 600, such as for example laptops and smartphones connecting to or disconnecting from a wireless sub-network in the network 600. The security device 660 may further alert the homeowner when a device has unexpectedly been disconnected from the network 600. The security device 660 may further alert the homeowner when an unknown device connects to the network 600, such as for example when a device that is not known to the homeowner connects to the Wi-Fi signal.

The security device 660 may also maintain historic information. For example, the security device 660 may provide snapshots of the network 600 taken once a day, once a week, or once a month. The security device 660 may further provide a list of devices that have, for example, connected to the wireless signal in the last hour or day, at what times, and for how long. The security device 660 may also be able to provide identification information for these devices, such as MAC addresses or usernames. As another example, the security device 660 may also maintain usage statistics for each device in the network 600, such as for example the times at which each device was in use, what the device was used for, how much energy the device used, and so on.

The software application or web browser or display interface that provides the homeowner with information about his network 600 may also enable the homeowner to make changes to the network 600 or to devices in the network 600. For example, through the security device 660, the homeowner may be able to turn devices on or off, change the configuration of a device, change a password for a device or for the network, and so on.

In some implementations, the security device 660 may also display currently deployed security mechanisms and their configuration. In some implementations, the security device 660 may also display activity seen at the security mechanisms, such as for example a suspicious access to a security mechanism. In some implementations, the security device 660 may also allow the homeowner to customize the security mechanisms. For example, the homeowner may be able to add or remove security mechanisms, modify data emulated by the security mechanisms, modify the configuration of security mechanism, and/or modify the activity of a security mechanism.

A deception-based network security device 660 thus can provide sophisticated security for a small network. The security device 660 may be simple to add to a network, yet provide comprehensive protection against both external and internal intrusions. Moreover, the security device 660 may be able to monitor multiple sub-networks that are each using different protocols. The security device 660, using deceptive security mechanisms, may be able to detect and confirm intrusions into the network 600. The security device 660 may be able to take preventive actions when an intrusion occurs. The security device 660 may also be able to provide the homeowner with information about his network, and possibly also control over devices in the network.

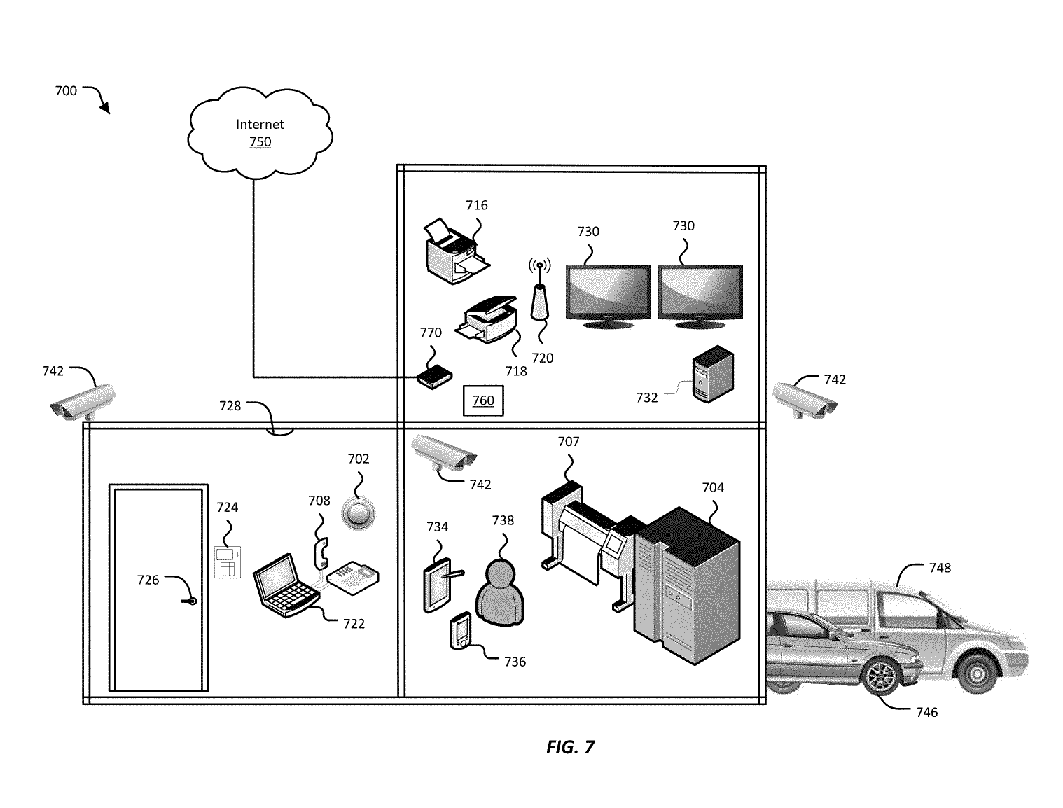

FIG. 7 illustrates another example of a small network 700, here implemented in a small business. A network in a small business may have both traditional and non-traditional devices connected to the network 700. Small business networks are also examples of networks that are often implemented with minimal security. A small business owner may not have the financial or technical resources, time, or expertise to configure a sophisticated security infrastructure for her network 700. The business owner, however, is likely able to at least set up a network 700 for the operation of the business. A deception-based network security device that is at least as simple to set up as the network 700 itself may provide inexpensive and simple yet sophisticated security for the network 700.

The example network 700 may be one, single network, or may include multiple sub-networks. For example, the network 700 may include a wired sub-network, such as an Ethernet network, and a wireless sub-network, such as an 802.11 Wi-Fi network. The wired sub-network may be implemented using cables that have been run through the walls and/or ceilings to the various rooms in the business. The cables may be connected to jacks in the walls that devices can connect to in order to connect to the network 700. The wireless network may be implemented using a wireless base station 720, or several wireless base stations, which provide a wireless signal throughout the business. The network 700 may include other wireless sub-networks, such as a short-distance Bluetooth™ network. In some cases, the sub-networks communicate with one another. For example, the Wi-Fi sub-network may be connected to the wired Ethernet sub-network. In some cases, the various sub-networks in the network 700 may not be configured to or able to communicate with each other.

As noted above, the small business network 700 may include both computers, network infrastructure devices, and other devices not traditionally found in a network. The network 700 may also include electronics, machinery, and systems that have been connected to the network 700 according to an Internet-of-Things approach. Workshop machinery that was once purely analog may now have computer controls. Digital workshop equipment may be network-enabled. By connecting shop equipment and machinery to the network 700, automation and efficiency of the business can be improved and orders, materials, and inventory can be tracked. Having more devices on the network 700, however, may increase the number of vulnerabilities in the network 700. Devices that have only recently become network-enabled may be particularly vulnerable because their security systems have not yet been hardened through use and attack. A deception-based network security device may provide simple-to-install and sophisticated security for a network that may otherwise have only minimal security.

The example small business of FIG. 7 includes a front office. In the front office, the network may include devices for administrative tasks. These devices may include, for example, a laptop computer 722 and a telephone 708. These devices may be attached to the network 700 in order to, for example, access records related to the business, which may be stored on a server 732 located elsewhere in the building. In the front office, security devices for the building may also be found, including, for example, security system controls 724 and an electronic door lock 726. Having the security devices on the network 700 may enable the business owner to remotely control access to the building. The business owner may also be able to remotely monitor the security of building, such as for example being able to view video streams from security cameras 742. The front office may also be where environmental controls, such as a thermostat 702, are located. Having the thermostat 702 on the network 700 may allow the business owner to remotely control the temperature settings. A network-enabled thermostat 702 may also track energy usage for the heating and cooling systems. The front office may also include safety devices, such as a network-connected smoke alarm 728. A network-connected smoke alarm may be able to inform the business owner that there is a problem in the building be connecting to the business owner's smartphone or computer.

Another workspace in this example small business is a workshop. In the workshop, the network 700 may include production equipment for producing the goods sold by the business. The production equipment may include, for example, manufacturing machines 704 (e.g. a milling machine, a Computer Numerical Control (CNC) machine, a 3D printer, or some other machine tool) and a plotter 706. The production equipment may be controlled by a computer on the network 700, and/or may receive product designs over the network 700 and independently execute the designs. In the workshop, one may also find other devices related to the manufacturing of products, such as radiofrequency identification (RFID) scanners, barcode or Quick Response (QR) code generators, and other devices for tracking inventory, as well as electronic tools, hand tools, and so on.

In the workshop and elsewhere in the building, mobile computing devices and people 738 may also be connected to the network 700. Mobile computing devices include, for example, tablet computers 734 and smartphones 736. These devices may be used to control production equipment, track supplies and inventory, receive and track orders, and/or for other operations of the business. People 738 may be connected to the network through network-connected devices worn or implanted in the people 738, such as for example smart watches, fitness trackers, heart rate monitors, drug delivery systems, pacemakers, and so on.

At a loading dock, the example small business may have a delivery van 748 and a company car 746. When these vehicles are away from the business, they may be connected to the network 700 remotely, for example over the Internet 750. By being able to communicate with the network 700, the vehicles may be able to receive information such as product delivery information (e.g., orders, addresses, and/or delivery times), supply pickup instructions, and so on. The business owner may also be able to track the location of these vehicles from the business location, or over the Internet 750 when away from the business, and/or track who is using the vehicles.

The business may also have a back office. In the back office, the network 700 may include traditional network devices, such as computers 730, a multi-function printer 716, a scanner 718, and a server 732. In this example, the computers 730 may be used to design products for manufacturing in the workshop, as well as for management of the business, including tracking orders, supplies, inventory, and/or human resources records. The multi-function printer 716 and scanner 718 may support the design work and the running of the business. The server 732 may store product designs, orders, supply records, and inventory records, as well as administrative data, such as accounting and human resources data.

The back office may also be where a gateway device 770 is located. The gateway device 770 connects the small business to other networks, including the Internet 750. Typically, the gateway device 770 connects to an ISP, and the ISP provides access to the Internet 750. In some cases, a router may be integrated into the gateway device 770. In some cases, gateway device 770 may be connected to an external router, switch, or hub, not illustrated here. In some cases, the network 700 is not connected to any networks outside of the business's own network 700. In these cases, the network 700 may not have a gateway device 770.

The back office is also where the network 700 may have a deception-based network security device 760. The security device 760 may be a standalone device that may be enabled as soon as it is connected to the network 700. Alternatively or additionally, the security device 760 may be integrated into another device connected to the network 700, such as the gateway device 770, a router, a desktop computer 730, a laptop computer 722, the multi-function printer 716, or the thermostat 702, among others. When integrated into another device, the security device 760 may use the network connection of the other device, or may have its own network connection for connecting to the network 700. The security device 760 may connect to the network 700 using a wired connection or a wireless connection.

Once connected to the network 700, the security device 760 may begin monitoring the network 700 for suspect activity. In some implementations, the security device 760 may scan the network 700 to learn which devices are connected to the network 700. In some cases, the security device 760 may learn the normal activity of the network 700, such as what time the various devices are used, for how long, by whom, for what purpose, and what data is transferred to and from each device, among other things.

In some implementations, having learned the configuration and/or activity of the network 700, the security device 760 may deploy deceptive security mechanisms. These security mechanisms may emulate devices that may be found on the network 700, including having an identifiable device type and/or network identifiers (such as a MAC address and/or IP address), and being able to send and receive network traffic that a device of a certain time would send and receive. For example, for the example small business, the security device 760 may configure a security mechanism to emulate a 3D printer, a wide-body scanner, or an additional security camera. The security device 760 may further avoid configuring a security mechanism to emulate a device that is not likely to be found in the small business, such as a washing machine. The security device 760 may use the deployed security mechanisms to monitor activity on the network 700.

In various implementations, when the security device 760 detects suspect activity, the security device 760 may deploy additional security mechanisms. These additional security mechanisms may be selected based on the nature of suspect activity. For example, when the suspect activity appears to be attempting to break into the shop equipment, the security device 760 may deploy a security mechanism that looks like shop equipment that is easy to hack. In some implementations, the security device 760 may deploy security mechanisms only after detecting suspect activity on the network 700.

The security device 760 selects devices to emulate that are particularly attractive for an infiltration, either because the emulated device appears to have valuable data or because the emulated device appears to be easy to infiltrate, or for some other reason. In some implementations, the security device 760 connects to a service on the Internet 750 for assistance in determining which devices to emulate and/or how to configure the emulated device. Once deployed, the security mechanisms serve as decoys to attract the attention of a possible infiltrator away from valuable network assets. In some implementations, the security device 760 emulates the security mechanisms using software processes. In some implementations, the security device 760 may be assisted in emulating security mechanisms by a computer 730 on the network.

In some implementations, the security device 760 may deploy security mechanisms prior to detecting suspicious activity on the network 700. In these implementations, the security mechanisms may present more attractive targets for a possible, future infiltration, so that if an infiltration occurs, the infiltrator will go after the security mechanisms instead of the actual devices on the network 700.

In various implementations, the security device 760 may also change the security mechanisms that it has deployed. For example, the security device 760 may add or remove security mechanisms as the operation of the business changes, as the activity on the network 700 changes, as devices are added or removed from the network 700, as the time of year changes, and so on.

Besides deflecting a possible network infiltration away from valuable or vulnerable network devices, the security device 760 may use the security mechanisms to confirm that the network 700 has been infiltrated. Because the security mechanisms are not part of actual devices in use by the business, any access to them over the network is suspect. Thus, once the security device 760 detects an access to one of its security mechanisms, the security device 760 may attempt to confirm that this access is, in fact, an unauthorized infiltration of the network 700.

To confirm that a security mechanism has been infiltrated, the security device 760 may monitor activity seen at the security mechanism. The security device 760 may further deploy additional security mechanisms, to see if, for example, it can present an even more attractive target to the possible infiltrator. The security device 760 may further look for certain activity, such as log in attempts to other devices in the network, attempts to examine data on the security mechanism, attempts to move data from the security mechanism to the Internet 750, scanning of the network 700, password breaking attempts, and so on.

Once the security device 760 has confirmed that the network 700 has been infiltrated, the security device 760 may alert the business owner. For example, the security device 760 may sound an audible alarm, email or send text messages to the computers 730 and/or handheld devices 734, 736, send a message to the business's cars 746, 748, flash lights, or trigger the security system's 724 alarm. In some implementations, the security device 760 may also take preventive measures. For example, the security device 760 may disconnect the network 700 from the Internet 750, may disconnect specific devices from the network 700 (e.g., the server 732 or the manufacturing machines 704), may turn some network-connected devices off, and/or may lock the building.

In various implementations, the security device 760 may allow the business owner to monitor her network 700, either when an infiltration is taking place or at any other time. For example, the security device 760 may provide a display of the devices currently connected to the network 700, including flagging any devices connected to the wireless network that do not appear to be part of the business. The security device 760 may further display what each device is currently doing, who is using them, how much energy each device is presently using, and/or how much network bandwidth each device is using. The security device 760 may also be able to store this information and provide historic configuration and/or usage of the network 700.

The security device 760 may have a display it can use to show information to the business owner. Alternatively or additionally, the security device 760 may provide this information to a software application that can run on a desktop or laptop computer, a tablet, or a smartphone. Alternatively or additionally, the security device 760 may format this information for display through a web browser. The business owner may further be able to control devices on the network 700 through an interface provided by the security device 760, including, for example, turning devices on or off, adjusting settings on devices, configuring user accounts, and so on. The business owner may also be able to view any security mechanisms presently deployed, and may be able to re-configure the security mechanisms, turn them off, or turn them on.

IoT networks can also include industrial control systems. Industrial control system is a general term that encompasses several types of control systems, including supervisory control and data acquisition (SCADA) systems, distributed control systems (DCS) and other control system configurations, such as Programmable Logic Controllers (PLCs), often found in the industrial sectors and infrastructures. Industrial control systems are often found in industries such as electrical, water and wastewater, oil and natural gas, chemical, transportation, pharmaceutical, pulp and paper, food and beverage, and discrete manufacturing (e.g., automotive, aerospace, and durable goods). While a large percentage of industrial control systems may be privately owned and operated, federal agencies also operate many industrial processes, such as air traffic control systems and materials handling (e.g., Postal Service mail handling).

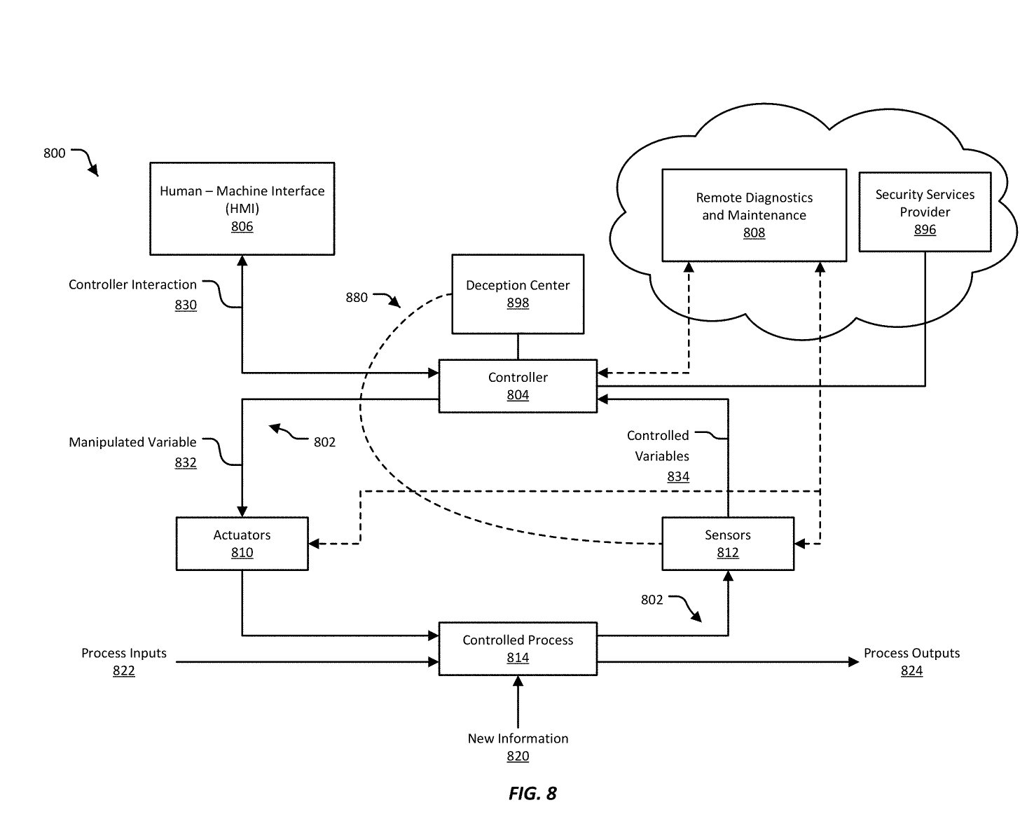

FIG. 8 illustrates an example of the basic operation of an industrial control system 800. Generally, an industrial control system 800 may include a control loop 802, a human-machine interface 806, and remote diagnostics and maintenance 808. In some implementations, the example industrial control system can be defended by a network threat detection and analysis system, which can include a deception center 898 and a security services provider 896.

A control loop 802 may consist of sensors 812, controller 804 hardware such as PLCs, actuators 810, and the communication of variables 832, 834. The sensors 812 may be used for measuring variables in the system, while the actuators 810 may include, for example, control valves breakers, switches, and motors. Some of the sensors 812 may be deceptions sensors. Controlled variables 834 may be transmitted to the controller 804 from the sensors 812. The controller 804 may interpret the controlled variables 834 and generates corresponding manipulated variables 832, based on set points provided by controller interaction 830. The controller 804 may then transmit the manipulated variables 832 to the actuators 810. The actuators 810 may drive a controlled process 814 (e.g., a machine on an assembly line). The controlled process 814 may accept process inputs 822 (e.g., raw materials) and produce process outputs 824 (e.g., finished products). New information 820 provided to the controlled process 814 may result in new sensor 812 signals, which identify the state of the controlled process 814 and which may also transmitted to the controller 804.

In some implementations, at least some of the sensors 812 can also provide the deception center 898 with visibility into the industrial control system 800, such as for example being able to present or project deceptive security mechanisms into the industrial control system. Additionally, in various implementations, the sensors 812 may provide a portal through which a suspected attack on the industrial control system can be redirected to the deception center 898. The deception center 898 and the sensors 810 may be able to communicate using network tunnels 880.

The deception center 898 provides network security for the industrial control system 800 by deploying security mechanisms into the industrial control system 800, monitoring the industrial control system through the security mechanisms, detecting and redirecting apparent threats, and analyzing network activity resulting from the apparent threat. In some implementations, the industrial control system 800 can include more than one deception center 898. In some implementations, the deception center may be located off-site, such as on the Internet.

In some implementations, the deception center 898 may interact with a security services provider 896 located outside the industrial control system 800. The security services provider 896 may act as a central hub for providing security to multiple sites that are part of the industrial control system 800, and/or for multiple separate, possibly unrelated, industrial control systems. For example, the security services provider 896 may communicate with multiple deception centers 898 that each provide security for a different industrial control system 800 for the same organization. As another example, the security services provider 896 may coordinate the activities of the deception center 898 and the sensors 812, such as enabling the deception center 898 and the sensors 812 to connect to each other. In some implementations, the security services provider 896 is located outside the industrial control system 800. In some implementations, the security services provider 896 is controlled by a different entity than the entity that controls the site network. For example, the security services provider 896 may be an outside vendor. In some implementations, the security services provider 896 is controlled by the same entity as that controls the industrial control system. In some implementations, the network security system does not include a security services provider 896.

The human-machine interface 806 provides operators and engineers with an interface for controller interaction 830. Controller interaction 830 may include monitoring and configuring set points and control algorithms, and adjusting and establishing parameters in the controller 804. The human-machine interface 806 typically also receives information from the controller 804 that allows the human-machine interface 806 to display process status information and historical information about the operation of the control loop 802.

The remote diagnostics and maintenance 808 utilities are typically used to prevent, identify, and recover from abnormal operation or failures. For diagnostics, the remote diagnostics and maintenance 808 utilities may monitor the operation of each of the controller 804, sensors 812, and actuators 810. To recover after a problem, the remote diagnostics and maintenance 808 utilities may provide recovery information and instructions to one or more of the controller 804, sensors 812, and/or actuators 810.

A typical industrial control system contains many control loops, human-machine interfaces, and remote diagnostics and maintenance tools, built using an array of network protocols on layered network architectures. In some cases, multiple control loops are nested and/or cascading, with the set point for one control loop being based on process variables determined by another control loop. Supervisory-level control loops and lower-level control loops typically operate continuously over the duration of a process, with cycle times ranging from milliseconds to minutes.

One type of industrial control system that may include many control loops, human-machine interfaces, and remote diagnostics and maintenance tools is a supervisory control and data acquisition (SCADA) system. SCADA systems are used to control dispersed assets, where centralized data acquisition is typically as important as control of the system. SCADA systems are used in distribution systems such as, for example, water distribution and wastewater collection systems, oil and natural gas pipelines, electrical utility transmission and distribution systems, and rail and other public transportation systems, among others. SCADA systems typically integrate data acquisition systems with data transmission systems and human-machine interface software to provide a centralized monitoring and control system for numerous process inputs and outputs. SCADA systems are typically designed to collect field information, transfer this information to a central computer facility, and to display the information to an operator in a graphic and/or textual manner. Using this displayed information, the operator may, in real time, monitor and control an entire system from a central location. In various implementations, control of any individual sub-system, operation, or task can be automatic, or can be performed by manual commands.

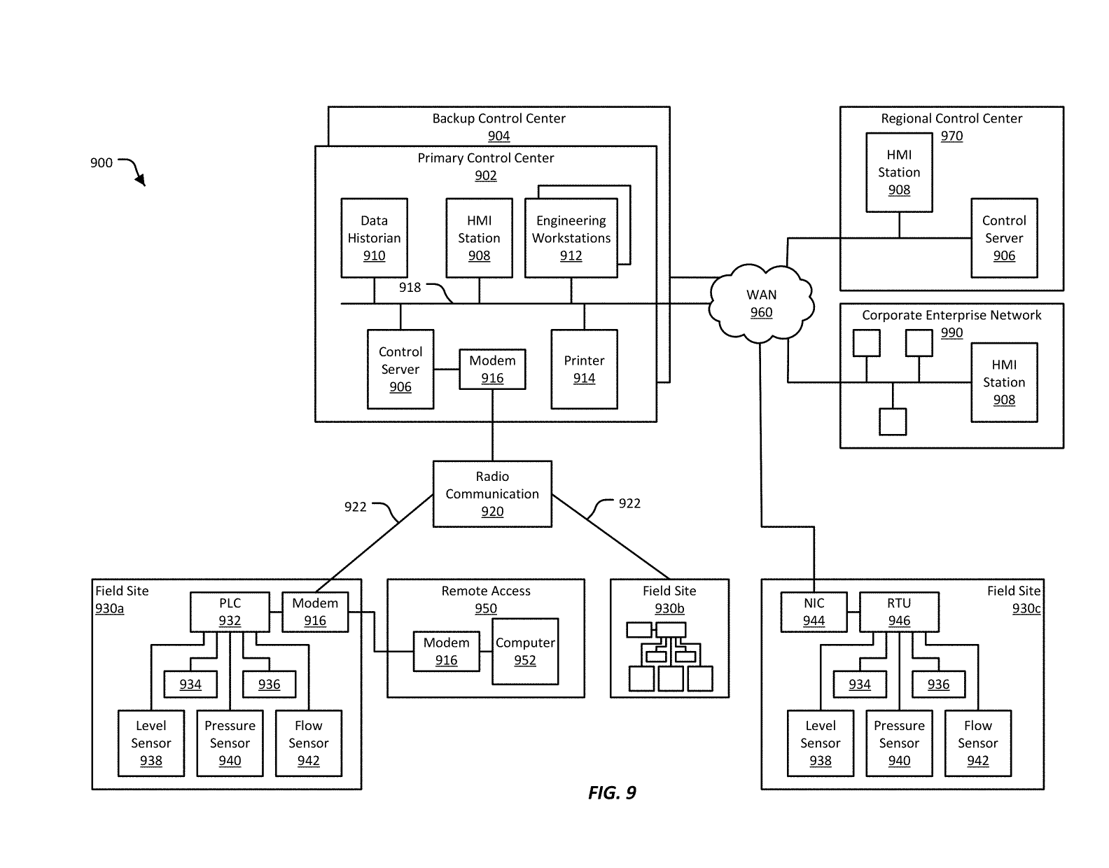

FIG. 9 illustrates an example of a SCADA system 900, here used for distributed monitoring and control. This example SCADA system 900 includes a primary control center 902 and three field sites 930a-930c. A backup control center 904 provides redundancy in case of there is a malfunction at the primary control center 902. The primary control center 902 in this example includes a control server 906—which may also be called a SCADA server or a Master Terminal Unit (MTU)—and a local area network (LAN) 908. The primary control center 902 may also include a human-machine interface station 908, a data historian 910, engineering workstations 912, and various network equipment such as printers 914, each connected to the LAN 918.

The control server 906 typically acts as the master of the SCADA system 900. The control server 906 typically includes supervisory control software that controls lower-level control devices, such as Remote Terminal Units (RTUs) and PLCs, located at the field sites 930a-930c. The software may tell the system 900 what and when to monitor, what parameter ranges are acceptable, and/or what response to initiate when parameters are outside of acceptable values.

The control server 906 of this example may access Remote Terminal Units and/or PLCs at the field sites 930a-930c using a communications infrastructure, which may include radio-based communication devices, telephone lines, cables, and/or satellites. In the illustrated example, the control server 906 is connected to a modem 916, which provides communication with serial-based radio communication 920, such as a radio antenna. Using the radio communication 920, the control server 906 can communicate with field sites 930a-930b using radiofrequency signals 922. Some field sites 930a-930b may have radio transceivers for communicating back to the control server 906.

A human-machine interface station 908 is typically a combination of hardware and software that allows human operators to monitor the state of processes in the SCADA system 900. The human-machine interface station 908 may further allow operators to modify control settings to change a control objective, and/or manually override automatic control operations, such as in the event of an emergency. The human-machine interface station 908 may also allow a control engineer or operator to configure set points or control algorithms and parameters in a controller, such as a Remote Terminal Unit or a PLC. The human-machine interface station 908 may also display process status information, historical information, reports, and other information to operators, administrators, mangers, business partners, and other authorized users. The location, platform, and interface of a human-machine interface station 908 may vary. For example, the human-machine interface station 908 may be a custom, dedicated platform in the primary control center 902, a laptop on a wireless LAN, or a browser on a system connected to the Internet.

The data historian 910 in this example is a database for logging all process information within the SCADA system 900. Information stored in this database can be accessed to support analysis of the system 900, for example for statistical process control or enterprise level planning.

The backup control center 904 may include all or most of the same components that are found in the primary control center 902. In some cases, the backup control center 904 may temporarily take over for components at the primary control center 902 that have failed or have been taken offline for maintenance. In some cases, the backup control center 904 is configured to take over all operations of the primary control center 902, such as when the primary control center 902 experiences a complete failure (e.g., is destroyed in a natural disaster).

The primary control center 902 may collect and log information gathered by the field sites 930a-930c and display this information using the human-machine interface station 908. The primary control center 902 may also generate actions based on detected events. The primary control center 902 may, for example, poll field devices at the field sites 930a-930c for data at defined intervals (e.g., 5 or 60 seconds), and can send new set points to a field device as required. In addition to polling and issuing high-level commands, the primary control center 902 may also watch for priority interrupts coming from the alarm systems at the field sites 930a-930c.

In this example, the primary control center 902 uses point-to-point connections to communication with three field sites 930a-930c, using radio telemetry for two communications with two of the field sites 930a-930b. In this example, the primary control center 902 uses a wide area network (WAN) 960 to communicate with the third field site 930c. In other implementations, the primary control center 902 may use other communication topologies to communicate with field sites. Other communication topologies include rings, stars, meshes, trees, lines or series, and busses or multi-drops, among others. Standard and proprietary communication protocols may be used to transport information between the primary control center 902 and field sites 930a-930c. These protocols may use telemetry techniques such as provided by telephone lines, cables, fiber optics, and/or radiofrequency transmissions such as broadcast, microwave, and/or satellite communications.

The field sites 930a-930c in this example perform local control of actuators and monitor local sensors. For example, a first field site 930a may include a PLC 932. A PLC is a small industrial computer originally designed to perform the logic functions formerly executed by electrical hardware (such as relays, switches, and/or mechanical timers and counters). PLCs have evolved into controllers capable of controlling complex processes, and are used extensively in both SCADA systems and distributed control systems. Other controllers used at the field level include process controllers and Remote Terminal Units, which may provide the same level of control as a PLC but may be designed for specific control applications. In SCADA environments, PLCs are often used as field devices because they are more economical, versatile, flexible, and configurable than special-purpose controllers.

The PLC 932 at a field site, such as the first field site 930a, may control local actuators 934, 936 and monitor local sensors 938, 940, 942. Examples of actuators include valves 934 and pumps 936, among others. Examples of sensors include level sensors 938, pressure sensors 940, and flow sensors 942, among others. Any of the actuators 934, 936 or sensors 938, 940, 942 may be “smart” actuators or sensors, more commonly called intelligent electronic devices (LEDs). Intelligent electronic devices may include intelligence for acquiring data, communicating with other devices, and performing local processing and control. An intelligent electronic device could combine an analog input sensor, analog output, low-level control capabilities, a communication system, and/or program memory in one device. The use of intelligent electronic devices in SCADA systems and distributed control systems may allow for automatic control at the local level. Intelligent electronic devices, such as protective relays, may communicate directly with the control server 906. Alternatively or additionally, a local Remote Terminal Unit may poll intelligent electronic devices to collect data, which it may then pass to the control server 906.

Field sites 930a-930c are often equipped with remote access capability that allows field operators to perform remote diagnostics and repairs. For example, the first remote 930a may include a modem 916 connected to the PLC 932. A remote access 950 site may be able to, using a dial up connection, connect to the modem 916. The remote access 950 site may include its own modem 916 for dialing into to the field site 930a over a telephone line. At the remote access 950 site, an operator may use a computer 952 connected to the modem 916 to perform diagnostics and repairs on the first remote field site 930a.

The example SCADA system 900 includes a second field site 930b, which may be provisioned in substantially the same way as the first field site 930a, having at least a modem and a PLC or Remote Terminal that controls and monitors some number of actuators and sensors.

The example SCADA system 900 also includes a third field site 930c that includes a network interface card (NIC) 944 for communicating with the system's 900 WAN 960. In this example, the third field site 930c includes a Remote Terminal Unit 946 that is responsible for controlling local actuators 934, 936 and monitoring local sensors 938, 940, 942. A Remote Terminal Unit, also called a remote telemetry unit, is a special-purpose data acquisition and control unit typically designed to support SCADA remote stations. Remote Terminal Units may be field devices equipped with wireless radio interfaces to support remote situations where wire-based communications are unavailable. In some cases, PLCs are implemented as Remote Terminal Units.

The SCADA system 900 of this example also includes a regional control center 970 and a corporate enterprise network 980. The regional control center 970 may provide a higher level of supervisory control. The regional control center 970 may include at least a human-machine interface station 908 and a control server 906 that may have supervisory control over the control server 906 at the primary control center 902. The corporate enterprise network 980 typically has access, through the system's 900 WAN 960, to all the control centers 902, 904 and to the field sites 930a-930c. The corporate enterprise network 980 may include a human-machine interface station 908 so that operators can remotely maintain and troubleshoot operations.

Another type of industrial control system is the distributed control system (DCS). Distributed control systems are typically used to control production systems within the same geographic location for industries such as oil refineries, water and wastewater management, electric power generation plants, chemical manufacturing plants, and pharmaceutical processing facilities, among others. These systems are usually process control or discrete part control systems. Process control systems may be processes that run continuously, such as manufacturing processes for fuel or steam flow in a power plant, for petroleum production in a refinery, or for distillation in a chemical plant. Discrete part control systems have processes that have distinct processing steps, typically with a distinct start and end to each step, such as found in food manufacturing, electrical and mechanical parts assembly, and parts machining. Discrete-based manufacturing industries typically conduct a series of steps on a single item to create an end product.

A distributed control system typically uses a centralized supervisory control loop to mediate a group of localized controllers that share the overall tasks of carrying out an entire production process. By modularizing the production system, a distributed control system may reduce the impact of a single fault on the overall system. A distributed control system is typically interfaced with a corporate network to give business operations a view of the production process.

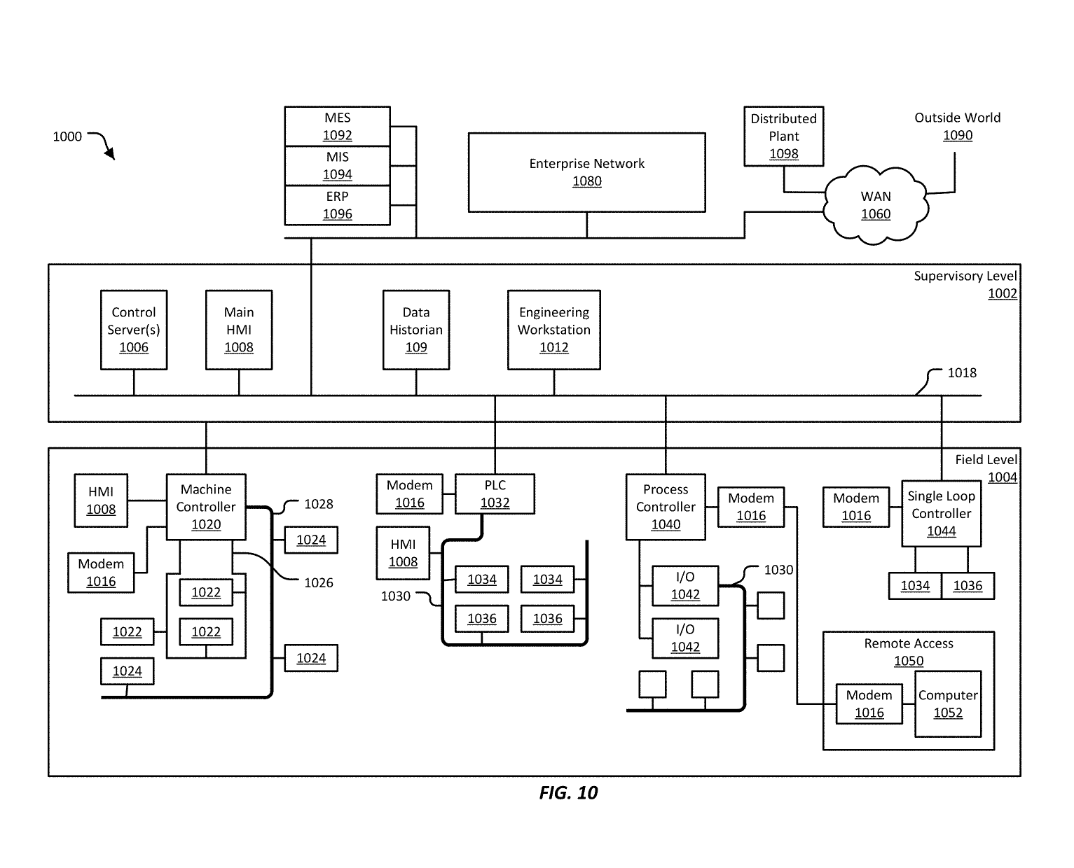

FIG. 10 illustrates an example of a distributed control system 1000. This example distributed control system 1000 encompasses a production facility, including bottom-level production processes at a field level 1004, supervisory control systems at a supervisory level 1002, and a corporate or enterprise layer.

At the supervisory level 1002, a control server 1006, operating as a supervisory controller, may communicate with subordinate systems via a control network 1018. The control server 1006 may send set points to distributed field controllers, and may request data from the distributed field controllers. The supervisory level 1002 may include multiple control servers 1006, with one acting as the primary control server and the rest acting as redundant, back-up control servers. The supervisory level 1002 may also include a main human-machine interface 1008 for use by operators and engineers, a data historian 1010 for logging process information from the system 1000, and engineering workstations 1012.

At the field level 1004, the system 1000 may include various distributed field controllers. In the illustrated example, the distributed control system 1000 includes a machine controller 1020, a PLC 1032, a process controller 1040, and a single loop controller 1044. The distributed field controllers may each control local process actuators, based on control server 1006 commands and sensor feedback from local process sensors.

In this example, the machine controller 1020 drives a motion control network 1026. Using the motion control network 1026, the machine controller 1020 may control a number of servo drives 1022, which may each drive a motor. The machine controller 1020 may also drive a logic control bus 1028 to communicate with various devices 1024. For example, the machine controller 1020 may use the logic control bus 1028 to communicate with pressure sensors, pressure regulators, and/or solenoid valves, among other devices. One or more of the devices 1024 may be an intelligent electronic device. A human-machine interface 1008 may be attached to the machine controller 1020 to provide an operator with local status information about the processes under control of the machine controller 1020, and/or local control of the machine controller 1020. A modem 1016 may also be attached to the machine controller 1020 to provide remote access to the machine controller 1020.

The PLC 1032 in this example system 1000 uses a fieldbus 1030 to communicate with actuators 1034 and sensors 1036 under its control. These actuators 1034 and sensors 1036 may include, for example, direct current (DC) servo drives, alternating current (AC) servo drives, light towers, photo eyes, and/or proximity sensors, among others. A human-machine interface 1008 may also be attached to the fieldbus 1030 to provide operators with local status and control for the PLC 1032. A modem 1016 may also be attached to the PLC 1032 to provide remote access to the PLC 1032.

The process controller 1040 in this example system 1000 also uses a fieldbus 1030 to communicate with actuators and sensors under its control, one or more of which may be intelligent electronic devices. The process controller 1040 may communicate with its fieldbus 1030 through an input/output (I/O) server 1042. An I/O server is a control component typically responsible for collecting, buffering, and/or providing access to process information from control sub-components. An I/O server may be used for interfacing with third-party control components. Actuators and sensors under control of the process controller 1040 may include, for example, pressure regulators, pressure sensors, temperature sensors, servo valves, and/or solenoid valves, among others. The process controller 1040 may be connected to a modem 1016 so that a remote access 1050 site may access the process controller 1040. The remote access 1050 site may include a computer 1052 for use by an operator to monitor and control the process controller 1040. The computer 1052 may be connected to a local modem 1016 for dialing in to the modem 1016 connected to the process controller 1040.

The illustrated example system 1000 also includes a single loop controller 1044. In this example, the single loop controller 1044 interfaces with actuators 1034 and sensors 1036 with point-to-point connections, instead of a fieldbus. Point-to-point connections require a dedicated connection for each actuator 1034 and each sensor 1036. Fieldbus networks, in contrast, do not need point-to-point connections between a controller and individual field sensors and actuators. In some implementations, a fieldbus allows greater functionality beyond control, including field device diagnostics. A fieldbus can accomplish control algorithms within the fieldbus, thereby avoiding signal routing back to a PLC for every control operation. Standard industrial communication protocols are often used on control networks and fieldbus networks.

The single loop controller 1044 in this example is also connected to a modem 1016, for remote access to the single loop controller.

In addition to the supervisory level 1002 and field level 1004 control loops, the distributed control system 1000 may also include intermediate levels of control. For example, in the case of a distributed control system controlling a discrete part manufacturing facility, there could be an intermediate level supervisor for each cell within the plant. This intermediate level supervisor could encompass a manufacturing cell containing a machine controller that processes a part, and a robot controller that handles raw stock and final products. Additionally, the distributed control system could include several of these cells that manage field-level controllers under the main distributed control system supervisory control loop.

In various implementations, the distributed control system may include a corporate or enterprise layer, where an enterprise network 1080 may connect to the example production facility. The enterprise network 1080 may be, for example, located at a corporate office co-located with the facility, and connected to the control network 1018 in the supervisory level 1002. The enterprise network 1080 may provide engineers and managers with control and visibility into the facility. The enterprise network 1080 may further include Manufacturing Execution Systems (MES) 1092, control systems for managing and monitoring work-in-process on a factory floor. An MES can track manufacturing information in real time, receiving up-to-the-minute data from robots, machine monitors and employees. The enterprise network 1080 may also include Management Information Systems (MIS) 1094, software and hardware applications that implement, for example, decision support systems, resource and people management applications, project management, and database retrieval applications, as well as basic business functions such as order entry and accounting. The enterprise network 1080 may further include Enterprise Resource Planning (ERP) systems 1096, business process management software that allows an organization to use a system of integrated applications to manage the business and automate many back office functions related to technology, services, and human resources.

The enterprise network 1080 may further be connected to a WAN 1060. Through the WAN 1060, the enterprise network 1080 may connect to a distributed plant 1098, which may include control loops and supervisory functions similar to the illustrated facility, but which may be at a different geographic location. The WAN 1060 may also connect the enterprise network to the outside world 1090, that is, to the Internet and/or various private and public networks. In some cases, the WAN 1060 may itself include the Internet, so that the enterprise network 1080 accesses the distributed plant 1098 over the Internet.

As described above, SCADA systems and distributed control systems use Programmable Logic Controllers (PLCs) as the control components of an overall hierarchical system. PLCs can provide local management of processes through feedback control, as described above. In a SCADA implementation, a PLC can provide the same functionality as a Remote Terminal Unit. When used in a distributed control system, PLCs can be implemented as local controllers within a supervisory scheme. PLCs can have user-programmable memory for storing instructions, where the instructions implement specific functions such as I/O control, logic, timing, counting, proportional-integral-derivative (PID) control, communication, arithmetic, and data and file processing.

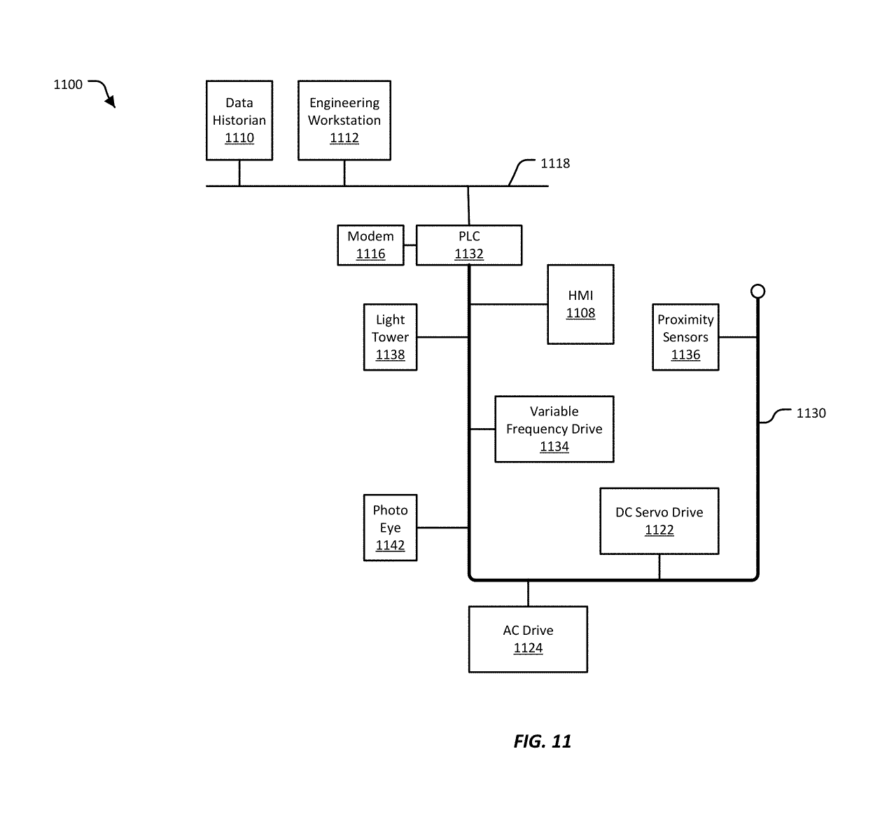

FIG. 11 illustrates an example of a PLC 1132 implemented in a manufacturing control process. The PLC 1132 in this example monitors and controls various devices over fieldbus network 1130. The PLC 1132 may be connected to a LAN 1118. An engineering workstation 1112 may also be connected to the LAN 1118, and may include a programming interface that provides access to the PLC 1132. A data historian 1110 on the LAN 1118 may store data produced by the PLC 1132.

The PLC 1132 in this example may control a number of devices attached to its fieldbus network 1130. These devices may include actuators, such as a DC servo drive 1122, an AC drive 1124, a variable frequency drive 1134, and/or a light tower 1138. The PLC 1132 may also monitor sensors connected to the fieldbus network 1130, such as proximity sensors 1136, and/or a photo eye 1142. A human-machine interface 1108 may also be connected to the fieldbus network 1130, and may provide local monitoring and control of the PLC 1132.

Most industrial control systems were developed years ago, long before public and private networks, desktop computing, or the Internet were a common part of business operations. These well-established industrial control systems were designed to meet performance, reliability, safety, and flexibility requirements. In most cases, they were physically isolated from outside networks and based on proprietary hardware, software, and communication protocols that included basic error detection and correction capabilities, but lacked secure communication capabilities. While there was concern for reliability, maintainability, and availability when addressing statistical performance and failure, the need for cyber security measures within these systems was not anticipated. At the time, security for industrial control systems mean physically securing access to the network and the consoles that controlled the systems.

Internet-based technologies have since become part of modern industrial control systems. Widely available, low-cost IP devices have replaced proprietary solutions, which increases the possibility of cyber security vulnerabilities and incidents. Industrial control systems have adopted Internet-based solutions to promote corporate connectivity and remote access capabilities, and are being designed and implemented using industry standard computers, operating systems (OS) and network protocols. As a result, these systems may to resemble computer networks. This integration supports new networking capabilities, but provides less isolation for industrial control systems from the outside world than predecessor systems. Networked industrial control systems may be exposed to similar threats as are seen in computer networks, and an increased likelihood that an industrial control system can be compromised.

Industrial control system vendors have begun to open up their proprietary protocols and publish their protocol specifications to enable third-party manufacturers to build compatible accessories. Organizations are also transitioning from proprietary systems to less expensive, standardized technologies such as Microsoft Windows and Unix-like operating systems as well as common networking protocols such as TCP/IP to reduce costs and improve performance. Another standard contributing to this evolution of open systems is Open Platform Communications (OPC), a protocol that enables interaction between control systems and PC-based application programs. The transition to using these open protocol standards provides economic and technical benefits, but also increases the susceptibility of industrial control systems to cyber incidents. These standardized protocols and technologies have commonly known vulnerabilities, which are susceptible to sophisticated and effective exploitation tools that are widely available and relatively easy to use.

Industrial control systems and corporate networking systems are often interconnected as a result of several changes in information management practices, operational, and business needs. The demand for remote access has encouraged many organizations to establish connections to the industrial control system that enable of industrial control systems engineers and support personnel to monitor and control the system from points outside the control network. Many organizations have also added connections between corporate networks and industrial control systems networks to allow the organization's decision makers to obtain access to critical data about the status of their operational systems and to send instructions for the manufacture or distribution of product.

In early implementations this might have been done with custom applications software or via an OPC server/gateway, but, in the past ten years this has been accomplished with TCP/IP networking and standardized IP applications like File Transfer Protocol (FTP) or Extensible Markup Language (XML) data exchanges. Often, these connections were implemented without a full understanding of the corresponding security risks. In addition, corporate networks are often connected to strategic partner networks and to the Internet. Control systems also make more use of WANs and the Internet to transmit data to their remote or local stations and individual devices. This integration of control system networks with public and corporate networks increases the accessibility of control system vulnerabilities. These vulnerabilities can expose all levels of the industrial control system network architecture to complexity-induced error, adversaries and a variety of cyber threats, including worms and other malware.

Many industrial control system vendors have delivered systems with dial-up modems that provide remote access to ease the burdens of maintenance for the technical field support personnel. Remote access can be accomplished, for example, using a telephone number, and sometimes an access control credential (e.g., valid ID, and/or a password). Remote access may provide support staff with administrative-level access to a system. Adversaries with war dialers—simple personal computer programs that dial consecutive phone numbers looking for modems—and password cracking software could gain access to systems through these remote access capabilities. Passwords used for remote access are often common to all implementations of a particular vendor's systems and may have not been changed by the end user. These types of connections can leave a system highly vulnerable because people entering systems through vendor-installed modems are may be granted high levels of system access.

Organizations often inadvertently leave access links such as dial-up modems open for remote diagnostics, maintenance, and monitoring. Also, control systems increasingly utilize wireless communications systems, which can be vulnerable. Access links not protected with authentication and/or encryption have the increased risk of adversaries using these unsecured connections to access remotely controlled systems. This could lead to an adversary compromising the integrity of the data in transit as well as the availability of the system, both of which can result in an impact to public and plant safety. Data encryption may be a solution, but may not be the appropriate solution in all cases.

Many of the interconnections between corporate networks and industrial control systems require the integration of systems with different communications standards. The result is often an infrastructure that is engineered to move data successfully between two unique systems. Because of the complexity of integrating disparate systems, control engineers often fail to address the added burden of accounting for security risks. Control engineers may have little training in security and often network security personnel are not involved in security design. As a result, access controls designed to protect control systems from unauthorized access through corporate networks may be minimal. Protocols, such as TCP/IP and others have characteristics that often go unchecked, and this may counter any security that can be done at the network or the application levels.

Public information regarding industrial control system design, maintenance, interconnection, and communication may be readily available over the Internet to support competition in product choices as well as to enable the use of open standards. Industrial control system vendors also sell toolkits to help develop software that implements the various standards used in industrial control system environments. There are also many former employees, vendors, contractors, and other end users of the same industrial control system equipment worldwide who have inside knowledge about the operation of control systems and processes.

Information and resources are available to potential adversaries and intruders of all calibers around the world. With the available information, it is quite possible for an individual with very little knowledge of control systems to gain unauthorized access to a control system with the use of automated attack and data mining tools and a factory-set default password. Many times, these default passwords are never changed.

### IV. Deception Center

The various customer networks described above may have some network security systems, or may have little network security. Each may be better protected by a network security system, such as the deception-based system discussed above.

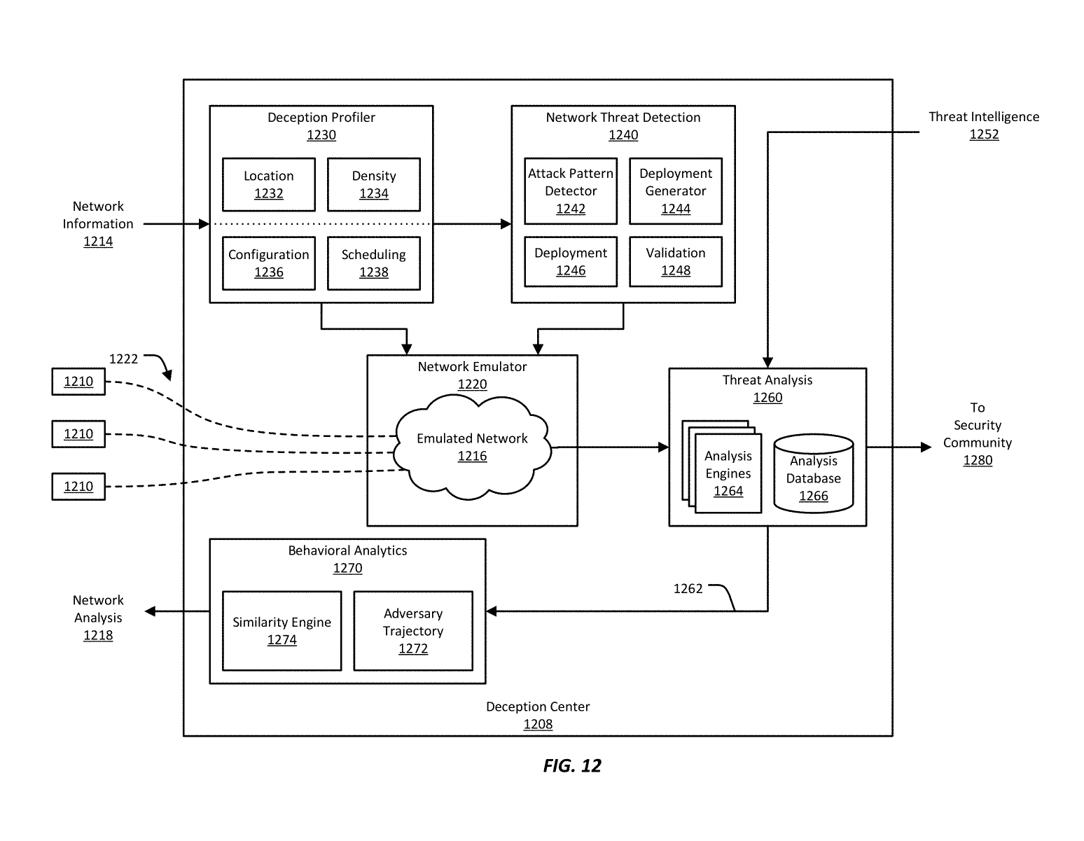

As discussed above, a network threat and analysis system may include a deception center that is configured to provide network threat detection, analysis of network threats, and defense against network threats. FIG. 12 illustrates an example of a deception center 1208. In this example, the deception center 1208 includes at least five major components: a network emulator 1220, a deception profiler 1230, a network threat detection engine 1240, a threat analysis engine 1260, and a behavioral analytics engine 1270. In various implementations, each of these components may be implemented using hardware, software, or a combination of hardware and software. In some implementations, one or more of the components may be combined. In some implementations, one or more of the components may be broken down into multiple components. In some implementations, the deception center 1208 may be implemented as a single appliance. In some implementations, the deception center 1208 may be implemented using a combination of computing systems. For example, one or more of the five example components may be implemented in a separate server. Alternatively or additionally, one or more of the components can be implemented as software processes. Alternatively or additionally, one or more of the components can be combined into one software process.

The network emulator 1220 may be a system configured to host an emulated network 1216. The emulated network 1216 may include one or more emulated network devices. An emulated network device is a hardware and/or software component configured to mimic some or all of the behavior of a network device that may be found in a site network. For example, an emulated network device may include at least a distinct MAC address and IP address. The emulated network devices in the emulated network 1216 may be used as deception mechanism in a site network. The emulated network devices may include, for example, address deception mechanisms, low-interaction deception mechanisms, and/or high-interaction deception mechanisms. In various implementations, the emulated network 1216 may be quickly reconfigured. For example, new emulated network devices can be launched or existing emulated network devices can be removed. Alternatively or additionally, emulated network devices can be reconfigured. For example, an address deception can be escalated to a low-interaction deception, and/or a low-interaction deception can be escalated to a high-interaction deception. In some implementations, the emulated network 1216 may be configured to act and respond as a fully functional network. In these implementations, the emulated network 1216 may be referred to as a high-interaction network.

The emulated network 1216 may be connected to one or more sensors 1210 installed in the site network over network tunnels 1222. The emulated network devices can be projected over the network tunnels 1222 and through the sensors 1210 into the site network, where they emulated network devices can function as deception mechanisms. The network emulator 1220 is described in further detail below.

The deception profiler 1230 may be configured to analyze the site network to determine which deception mechanisms to deploy into the site network, where to deploy them, and/or when to deploy them. The deception profiler 1230 may receive network information 1214 from the site network. This network information 1214 may include information such as subnet addresses, IP addresses in use, an identity and/or configuration of devices in the site network, and/or profiles of usage patterns of the devices in the site network. Using this information, the deception profiler 1230 may configure one or more deception mechanisms. For example, the deception profiler 1230 may instruct the network emulator 1220 to reconfigure the emulated network 1216.

The deception profiler 1230 in this example includes a location engine 1232, a density engine 1234, a configuration engine 1236, and a scheduling engine 1238. The location engine 1232 may determine where in the site network to deploy deception mechanisms. The density engine 1234 may determine how many deception mechanisms to deploy. The configuration engine 1236 may determine how each deception mechanism is to be configured, and may provide configurations to the network emulator 1220. The scheduling engine 1238 may determine when a deception mechanism should be deployed and/or activated. The components of the deception profiler 1230 are described in further detail below.

The network threat detection engine 1240 may be configured to monitor the site network and watch for possible attacks. For example, the network threat detection engine 1240 may detect an access to a deception mechanism. The network threat detection engine 1240 may further attempt to confirm that suspicious activity in the site network is an actual attack. To do so, in various implementations, the network threat detection engine 1240 may instruct the network emulator 1220 to reconfigure the emulated network 1216 to create deceptions that are more attractive to an attacker and/or to contain the possible attacker to the emulated network 1216.

In this example, the network threat detection engine 1240 includes an attack pattern detector 1242, a deployment generator 1244, a deployment engine 1246, and a validation engine 1248. The attack pattern detector 1242 may receive network information 1214 from various network devices in the site network, and analyze the network information 1214 to determine whether a network abnormality has occurred or is occurring. The deployment generator 1244 may analyzes suspected attack patterns from the attack pattern detector 1242 to determine what should be done to confirm that an attack has occurred or is in progress. The deployment engine 1246 may implement a deployment strategy generated by the deployment generator 1244. The deployment strategy may include instructing the network emulator 1220 to add, remove, and/or modify emulated network devices in the emulated network 1216, and/or to modify the deception mechanisms projected into the site network. The validation engine 1248 may analyze the deployment strategy and feedback data received from the site network and/or the emulated network 1216 to confirm whether an attack has occurred. The network threat detection engine 1240 is described in further detail below.

The threat analysis engine 1260 may receive data collected from the emulated network during the course of an incident that has been allowed to proceed within the emulated network 1216. Generally, when a suspected threat to the site network has been detected, the components of the deception center 1208 may redirect and contain suspect network traffic related to the attack to the emulated network 1216. Once contained to the emulated network 1216, the suspected attacked may be allowed to proceed. By allowing the suspected attack to proceed, information can be learned about the suspected attack, such as the manner of the attack, the motivation for the attack, network vulnerabilities that allow the attack to proceed, and so on. As the attack is allowed to proceed, information is collected by the emulated network 1216, such as log files, memory snapshots, packets, and any other information that may be generated by suspect network traffic and interacting with suspect network traffic.

In various implementations, the threat analysis engine 1260 may include one or more analysis engines 1264 for analyzing different types of data collected in the network emulator. To analyze the data, in some implementations the threat analysis engine 1260 may receive threat intelligence 1252 from, for example, the network security community. The threat intelligence 1252 may include, for example, descriptions of current (e.g. for a given day or hour or minute) known network threats. The threat analysis engine 1260 may also include an analysis database 1266 for storing data collected in the emulated network 1216 and/or analysis results from the analysis engines 1264.

In various implementations, the threat analysis engine 1260 may produce indicators 1262 that describe a particular incident that was analyzed using the emulated network 1216. These indicators 1262 may include, for example, digital signatures of malicious files, IP addresses of malicious sites, and/or descriptions of the course of events in the incident. In some implementations, the indicators may be provided to the network security community 1280. The indicators 1262 may also be provided to the behavioral analytics engine 1270. The threat analysis engine 1260 is described in further detail below.

The behavioral analytics engine 1270 includes two engines that may be used to analyze a site network for an attack or suspected attack: an adversary trajectory engine 1272 and a similarity engine 1274.

The adversary trajectory engine 1272 may analyze the various ways in which an attack may have occurred in a site network. Using this information, and possibly also the indicators 1262, the adversary trajectory engine 1272 may trace the possible path of a specific incident in the site network. This path may point to network devices in the site network that could have been affected by the incident. These network devices can be checked to determine whether they have, in fact, been affected.

The similarity engine 1274 may use the indicators 1262 to identify similar machines. For example, given emulated network devices in the emulated network 1216, the similarity engine 1274 may determine query items from, for example, the indicators 1262, and use the query items to identify similar network devices in the site network. Alternatively or additionally, the similarity engine 1274 may receive query items generated from network devices in the site network, and may use those query items to find similar network devices in the site network.

The adversary trajectory engine 1272 and the similarity engine 1274 are each described in further detail below.

Using the adversary trajectory engine 1272 and/or the similarity engine 1274, the behavioral analytics engine 1270 may produce a network analysis 1218. The network analysis 1218 may indicate, for example, whether the site network has been exposed to a particular attack, which (if any) network devices may have been affected by the attack, how the network devices were affected by the attack, and/or how the site network's security can be improved. The network analysis 1218 can be used to scrub the effects of an attack from the site network, and/or to increase the security of the site network.

### V. Threat Analysis

In various implementations, a deception center may be provided with a targeted threat analysis engine to analyze suspect network traffic. When suspect network traffic is received by a emulated network in the deception center, the emulated network may record results from conducting static, dynamic, and/or network analysis of the suspect traffic. The emulated network may be configured to record data over the course of an incident. An “incident” is an attack or suspected attack on a network. The emulated network may be configured to record data for an incident from the time a suspected attack is detected until the suspected attack is terminated.

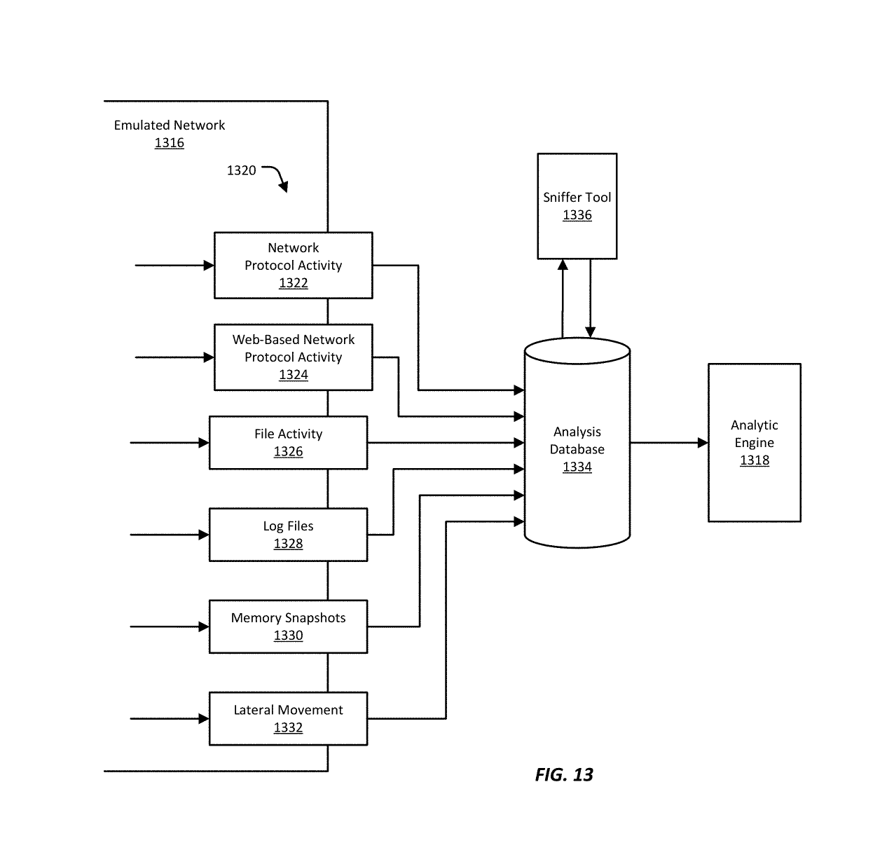

FIG. 13 illustrates examples of the data 1320 that may be collected over the course of an incident from processes and monitoring tools analyzing suspect network traffic in a emulated network 1316. FIG. 13 further illustrates that, in some implementations, the threat intelligence engine may include an analysis database 1340 that serves as a repository for the data 1320 collected in the emulated network 1316. In some implementations, the threat intelligence engine may include a sniffer tool 1336, for prioritizing and filtering the data collected in the analysis database. The threat intelligence engine may provide data from the analysis database to the analytic engine 1318, where the data can be analyzed.

In various implementations, the data 1320 collected from the emulated network 1316 may include network protocol activity 1322, web-based network protocol activity 1324, file activity 1326, log files 1328, memory snapshots 1330, and captured lateral movement 1332. These types of data 1320 are provided as examples of the type of data that may be collected, and other types of data may be collected, based on what data is available and what data is desired.

Network protocol activity 1322 may include network traffic related to various networking protocols. Network traffic associated with network protocol activity 1322 may include network traffic coming into a customer network and/or network traffic going out of the customer network. This network traffic can include, for example, email, DNS requests for servers other than web servers, SMB traffic originating inside the customer network and accessing servers outside the customer network or originating outside the customer network and accessing servers inside the customer network, and/or FTP traffic that is unrelated to webpage content, among other things. Network protocol activity 1322 may be captured by, for example, network packet monitoring tools or in log files.

Web-based network protocol activity 1324 may include network traffic associated with accessing websites. The websites being accessed may be located on web servers located outside the customer network; that is, external web sites being accessed by a user inside the customer network. The websites being accessed may alternatively or additionally include websites hosted by the customer network itself, and being accessed by a user either inside or outside the customer network. Web-based network traffic may include, for example, DNS packets requesting the IP address of a website, Hyper-Text Transfer Protocol (HTTP) packets for transferring webpages, file transfer protocol (FTP) packets for transferring webpage content, such as image files, and/or packets exchanging user authentication information. Web-based network protocol activity 1324 may be captured by, for example, network packet monitoring tools or in log files.

In various implementations, web-based network protocol activity 1324 may be included within the network protocol activity 1322.

File activity 1326 may include information learned from static analysis of files found in the content of suspect network traffic. File activity 1326 can include, for example, the output of virus scans, a description of contents of files, components such as macros and scripts extracted from files, results from opening files, and/or results from deconstructing files (e.g., compiling or decompressing the file), among other things. File activity 1326 may be captured by processes executing the static analysis. File activity 1326 may also be captured by the testing device executing the static analysis, which may produce, for example, the output of virus scanners, de-compilers, emulators, and so on.

Log files 1328 include log files produced during dynamic analysis of the contents of suspect network traffic. These log files may be generated, for example, by the emulated system that is the release point for the contents of the suspect network traffic. These log files may include, for example, log files that are typically generated by an operating system. These log files capture information such as operating system kernel activity, user-level application programming interface activity, user log in attempts, and commands entered by a user, among many others. The log files 1328 may also include the output of processes specifically monitoring calls made from the release point to other devices in the emulated network 1316. These log files may capture information such as downloading of files from outside the customer network, uploading files from the customer network to an outside server, creating, deleting, copying, modifying, moving, decrypting, encrypting, decompressing, and/or compressing files, and network traffic to other devices, such as login attempts and port scanning. In various implementations, log files deemed interesting (which may include all log files generated by devices emulated in the emulated network 1316) are provided to the analysis database 1340.

Memory snapshots 1330 may be taken at various times over the course of an incident. For example, the emulated network 1316 may take before and after snapshots of emulated memory structures in the emulated network 1316. For example, real servers, workstations, routers, and other network devices typically include some memory. In some implementations, the emulated network 1316, when emulating these devices, may also emulate any memory that they include. The emulated network 1316 may further produce snapshots of each memory before suspect network traffic is analyzed, as well as after. A memory snapshot is a copy of the contents of a memory. In some implementations, the emulated network 1316 may alternatively or additionally produce memory snapshots of the test devices being used to create the emulated network 1316. As discussed above, the emulated network 1316 is built from physical equipment, such as a rack of servers, which has its own memory. This memory may be captured in snapshots at various intervals, particularly during the analysis of suspect network traffic. Alternatively or additionally, the emulated network 1316 may take memory snapshots 1330 during the course of dynamic analysis of files. For example, the emulated network may take a memory snapshot 1330 during the execution of a file. This memory snapshot may provide some insight into the contents of the file.

Lateral movement 1332 is, as described above, the movement of an attack from one network device to another. Lateral movement 1332 may be captured, for example, as a trace of activity among multiple devices emulated in the emulated network 1316. In some implementations, lateral movement 1332 may be extracted from network protocol activity 1322, web-based network protocol activity 1324, file activity 1326, and/or log files 1328. For example, file activity 1326 may show downloading of malware and log files 1328 may capture login attempts. Lateral movement 1332 data may put this information together and provide a cohesive description of an attack.

As noted above, the data 1320 extracted from the emulated network 1316 may be accumulated in an analysis database 1340. In some implementations, the threat intelligence engine may include a sniffer tool 1336. In these implementations, the sniffer tool 1336 may prioritize and filter the data stored in the analysis database 1340. For example, the sniffer tool 1336 may generate alerts upon finding particularly suspect information (e.g., by finding a digital signature for the information on a blacklist). As another example, the sniffer tool 1336 may identify data known to be safe (e.g., because a digital signature for the data or a domain extracted from the data can be found on a whitelist), and remove this data from the analysis database 1340. As another example, the sniffer tool 1336 may extract files out of network packets. As another example, the sniffer tool 1336 may generate digital signatures for files, packets, or other data in the analysis database 1334. As another example, the sniffer tool 1336 may trim routine information from log files, so that the log files record primarily suspect activity. As another example, the sniffer tool 1336 may organize related information together, such as for example putting together network traffic and log files related to lateral movement. In some implementations, the sniffer tool 1336 may thus serve to reduce the volume of data that may need to be analyzed. The sniffer tool 1336 may also be referred to as a network protocol parser. One example of a sniffer tool 1336 is the Bro Network Security Monitor.

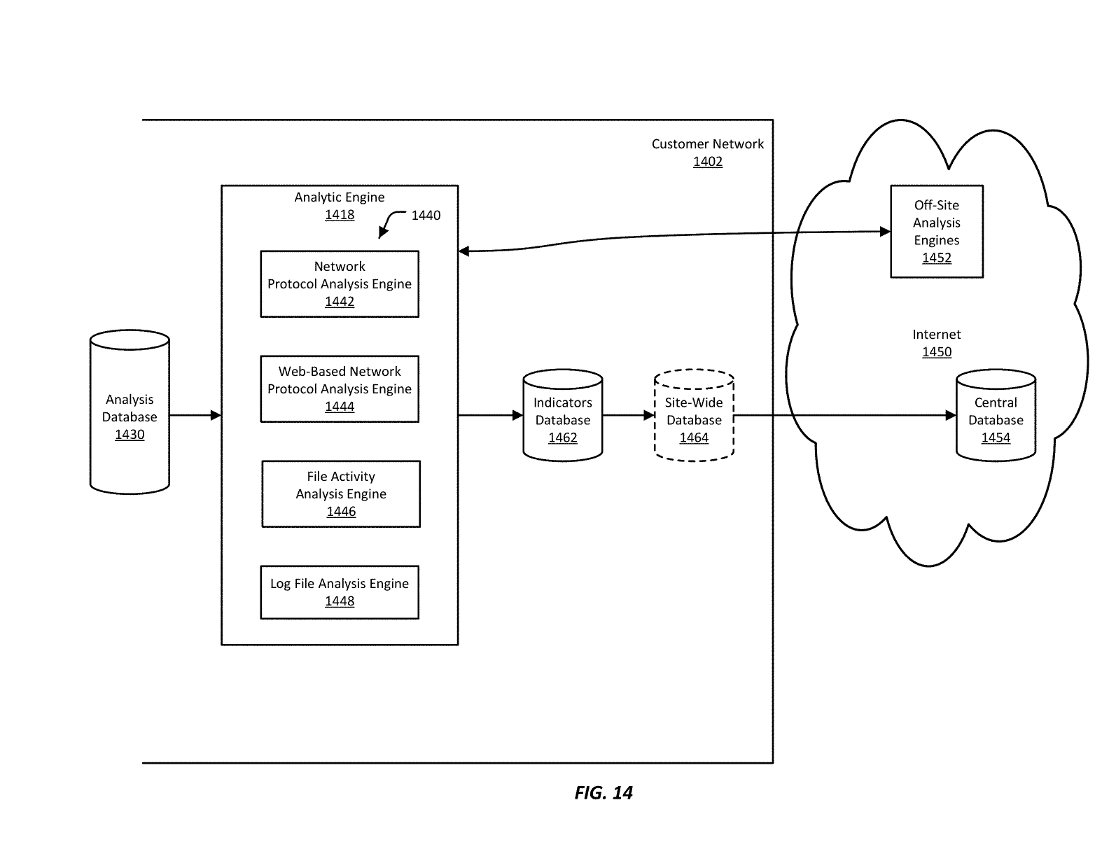

The contents of the analysis database 1340 may be provided to the analytic engine 1318 for detail analysis. FIG. 14 illustrates an example of the operations of an analytic engine 1418. In various implementations, the analytic engine 1418 may include multiple analysis engines 1440. Each analysis engine 1440 may analyze a different type of data stored in an analysis database 1430. Generally, each analysis engine 1440 may apply one or more of heuristic algorithms, probabilistic algorithms, machine learning algorithms, and/or pattern matching algorithms, in addition to emulators, to detect whether data (e.g., files, email, network packets, etc.) from the analysis database 1430 is malicious. Each analysis engine 1440 may further include sub-modules and plugins, which are also able to apply heuristic, probabilistic, machine learning, and/or pattern matching algorithms, as well as emulators, to determine whether some data is malicious. In various implementations, the analysis engines 1440 may be configured to operate in parallel, such that the analytic engine 1418 is able to analyze many types of data at the same time. In some implementations, the analytic engine 1418 may have additional analysis engines 1440 not illustrated here. In some implementations, the analytic engine 1418 may have fewer analysis engines 1440, depending on what is required for a particular implementation.

In this example, the analytic engine 1418 includes a network protocol analysis engine 1442, a web-based network protocol analysis engine 1444, a file activity analysis engine 1446, and a log file analysis engine 1448. As discussed in further detail below, each of these analysis engines 1440 processes a different type of data from the analysis database 1430. The network protocol analysis engine 1442 processes results from network and dynamic analysis of network traffic. The web-based network protocol analysis engine 1444 processes results from network analysis of network traffic related to access of websites. The file activity analysis engine 1446 processes data captured during static analysis of the content of suspect network traffic. The log file analysis engine 1448 processes log file data. In some implementations, the analysis engines 1440 may, also work together to analyze data from the analysis database 1430. For example, file activity analyzed by the file activity analysis engine 1446 may be correlated against network activity analyzed by the web-based network protocol analysis engine 1444 and the network protocol analysis engine 1442 to produce a network history of lateral movement of an attack. As further example, information provided by the network analysis may be searched for, by the log file analysis engine 1448, to provide an activity trace of lateral movement. In some implementations, the various analysis engines 1440 may be combined into fewer analysis engines, or may be divided into additional sub-engines. For example, in some implementations, the network protocol analysis engine 1442 may also analyze web-based network traffic.

In various implementations, analysis engines 1440 may each produce indicators that describe the data that each analyzes, which may be stored in an indicators database 1462. Indicators describe the suspect network associated with data analyzed by the analysis engines 1440. For example, the network protocol analysis engine 1442 may produce indicators that the describe the source and destination of HTTP-based packets, a description of the webpages associated with the packets, as well as any malicious content downloaded as a result of the HTTP packets. As another example, the network protocol analysis engine 1442 may produce indicators describing SMB packets that uploaded files that should not have left the customer network 1402. As another example, the file activity analysis engine 1446 may provide indicators describing files storing credentials that where modified. As another example, the log file analysis engine 1448 may produce indicators that describe repeated, and thus suspect, login attempts.

In various implementations, the analysis engines 1440 produce static, file, and network indicators that describe and/or identify an threat posed by suspect network traffic, or lack of a threat, if no threat is found. For example, in some implementations, a threat associated with specific suspect network traffic may be identifiable by a name, which is included in an indicator. The indicators may further include information such as timestamps, indicating a start and/or end of the attack, and/or a weight, indicating the severity of the attack, and/or contextual information about the attack, such as the type of network exchanges made during the attack. In some implementations, suspect network traffic that is harmless may also be provided with indicators. In these implementations, the indicators may include a weight value that indicates that the network traffic is harmless.

In some implementations, the analytic engine 1418 may also provide data from the analysis database 1430 to off-site analysis engines 1452, located outside the customer network 1402. Off-site analysis engines 1452 are additional analysis engines that are hosted by a central service located on the Internet 1450. The central service may have analysis engines that the analytic engine 1418 does not have, or does not yet have. For example, central server may have off-site analysis engines 1452 that are more up-to-date, and/or may have off-site analysis engines 1452 that are newer. In some cases, newer off-site analysis engines 1452 may be in a testing phase, prior to being provided to the customer network 1402. The off-site analysis engines 1452 may provide indicators back to the analytic engine 1418. The analytic engine 1418 may add these indicators to the indicators database 1462.

In some implementations, the indicators database 1462 may further provide indicators to a site-wide database 1464. As noted above, the customer network 1402 may include a site-wide database 1464 when the customer network 1402 includes more than one site network. Each site network may be provided with their own threat intelligence engine. Each threat intelligence engine may provide indicators for their analytic engines to the site-wide database 1464.

In some implementations, the indicators database 1462 may provide indicators to a central database 1454, located on the Internet 1450. In implementations that include a site-wide database 1464, the site-wide database 1464 may provide indicators for all of the customer network 1402 to the central database 1454. The central database 1454 is a central repository for indicators that describe suspect network traffic. The central database 1454 may collect indicators from multiple customer networks. The central database 1454 may also share indicators between customer networks. Sharing indictors between customer networks may make all of the customer networks more secure. For example, another customer network may have seen an attack that the illustrated customer network 1402 has not yet experienced. The customer network 1402 may use indicators from the other customer network to improve its network security infrastructure, and thereby possibly improving is defenses against the same attack.

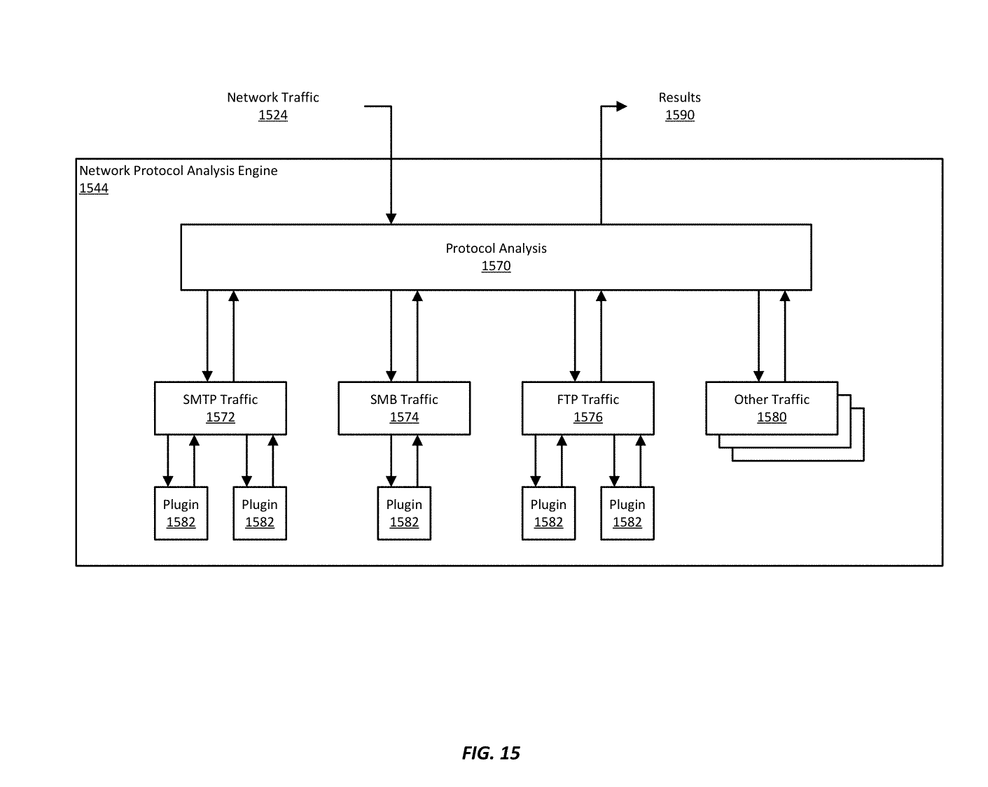

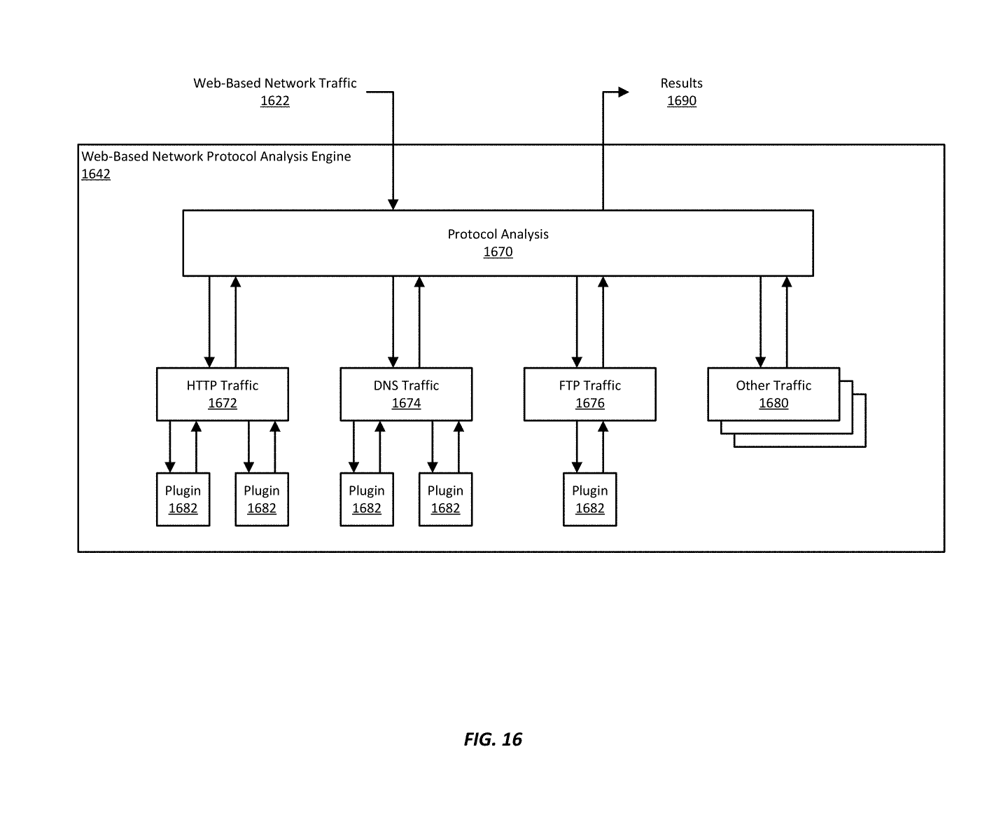

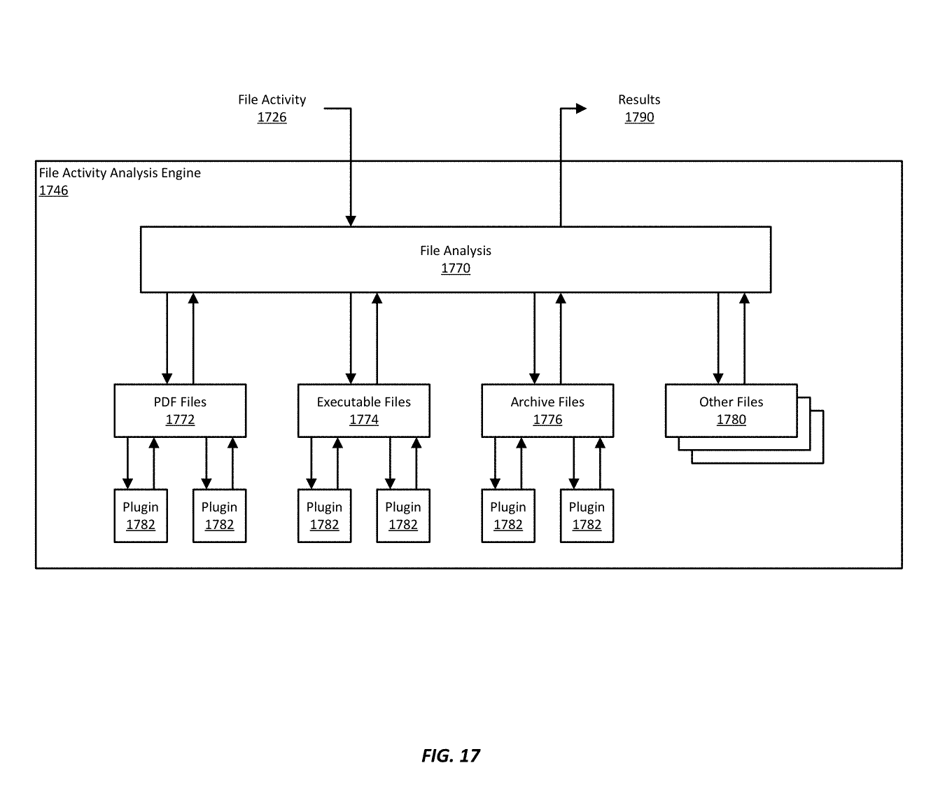

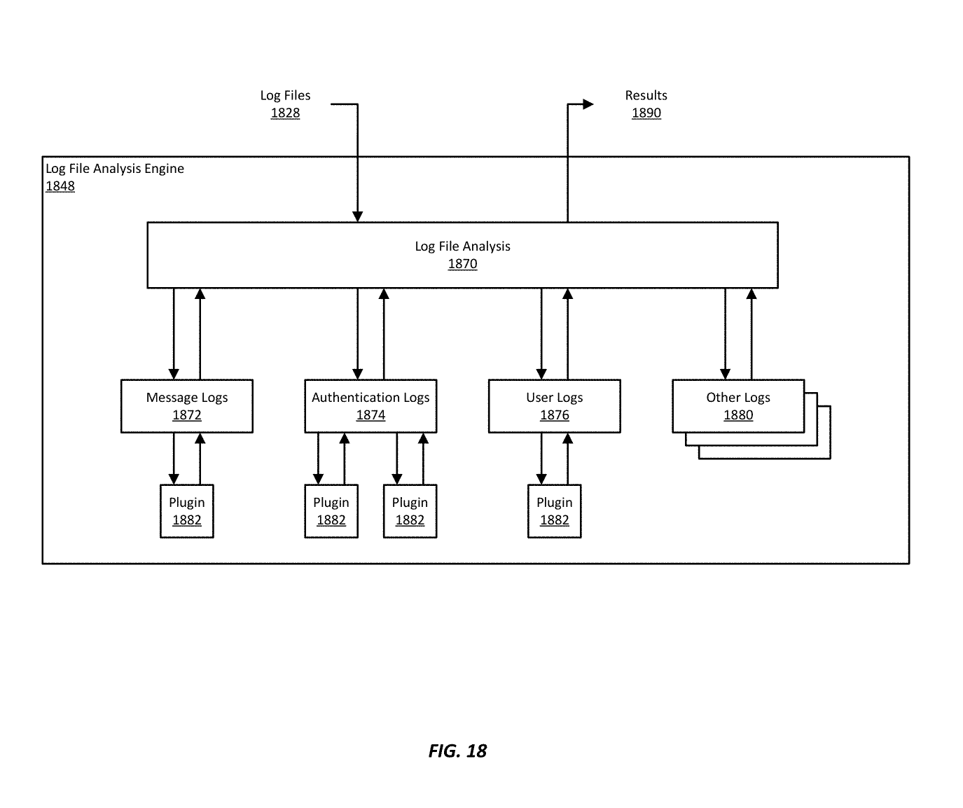

FIGS. 15-18 illustrate examples of the structure and processes of the analysis engines 1440 illustrated in the example of FIG. 14. FIG. 15 illustrates an example of a network protocol analysis engine 1544; FIG. 16 illustrates an example of a web-based network protocol analysis engine 1642; FIG. 17 illustrates an example of a file activity analysis engine 1746; and FIG. 18 illustrates an example of a log file analysis engine 1848.

FIG. 15 illustrates an example of a network protocol analysis engine 1544. The network protocol analysis engine 1544 may analyze network traffic associated with network protocols, in some cases including web-based network protocols. Analyzing non-web-based network traffic separately from web-based network traffic may be beneficial because non-web-based network traffic may use network protocols unrelated to web-based network traffic. Additionally, non-web-based network traffic may be received at different rates, may be used differently, and may harbor different kinds of threats. In various implementations, however, web-based network traffic is analyzed by the network protocol analysis engine 1544, along with non-web-based network traffic. In these implementations, the network protocol analysis engine 1544 can provide comprehensive analysis of the network traffic.

This example network protocol analysis engine 1544 is also arranged modularly and hierarchically. A protocol analysis 1570 receives other network traffic 1524, and may conduct a first stage analysis of the network traffic 1524. For example, the protocol analysis 1570 may identify a network protocol associated with a packet or stream of packets. The protocol analysis 1570 may then invoke a sub-module designed to analyze packets for the identified network protocol. In this example, the network protocol analysis engine 1544 includes sub-modules for Simple Mail Transfer Protocol (SMTP) traffic 1572 (e.g., email), Server Message Block (SMB) traffic 1574 (e.g. resource sharing packets), and FTP traffic 1576. The sub-modules may each be assisted by one or more plugins 1582. The network protocol analysis engine 1544 may also include sub-modules for other traffic 1580 (e.g. FTP, Trivial File Transfer Protocol (TFTP), Remote Desktop Protocol (RDP), Internet Message Access Protocol (IMAP), DNS, DHCP, Transparent Network Substrate (TNS), Lightweight Directory Access Protocol (LDAP), etc.). These other sub-modules may analyze traffic for other network protocols, including ones that are currently known and not illustrated here, and ones that will be developed in the future.

The SMTP traffic 1572 sub-module analyzes suspect email. The SMTP traffic 1572 sub-module may, for example, examining email headers to look for patterns known to be associated with malicious email. The SMTP traffic 1572 sub-module may also examine email content to look for malicious attachments and/or links. The SMTP traffic 1572 sub-module may provide a determination to the protocol analysis 1570 that indicates whether some email was malicious or not, or whether it could not make a determination. The determination from the SMTP traffic 1572 sub-module may be based on its own analysis, or on the analysis of one or more plugins 1582, or on a combined analysis.

The SMB traffic 1574 sub-module analyzes packets associated with shared access to files, printers, ports, and miscellaneous communications between devices in a network. SMB packets may also provide an authenticated inter-process communication mechanism. The SMB traffic 1574 sub-module may examine SMB packets and look for unauthorized accesses to shared resources or unauthorized communications. The SMB traffic 1574 sub-module may provide a determination to the protocol analysis 1570 as to whether some SMB traffic was malicious, not malicious, or possibly malicious. The SMB traffic 1574 sub-module's determination may be based on its own analysis, or on the analysis of one or more plugins 1582, or on a combined analysis.

The FTP traffic 1576 module analyzes network traffic associated with the transfer of data using FTP. Communications using FTP typically involve establishing a communication channel between a client machine and a server machine. The client machine can issue commands to the server machine, and upload files to the server machine or download files from the server machine. The FTP traffic 1576 sub-module may analyze FTP-related network traffic, and attempt to determine whether any of the traffic uploaded files that were not authorized to be uploaded or downloaded malicious files. The FTP traffic 1576 module also attempt to determine whether the FTP communication channel was validly established. Some FTP servers may allow users to connect anonymously, while others require a username and password to establish a connection. The FTP traffic 1576 sub-module may provide a determination to the protocol analysis 1570 that indicates whether some FTP traffic was malicious, was not malicious, was harmless, or that the traffic's maliciousness could not be determined. The FTP traffic 1576 sub-module's determination may be based on its own analysis, the analysis of one or more plugins 1582, or a combined analysis.

The protocol analysis 1570 may use the determinations made by the sub-modules and/or their attached plugins 1582 and generate indicators 1590 that describe the other network traffic 1524. These indicators 1590 may be referred to as network indicators. These indicators 1590 may describe the behavior of the other network traffic 1524, may identify network traffic associated with a particular behavior, and/or may indicate whether some network traffic is or is not a threat. For example, the indicators 1590 generated by the other network protocol analysis engine 1544 may include source and destination addresses for the other network traffic 1524, descriptions of any files found in the network traffic, and/or any usernames associated with the network traffic, among other things. In some implementations, the indicators 1590 may indicate that some other network traffic 1524 is or is not a threat. In some implementations, the indicators 1590 may include a weight value that indicates a probability that some other network traffic 1524 is a threat.

FIG. 16 illustrates an example of web-based network protocol analysis engine 1642 implemented in a modular fashion. A modular implementation may provide both flexibility and scalability. Flexibility is provided because the web-based network protocol analysis engine 1642 can be reconfigured based on the web-based network traffic 1622 that is received Scalability is provided because modules for new types of web-based network traffic can be added, in some cases without needing to rebuild the web-based network protocol analysis engine 1642.

In this example, the web-based network protocol analysis engine's 1642 modules are arranged hierarchically. The first level of analysis is protocol analysis 1670. The protocol analysis 1670 gets or receives web-based network traffic 1622. The protocol analysis 1670 may get data (a “push” data model) or fetch data (a “pull” data model). In some implementations, the web-based network traffic 1622 may already be organized into packet streams. A packet stream is a series of related packets that have the same source and destination. For example, the packets that form a video being streamed from a host to a viewer's device would be considered a packet stream.

The protocol analysis 1670 may make an initial examination of the web-based network traffic 1622. Among other things, the protocol analysis 1670 may determine the web-based network protocol that each packet or packet stream is associated with. The protocol analysis 1670 may then invoke the appropriate sub-module for the network protocol type, and direct packets associated with that protocol to the sub-module. In this example, the web-based network protocol analysis engine 1642 has at least three sub-modules: one for HTTP traffic 1672, one for DNS traffic 1674, and one for FTP traffic 1676. The web-based network protocol analysis engine 1642 may have additional sub-modules for other traffic 1680, where these sub-modules are focused on packets that use network protocols not explicitly illustrated here. The functionality of the web-based network protocol analysis engine 1642 can also be expanded by adding more sub-modules for yet more web-based network protocols.

Each of the sub-modules analyze packets associated with their protocol type and attempt to determine whether the packets can cause harm to a network. For example, the HTTP traffic 1672 sub-module may match website addresses against “black lists” and “white lists.” Black lists include lists of websites and/or website content that is known to be malicious, compromised, or are otherwise associated with web content known to cause harm. Black lists may include website domain names, IP addresses, Uniform Resource Locators (URLs), and/or hashes of malicious files. The HTTP traffic 1672 sub-module may also match web site content (such as files and images) against black lists. White lists include lists of websites and/or website content that is known to be safe and uncompromised. Black lists and white lists may change dynamically, as when a previously safe website becomes compromised, or as a compromised website is recovered, or as websites are shut down and removed from the Internet. HTTP traffic associated with a website on a black list may be marked as malicious, while HTTP traffic associated with a white list may be marked as clean.

As another example, the DNS traffic 1674 sub-module may also match domain names against black lists and white lists. DNS traffic typically includes requests to translate domain names to IP addresses. A DNS request may be for a domain that is hosted by the customer network, or may be for a domain that is outside the customer network but that the customer network's DNS server knows about. A malicious DNS request may, for example, be attempting to obtain an IP address for an internal website that is not publicly available. The DNS traffic 1674 sub-module attempts to determine whether suspect DNS requests may be malicious or are acceptable.

As another example, the FTP traffic 1676 sub-module may examine packets that contain website content that were transferred using FTP. FTP provides one way to transfer images, files, and/or multi-media content associated with webpages. The FTP traffic 1676 sub-module may examine web-based FTP traffic and determine whether the traffic includes any malicious content, or whether the content is innocuous.

The functionality of the sub-modules may also be expanded with plugins 1682. A plugin is a module that can be added to or removed from a sub-module without having to rebuild the sub-module and often while the sub-module is running. Here, plugins provide the ability to quickly add functionality to a sub-module. For example, in some implementations, the HTTP traffic 1672 sub-module may be unable to determine whether some packets are malicious or safe. In these implementations, the HTTP traffic 1672 module may invoke one or more plugins 1682, which may each operate on the packet in a different way. For example, one plugin 1682 may access black lists located on the Internet. These black lists may be public black lists, or may be black lists maintained along with off-site analysis engines. As another example, another plugin 1682 may access a public database of known bad websites, such as one hosted by Google®. The DNS traffic 1674 sub-module and FTP traffic 1676 sub-module may also have plugins to expand their functionality. Plugins also provide a way to add new or up-to-date functionality to the sub-modules. The sub-modules can also be updated by providing an updated web-based network protocol analysis engine 1642, which may require rebuilding the web-based network protocol analysis engine 1642. Plugins, however, may provide for faster, less intrusive, and/or intermediate updates between updates of the web-based network protocol analysis engine 1642 itself.

The plugins 1682 may each produce a determination of whether a packet or group of packets is malicious or clean. A plugin 1682 may also indicate that it was unable to make a determination. In this example, the sub-modules receive the results from their associated plugins 1682. The sub-modules provide a determination, either their own or one made by their plugins 1682, to the protocol analysis 1670. The protocol analysis 1670 may use the determination from a sub-module to produce indicators 1690. These indicators 1690 may be referred to as network indicators. As noted above, these indicators 1690 may describe and/or identify network traffic associated with a threat. For example, the indicators 1690 generated by the web-based network traffic may include the domain names, URLs, and/or IP addresses of web sites accessed, a description of the websites, a description of content downloaded from the websites, and/or the IP address of the computer that requested the website content, among other things. The indicators 1690 may indicate definitively that some network traffic is a threat or may indicate definitively that some network traffic is not a threat. Alternatively or additionally, the indicators 1690 may provide a weight value that indicates the probability that some network traffic is a threat. For example, a weight value of “100” may indicate a 100% probability that some network traffic is a threat, while a weight value of “0” may indicate that the network traffic is not a threat. Furthermore, any weight value between “0” and “100” may indicate the relatively probability that some network traffic is a threat.

FIG. 17 illustrates an example of a file activity analysis engine 1746. The file activity analysis engine 1746 analyzes the result of static analysis of the contents of suspect network activity. For example, the file activity analysis engine 1746 may examine results from opening the contents, applying virus scans to the content, and/or deconstructing the content, among other things. By examining these results, the file activity analysis engine attempts to determine whether the content can cause harm to a network.

This example file activity analysis engine 1746 is also arranged modularly and hierarchically. A file analysis 1770 receives file activity 1726, and may conduct a first stage analysis of the file activity 1726. For example, the file analysis 1770 may include black lists for files known to be malicious. In some implementations, the black lists may store digital signatures of malicious files. These digital signatures may be generated by, for example, the MD5 algorithm, Secure Hash Algorithm 1 (SHA-1), or SHA-2, among others. The file analysis 1770 may compare files found in suspect network traffic against signatures in the black lists. The file analysis 1770 may also check files against white lists. White lists may include files that are known to be safe. White lists may also store digital signatures of files. Files found in suspect network traffic that match signatures in white lists can be assumed to be safe.

The file analysis 1770 may also or alternatively determine the file type for a file extracted from suspect network traffic, and invoke a sub-module for analyzing files of that type. In this example, the file activity analysis engine 1746 includes sub-modules for analyzing portable document format (PDF) files 1772, executable files 1774, and archive files 1776. The sub-modules may each be assisted by one or more plugins 1782. The file activity analysis engine 1746 may include sub-modules for analyzing other files 1780 of types not illustrated here, and also for analyzing activity related to certain files, such as password files and sensitive data files.

The PDF files 1772 sub-module analyzes files formatted in PDF or that appear to be formatted in PDF. PDF is a popular format for transferring documents across networks. Thus sending PDF files in network traffic is fairly common. Hacking tools, however, can be embedded into seemingly innocent PDF files. The PDF files 1772 sub-module may attempt to determine whether a PDF file is malicious or harmless. For example, the PDF files 1772 sub-module may be able to detect malicious obfuscation in a PDF file, and/or whether a PDF file includes a shell script. The PDF files 1772 sub-module may provide its determination, or the determination made by a plugin 1782, or a combined determination, to the file analysis 1770.

The executable files 1774 sub-module analyzes executable files and files that appear to be executable. Executable files are programs that can be run on a computer. Viruses and other malware can be delivered into a network using executable files. Once launched, an executable file may have some privileges to make changes to a computer that it is launched on. Malware may take advantage of these privileges, and once launched, may exploit vulnerabilities in a computer's security infrastructure. The executable files 1774 sub-module may attempt to identify an executable file, and/or identify what an executable file does. Using this and other information, the executable files 1774 sub-module may attempt to determine whether the executable file is malicious. The executable files 1774 sub-module may provide its determination, or a determination of one of or more of its plugins, or a combined determination to the file analysis 1770.

The archive files 1776 sub-module analyzes archive files. Archive files are containers for other files, and provide a convenient way to transfer groups of files and/or large files. The files contained in an archive file may have been compressed and/or encrypted. The archive files 1776 sub-module may attempt to determine what is contained in an archive file, and whether the contents are malicious. The archive files 1776 sub-module may decompress and/or decrypt an archive file. In some cases, the archive files 1776 sub-module may pass the contents of an archive to the file analysis 1770, which may pass the contents to another sub-module. The archive files 1776 sub-module may provide its determination (or that of one or more of its sub-modules) to the file analysis 1770.

The file analysis 1770 may use the determinations made by the sub-modules and/or their attached plugins 1782 to generate indicators 1790 that describe the file activity 1726. These indicators 1790 may be referred to as file indicators. These indicators 1790 may describe and/or identify the analyzed files. For example, the indicators 1790 may include file types, components extracted from files, results from applying virus scanning and other tools to the files, results from opening or executing a file, results from deconstructing and analyzing the deconstructed contents of file, where a file came from and when, and/or a digital signature, which may be used to identify a file. The indicators 1790 may further indicate whether a file is malicious. In some implementations, the indicators 1790 may include a weight value that indicates the probability that a file is malicious.

FIG. 18 illustrates an example of a log file analysis engine 1848. The log file analysis engine 1848 analyzes log files generated by operating systems, applications, and devices in the emulated network. For example, the log file analysis engine 1848 can analyze log files generated by emulated network devices form the emulated network. In various implementations, the emulated network devices can be implemented using virtual machines.

This example log file analysis engine 1848 is also arranged modularly and hierarchically. A log file analysis 1870 receives log files 1828 and may conduct a first stage analysis of the log files 1828. For example, the log file analysis 1870 may sort log files by their type, and invoke an appropriate sub-module for analyzing each log file by its type. In this example, the log file analysis engine 1848 includes sub-modules for analyzing message logs 1872, authentication logs 1874, and user logs 1876. The sub-modules may each be assisted by one or more plugins 1882. The log file analysis engine 1848 may include sub-modules for analyzing other logs 1880, including any of the many logs that may be generated by network devices but that are not illustrated here.

The message logs 1872 sub-module analyzes message logs. Message logs contain global system messages, often including messages that are also found in other message logs, such as mail and authentication logs. Analyzing message logs may provide a comprehensive view of the activity seen by a emulated device in the emulated network. The message logs 1872 sub-module may also analyze message logs based on information provided by other analysis engines. For example, message logs may be searched for activity related to a suspect IP address or username, found through network analysis.

The authentication logs 1874 sub-module analyzes log files related to user authentication. Authentication logs include information such as a history of logins (including usernames, login times, and logout times) and the authentication mechanism used. Examining log files may be useful for finding, for example, repeated login attempts, password scanning (e.g., multiple login attempts with the same username and different passwords), and/or logins using deliberately released usernames and passwords. Authentication logs can also be searched for activity related to, for example, a suspect username or around a specified time. The key words or search strings may be provided by other analysis engines.

The user logs 1876 sub-module analyzes log files that record user-level activity. User logs may capture the actions of one user. For example, a user log may include commands entered by a user, files opened or closed by the user, applications launched by the user, other systems accessed by the user, and so on. Examining user logs may be useful, for example, when an outside actor has gained access to the emulated network using stolen or leaked credentials. Hence, user logs may be examined for information related to a specific user, which may be identified by another analysis engine.

The sub-modules may each make a determination as to whether a log file being analyzed indicates malicious activity. The sub-modules may make this determination with the assistance of one or more attached plugins 1882. The sub-modules may provide their determinations to the log file analysis 1870. The log file analysis 1870 may use the determinations made by the sub-modules to generated indicators 1890 that describe and/or identify activity seen in the log files 1828. These indicators 1890 may be referred to as dynamic indicators. For example, indicators 1890 generated by the log file analysis engine 1848 may include a list of login attempts, usernames associated with log in attempts, commands entered by a user that has infiltrated the emulated network, and/or changes made within the emulated network, among other things. The indicators 1890 may indicate that no malicious activity was found, or that malicious activity was definitely found. In some implementations, the indicators may alternatively or additionally provide a weight value that indicates the probability of malicious activity.

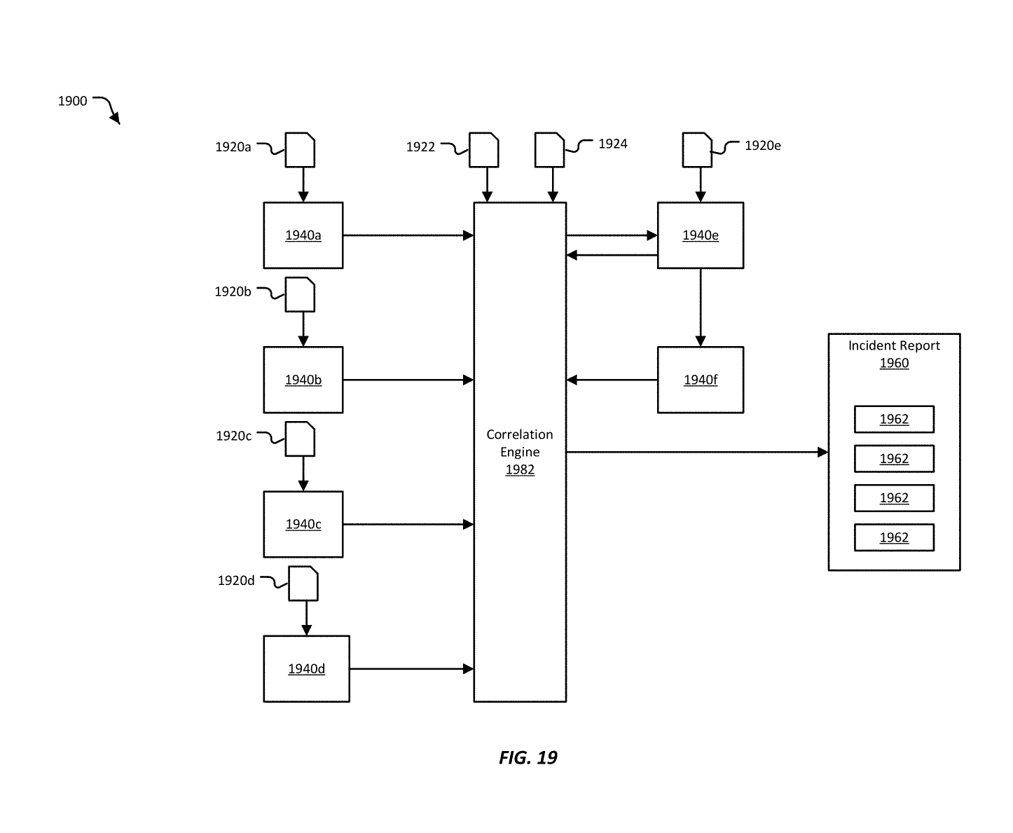

In various implementations, the analysis engines described in FIGS. 15-18 may be launched by the analytic engine in a predetermined sequence. FIG. 19 illustrates an example of the order or sequence in which analysis engines 1940a-1940f can be run, as well as a correlation engine 1982 for correlating the results from the various analysis engines 1940a-1940f. In various implementations, the analytic engine executes the analysis engines 1940a-1940f in a predetermined order, which can be modified. The execution order may be based on current threat intelligence from the network security community. For example, the security community may learn that certain malware has been released on a particular date, or that several websites have suffered denial of service (DoS) attacks. In this example, the threat intelligence engine can be configured to watch particularly for this denial of service attacks that look similar to the attacks seen at those websites. For example, the network protocol analysis engine can be placed first or early in the execution order, so that the network protocol analysis engine can catch streams of packets that appear to be related to a denial of service attack. New threat intelligence may be received once a day or several times a day, and analytic engine may adjust the execution of the analysis engines 1940a-1940f accordingly.

In some implementations, the analytic engine can also determine the order in which to execute the analysis engines from what can be learned from suspect network traffic. For example, an attack may take the form of a large amount of irrelevant or inappropriate email (e.g., spam email) being received by a network. The nature of this email as spam may be identified by the network's security infrastructure, and the analytic engine may use this information to invoke a email analysis engine first. The email analysis engine may conduct an analysis of the headers of the suspicious email, and determine, for example, that the email does not have a valid header (e.g., the sender's email address is invalid or has been spoofed). The result of the email header analysis can be provided to a file analysis engine and/or a log file analysis engine to determine whether attachments included in the suspect email are malicious. In contrast, should the email header analysis engine find nothing wrong with the email, then the file and log file analysis engines need not be run.

In various implementations, the analytic engine may also be able to add new analysis engines to the sequence, remove analysis engines from the sequence, and/or add or remove plugins for an analysis engine. The analytic engine may make these changes to new or different network threats and/or to update the functionality of the analytic engine. In some implementations, updates and changes to the analytic engine can be provided over the Internet. In some implementations, the analytic engine can be updated without needing to shut it down or take it off line.

In the example illustrated in FIG. 19, four analysis engines 1940a-1940d are initially launched in parallel. These four analyses engines 1940a-1940d can be one of the web-based network protocol analysis engine, other network protocol analysis engine, file activity analysis engine, log file analysis engine, or some other analysis engine included in the analytic engine. The four initial analysis engines 1940a-1940d receive as input incident data 1920a-1920d of an appropriate type (e.g., a web-based network protocol analysis engine receives web-based network traffic data; a file analysis engine receives files, etc.) The initial analysis engines 1940a-1940d can be run in parallel or sequentially; in this particular example, there is no requirement that they be run in a specific order. In some cases, there may be a requirement that the result from one analysis engine 1940a-1940d be provided to another analysis engine 1940a-1940d. In various implementations, additional or fewer analysis engines 1940a-1940f can be run initially.

Each of the initial analysis engines 1940a-1940d may produce results. These results may indicate whether a particular piece of data from the incident data 1920a-1920d is malicious, is safe, or has an undetermined status. Results that indicate particular data is safe and some results that indicate an undetermined status may be discarded, or are otherwise set aside. Results that indicate particular data is malicious, and thus very likely related to an actual attack, may be provided to the correlation engine 1982.

The correlation engine 1982 correlates the results from the various analysis engines to produce an incident report 1960. One or more of the results may indicate that the site network has, in fact, suffered an attack. For example, one or more servers in the emulated network may have crashed. The correlation engine 1982 attempts to reconstruct the sequence of events that led up to the harm caused by the attack. The analysis engines 1940a-1940f may identify events in the incident data 1920a-1920e that, by themselves, are probably malicious (e.g., downloading of a malware file). Many events in the incident data 1920a-1920e may, alone, appear innocent (e.g., receiving an email). The correlation engine 1982 attempts to connect these events, which may appear to be unrelated, and thereby reconstruct the course of the attack. Furthermore, the correlation engine 1982, in most implementations, has access to all of the data captured for the incident, and thus may be able to relate single events to events that happened both before and after. In many cases, having reconstructed the course of the attack, the report from the correlation engine 1982 can be used to identify malicious activity related to the attack.

For example, one analysis engine 1940a may indicate to the correlation engine 1982 that a malware file was downloaded to a server in the emulated network. Another analysis engine 1940b may indicate that servers in the emulated network crashed because their memory was flooded with garbage data. The correlation engine 1982 may search the incident data 1920a-1920e for a connection between these events. To continue the example, the correlation engine 1982 may find that the malware file launched a process on each of the servers that crashed. The correlation engine 1982 may further find that the servers' memory started to fill once these processes were started.

The correlation engine 1982 can also be in identify and deconstruct attacks that can otherwise be difficult to trace. One example of an attack that is difficult to trace is a “dropper” attack. A dropper is a malware installer that surreptitiously carries viruses, back doors, or other malicious software. A dropper file by itself does not cause harm directly, and cannot be identified by simple checks such as examining its file extension. Once on a computing system, the dropper file can be inadvertently activated by a user attempting to open the file, or may exploit a security vulnerability to activate itself. Once activated, the dropper file unpacks and executes its contents, which is often a malware file.

A dropper can be detected in various ways by correlating the dropper's contents—which, for purposes of the following examples, will be referred to as the contents file—back to the dropper. For example, the contents file may be executed on an emulated network device, and its malicious behavior may be both exposed and captured in log files generated by the emulated network device. As another example, a static scan of the contents file may reveal its malicious nature. As another example, the contents file, once invoked, may make calls to a command and control server located on the Internet. A command and control server (C&C server) is a centralized computer that issued commands to a botnet, and receives reports back from coopted computing systems. This malicious behavior may be captured in log files generate an emulated network device on which the contents file is launched.

In each of the above examples, the correlation engine 1982 may look for the contents file (e.g., by looking for a digital signature generated for the contents file) in other log files, and find it in a log file generated when the dropper file was itself executed. The dropper file's relationship with the contents file will thus cause the otherwise benign-seeming dropper file to be classified as malicious. Additionally, the correlation engine 1982 may be able to identify how the dropper file itself came to be on the network. For example, the correlation engine 1982 may look for the dropper file in email attachments (e.g., using a digital signature generated for the dropper file), and/or may look for the dropper file in network packets that were part of a download from the Internet. In this way, the correlation engine 1982 may be able to trace the events in the dropper attack independently from when the various events in the attack occurred.

Before being able to produce an incident report 1960, the correlation engine 1982 may require additional results for additional analysis engines 1940e-1940f. For example, to continue to previous example, the correlation engine 1982 may have determined that a malware file causes the servers to crash, but so far does know where the malware file came from or how it came to be placed in the network. The analysis engine may, in this example, invoke additional analysis engines 1940e-1940f to obtain more information. For example, one analysis engine 1940e may be invoked to search log files for a time at which the malware file was downloaded. Another analysis engine 1940f may be invoked to search network packets for the malware file. From the results from these analysis engines 1940e-1940f, the correlation engine 1982 may be able to identify where the malware file came from (e.g., an IP address of the sender) and when it was downloaded to the emulated network.

The correlation obtained so far, however, may not yet describe the whole incident. In some cases, the incident data 1920a-1920e may be incomplete. For example, suspect network traffic may be diverted to the emulated network when some network traffic is identified as suspect. The attack on the network, however, may have started before the suspect network traffic is identified, and may have escaped detection. Activity resulting from this network traffic may thus not have been captured in the incident data 1920a-1920e. In some implementations, the correlation engine 1982 thus may also receive additional data 1922, 1924, such as log files, from the site network. This additional data 1922, 1924 may include data 1922 captured by network packet monitors and data 1924 captured by computing systems in the site network, among other data available from the site network. In these implementations, the correlation engine 1982 may correlate events in the incident with events recorded in the additional data 1922, 1924. To continue the previous example, the correlation engine 1982 may learn from the additional data that a user in the site network received an email from a trusted source with an apparently innocent link, and that by following the link to a website, the user triggered downloading of the malware file.

In some implementations, the correlation engine 1982 may be able to iteratively search the incident data 1920a-1920e, repeatedly trying different searches to make connections between different events. In some implementations, the correlation engine 1982 may be able to replay the events in an incident to determine if it has found the events related to the attack, and/or to determine what resulted from a particular series of events. For example, the threat intelligence engine may receive a sequence of events, and may execute each event in the sequence in the r.

Once the correlation engine 1982 has made a best attempt at determining the events in an attack, the correlation engine 1982 may produce an incident report 1960. The incident report 1960 includes one or more indicators 1962, each of which describe an event.

### VI. Infiltration Detection and Network Rerouting

As noted above, the threat-analysis platform discussed above can analyze data obtained from an emulated network, which may be configured as a high-interaction network. In various implementations, network traffic analyzed by the high-interaction network can be sent to the high-interaction network from endpoints in a site network. These endpoints can include various computing systems in the site network that are used for the ordinary business of the site network. For example, endpoints can include user workstations configured for use by the site network's legitimate users. As a further example, endpoints can also include server systems, which may have a dedicated purpose in the site network, and/or which may be shared among the legitimate users of the site network.

In various implementations, network security for a site network can include monitoring an endpoint, and determining whether activity on the endpoint is suspicious. When suspicious activity is detected on the endpoint, network traffic to and from the endpoint can be redirected to a high-interaction network. Redirecting the network traffic, can cause the endpoint to be isolated from the rest of the site network, which may result in an attacker also being unable to reach the rest of the site network. The high-interaction network can be configured to emulate the site network and possibly also the compromised endpoint, so that the attacker remains unaware that he is not communicating with real systems in the site network. The high-interaction network can subsequently be used to analyze network traffic, determining whether the network traffic includes malicious activity, and possibly also analyzing the nature of the malicious activity.

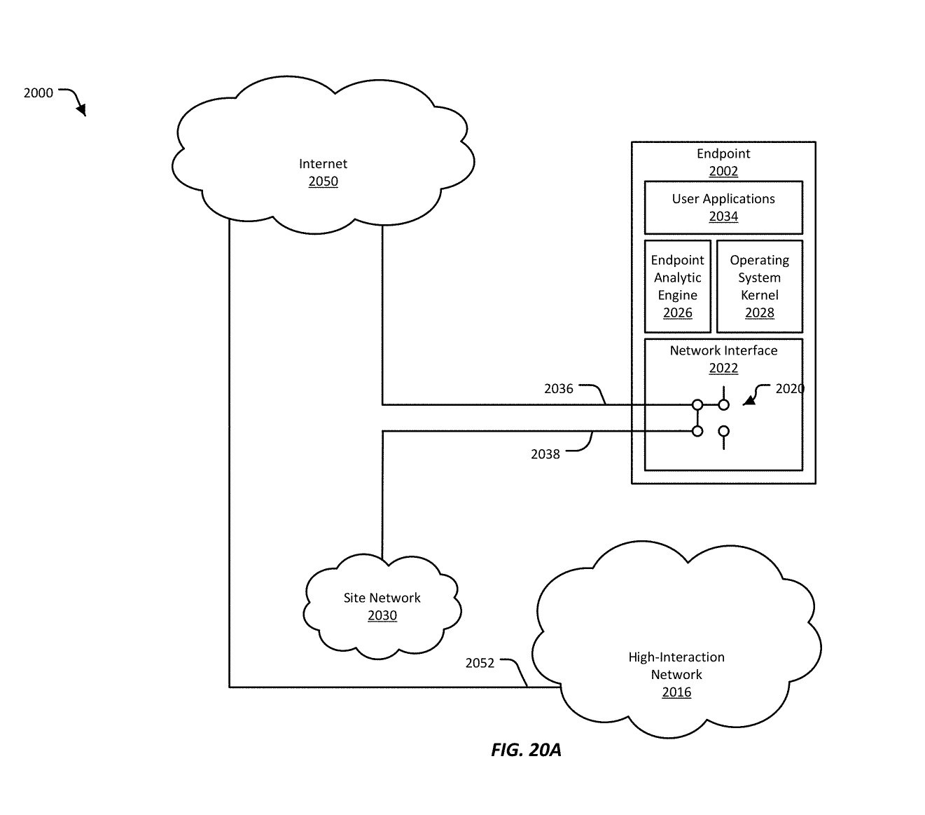

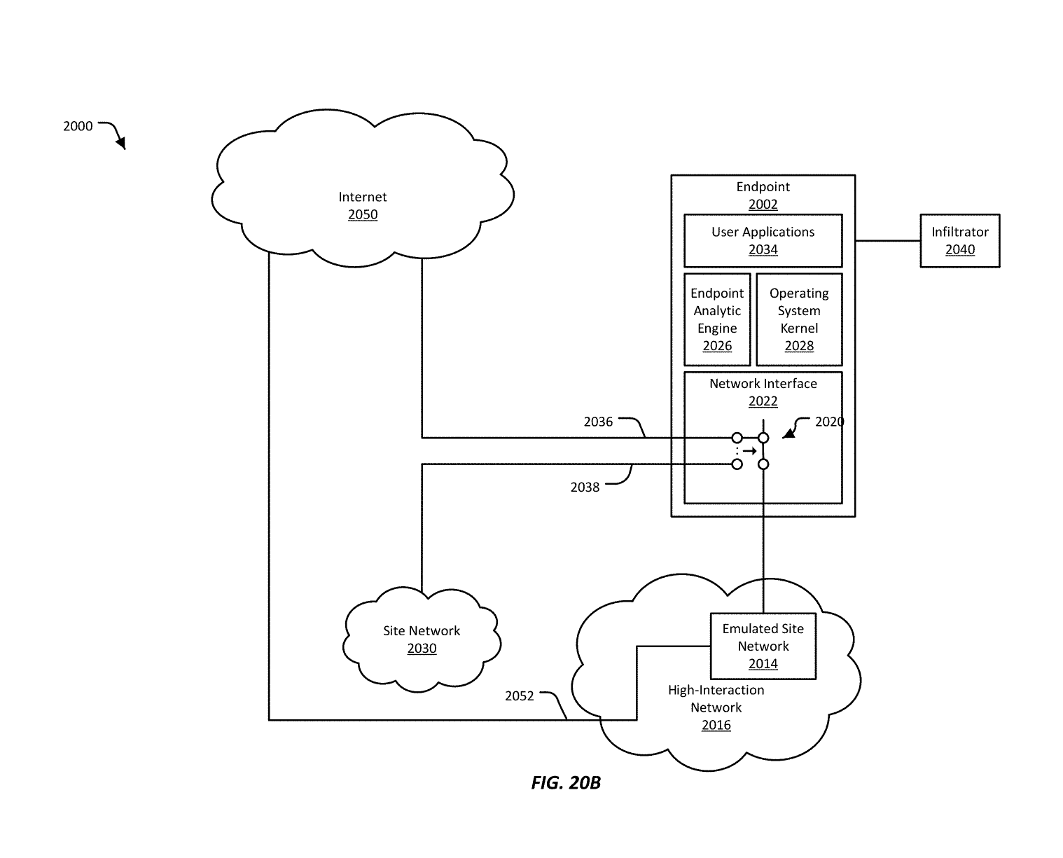

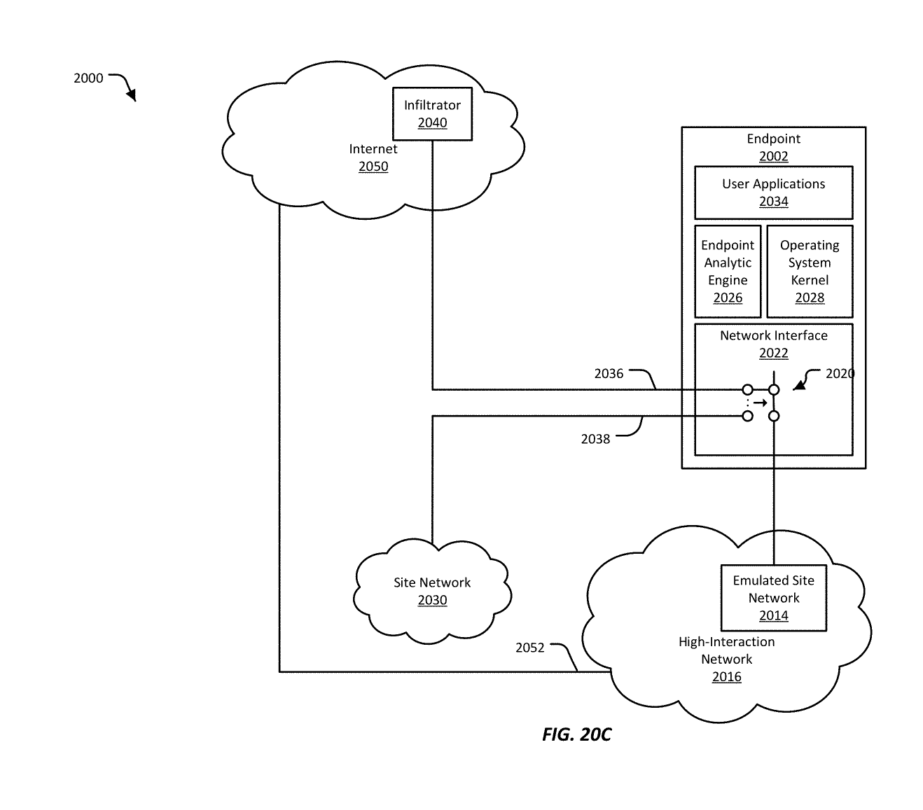

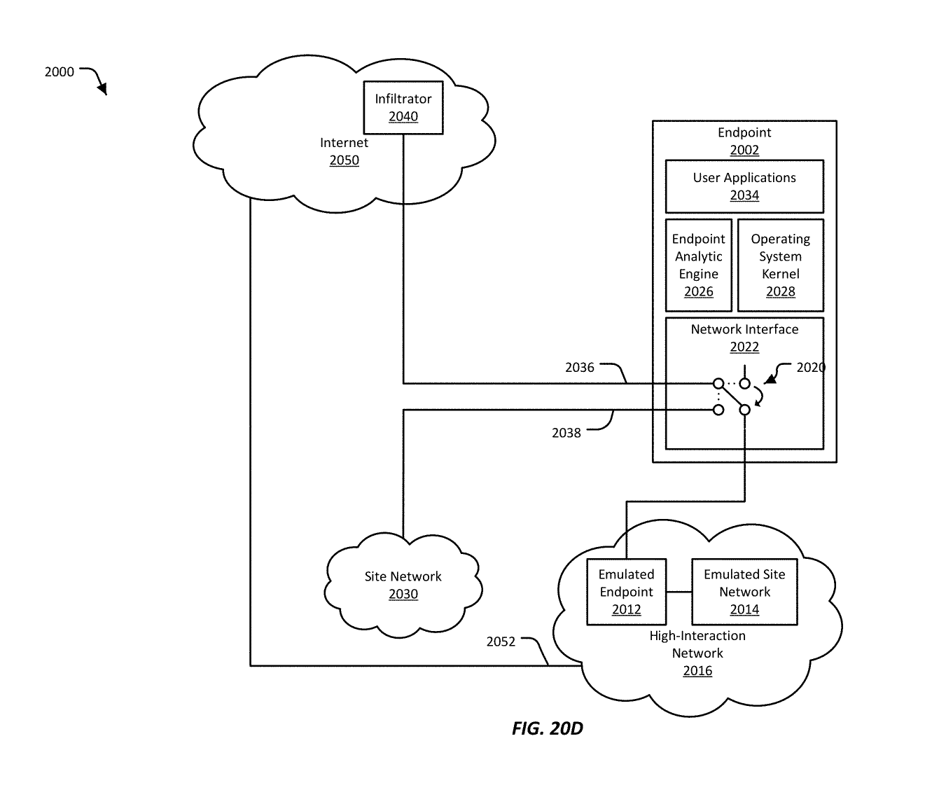

FIG. 20A illustrates an example of a system 2000 including an endpoint 2002 and a high-interaction network 2016. In this example, the endpoint 2002 is configured to communicate with a site network 2030 and the Internet 2050. The endpoint's 2002 connections to the site network 2030 and Internet 2050 are illustrated as individual communication channels 2036, 2038. In some implementations, the endpoint 2002 may have one physical network connection to the site network 2030, and may access the Internet 2050 through routers and gateway devices provided by the site network 2030. The endpoint 2002, however, may be configured to separate its network communications into separate channels 2036, 2038, one for communications outside the site network 2030 and one for communications within the site network 2030. In some implementations, the endpoint 2002 may be configured to communicate only with the site network 2030. In these implementations, the endpoint 2002 has only one communication channel 2038, and is unable to communicate outside the site network 2030.

An endpoint, such as the example endpoint 2002, executes user applications 2034 and operating system kernel 2028. The endpoint 2002 may also have an endpoint analytic engine 2026 and a network interface 2022. User applications are programs that may be executed by users of the endpoint 2002, including both non-privileged users and users with administrative privileges. Examples of user applications include word processing, spreadsheet, presentation, and email programs, web browsers, and games, among others. User applications typically execute in the endpoint's 2002 user space, that is, memory designated for use by user-level applications. The user space typically has limited access privileges, such that user applications 2034 can make very limited changes to the endpoint's 2002 software, and can only access the endpoint's 2002 hardware through the operating system. User space is restricted this way to prevent an errant user application 2034 from doing damage to the operating system or misusing the hardware.

The operating system kernel 2028 is the central part of the endpoint's 2002 operating system. The operating system kernel 2028 provides functions and processes that enable the user applications 2034 to access the endpoint's 2002 hardware. The operating system kernel 2028 may also coordinate the activities of the user applications 2034 and the rest of the operating system. Typically, the operating system kernel 2028 executes in kernel space, that is, a protected area of memory that generally cannot be written to by user applications 2034.

The endpoint analytic engine 2026 is software, hardware, or a combination of software and hardware configured to monitor the endpoint 2002 for conditions that indicate a suspect access to the endpoint 2002. The endpoint analytic engine 2026 may interface with the operating system kernel 2028 and the user applications 2034 to watch for certain conditions, discussed in further detail below. These conditions may indicate that an infiltrator has gained access, or is attempting to gain access to the endpoint 2002. In some implementations, the endpoint analytic engine 2026 may be implemented as a software process that executes in kernel space. In some implementations, the endpoint analytic engine 2026 may be implemented in an integrated circuit that can be added to the endpoint 2002, and that has access to the operations of the operating system kernel 2028. In some implementations, the endpoint analytic engine 2026 may be integrated into a processor that supports the operation of the endpoint 2002. In some implementations, the endpoint analytic engine 2026 may be a board that can be added to the endpoint's 2002 hardware. In these implementations, the endpoint analytic engine 2026 may be implemented in an integrated circuit and/or in firmware executing on an integrated circuit.

The network interface 2022 is software or a combination of software and hardware that provides the endpoint 2002 with the ability to communicate with the site network 2030 and the Internet 2050. The network interface 2022 may have control logic 2020 that is able to control the communication channels 2036, 2038 between the endpoint 2002 and the site network 2030 and the Internet 2050. The control logic 2020 may control physical connections or may control logical connections. In some implementations, the network interface 2022 is controlled by the operating system kernel 2028 and/or the endpoint analytic engine 2026. In some implementations, the endpoint analytic engine 2026 is incorporated into the network interface 2022.

The site network 2030 is a local network that the endpoint 2002 is a part of. As used herein, a site network is generally a network that is under administrative control by one entity. For example, the site network 2030 may be a network installed at a business, a school campus, a hospital, a government site, or a private home. The site network 2030 may have one or more sub-networks, or subnets. The site network 2030 may also be referred to as a LAN or a group of LANS. The endpoint 2002 may be one of many endpoints in the site network 2030. The site network 2030 may also include routers, switches, hubs, gateways, and other network devices that provide the infrastructure for a network.

In this example, the Internet 2050 is provided as an example of networks located outside the administrative control of the entity that controls the site network 2030. The Internet 2050 may include both public and private networks. As noted above, the endpoint 2002 may either communicate with the Internet 2050 directly, or may communicate with the Internet 2050 through network infrastructure provided by the site network 2030.

As part of its security infrastructure, the system 2000 may also include a high-interaction network 2016. The high-interaction network 2016 is an isolated, self-contained, closely monitored network that can be quickly reconfigured, repaired, brought up, or taken down. The high-interaction network 2016 is not a part of the site network 2030, and exists within a physically and/or virtually isolated, contained space. The high-interaction network 2016, however, appears and behaves just as does a real network, including having a connection to the Internet 2050. The high-interaction network 2016 may consist of physical routers, switches, and servers. Alternatively or additionally, the high-interaction network 2016 may consist of a fully emulated network residing on one or more servers. Alternatively or additionally, the high-interaction network 2016 may consist of a combination of physical devices and emulated devices. In some implementations, the high-interaction network 2016 may reside at a cloud service provider, with use of the high-interaction network 2016 provided by the cloud service provider. In some implementations, the high-interaction network 2016 may be configured to emulate all or part of the site network 2030.

FIG. 20B illustrates an example of infiltration of the system 2000 at the endpoint 2002. In this example, a possible infiltrator 2040 has direct access to the endpoint 2002, either because the infiltrator 2040 has physically connected another device to the endpoint 2002, or because the infiltrator 2040 is sitting in front of the endpoint 2002, or because the infiltrator 2040 has otherwise interfaced to the endpoint 2002 without using the endpoint's 2002 network connection. Cases where the infiltrator 2040 has used the endpoint's 2002 network connection to connect to the endpoint 2002 are discussed below.

The infiltrator 2040 may be attempting to gain access to the endpoint 2002 using various methods. The endpoint analytic engine 2026 may be monitoring the endpoint 2002 for conditions that indicate use of one of these methods. Examples of infiltration methods include privilege escalation, use of decoy passwords, installation of administrative tools or other unauthorized tools, and remote code execution. Privilege escalation is the modification of an access privilege of a user application 2034 or a user account, usually resulting in increasing the access privilege. Use of a decoy password is a login into the endpoint 2002 using a password that was deliberately “leaked” to provide bait for an infiltrator. Administrative tools are applications that can be used by an administrator for legitimate administration of the endpoint 2002, but which can also be used to hack into the endpoint 2002. Other unauthorized tools include, for example, password cracking tools, password dumping tools, and reconnaissance tools, among others. Remote code execution involves exploitation of a vulnerability in a user application 2034 that allows malicious code to commandeer the normal execution flow of the user application 2034. These example methods are described in further detail below.

Once the endpoint analytic engine 2026 detects that a condition has occurred, indicating a suspect access, the endpoint analytic engine 2026 may cause the network interface 2022 to redirect communications between the endpoint 2002 and the site network 2030 to the high-interaction network 2016. For example, the network interface's 2022 control logic 2020 may disconnect from the communication channel 2038 with the site network 2030, and enable a connection to the high-interaction network 2016. Redirection of the endpoint's 2002 network communications may involve flipping one or more mechanical or electronic switches. Alternatively or additionally, redirection may be at a logical level. For example, in some implementations, packets received by endpoint 2002 that are addressed to the site network 2030 may have their destination addresses changed to an address in the emulated site network 2014 in the high-interaction network 2016. Similarly, packets received from the emulated site network 2014 may have their source addresses changed to an address from the site network 2030 before the packets are sent on to the Internet 2050, so that it appears that the packet came from the site network 2030. Other techniques can be used to cause packets to by logically redirected, including, for example, encapsulation.

In some implementations, the network interface 2022 may maintain the endpoint's 2002 communication channel 2036 with the Internet 2050 while disabling the communication channel 2038 with the site network 2030. In some cases, the infiltrator's 2040 attack on the system 2000 may include downloading or uploading data from or to the Internet 2050. Hence providing the infiltrator 2040 with a communication channel 2036 with the Internet 2050 may provide additional information about the infiltrator's 2040 methods and motive

As a result of redirecting the endpoint's 2002 network communications, the endpoint 2002 may be effectively cut off and isolated from the site network 2030, and the infiltrator 2040 will be unable to do harm to the site network 2030. Instead, the endpoint 2002 is provided with a communication channel with an emulated site network 2014 in the high-interaction network 2016. The emulated site network 2014 emulates all or part of the site network 2030. Should the infiltrator 2040 attempt to log in to a server in the site network 2030 or attempt to access data in the site network 2030, the infiltrator 2040 will be presented with emulated servers and data, so that the infiltrator's attempts can succeed. But because the infiltrator 2040 is communicating with the emulated site network 2014, rather than the site network 2030, no harm should come to the site network 2030. Furthermore, the infiltrator's 2040 activities in the emulated site network 2014 can be analyzed.

The high-interaction network 2016 provides a controlled space in which to conduct static, dynamic, and/or network analysis of the infiltrator's 2040 activity, including both actions taken at the endpoint 2002 and in the emulated site network 2014. As discussed in further detail below, static analysis may include, for example, opening files found in suspect network traffic generated by the infiltrator 2040 and/or deconstructing the files using decompression and/or decompilation tools. Dynamic analysis may include, for example, unpacking the contents of packets in the infiltrator's 2040 network traffic and interacting with the contents as would a real network user. Network analysis may include, for example, tracing network actions or activity initiated by interacting with the contents of the suspect network traffic.

The high-interaction network 2016 may provide data that can be used to generate indicators. The indicators may confirm that a malicious actor has infiltrated the endpoint 2002, or that supposed infiltration was, in fact, harmless. The indicators may further describe and/or identify the infiltrator's 2040 activity. The indicators may include, for example, a description of the type of any content found in the infiltrator's 2040 network traffic, a description of the results from opening and/or conducting other operations on the content, source and destination addresses for the suspect network traffic, and/or digital signatures of any files found in the content. The indicators can also include “indicators of compromise” (IOCs). Indicators of compromise are a set of data that describes identified malicious activity. Indicators of compromise can be used to describe virus signatures, Internet Protocol (IP) addresses associated with suspicious activity, Message Data algorithm 5 (MD5) hashes of malware files, or Uniform Resource Locations (URLs) or domain names of botnet command and control servers. Indicators of compromise can be used by intrusion detection systems and anti-virus software to detect attacks on a network. Indicators of compromise may be formatted for both human and machine readers, such as for example using Extensible Markup Language (XML).

The indicators can be used to improve the security of the endpoint 2002 and/or the site network 2030. For example, the indicators may describe a fault in a user application 2034 that allowed the infiltrator 2040 to execute remote code, and that the remote code caused privilege escalation, resulting in the infiltrator 2040 gaining access to the endpoint 2002. Having been identified, the fault in the user application 2034 can be patched. The same fault can also be patched in other endpoints in the site network 2030. In some implementations, indicators may be shared between sites, to improve overall network security.

In this example, redirection of the endpoint's 2002 network communication resulted in the endpoint 2002 being quarantined from the site network 2030. Analysis of the infiltrator's 2040 activity may result in determining that the infiltrator 2040 had direct access to endpoint 2002. Once the infiltrator 2040 has been removed from the endpoint 2002, the endpoint 2002 can be reconnected to the site network 2030. In some cases, the endpoint 2002 may need to be “scrubbed” before it can be reconnected to the site network 2030; that is, it may be necessary to remove any files or applications installed by the infiltrator 2040, to patch user applications 2034 to fix security vulnerabilities, rebuild the operating system, reinstall the user applications 2034, reformat the hard drives, restart the endpoint analytic engine 2026, and so on. Once the endpoint 2002 has been cleaned, and the infiltration has been analyzed and ended, the endpoint 2002 can be reconnected to the site network 2030.

FIG. 20C illustrates another example of infiltration of the system 2000, where, in this case, the infiltrator 2040 is attempting to access the endpoint 2002 through the endpoint's 2002 network connection. In this example, the infiltrator 2040 is located outside the site network 2030, such as somewhere on the Internet 2050. The infiltrator 2040 is able to communicate with the endpoint 2002 using the endpoint's communication channel 2036 with the Internet 2050. Using this communication channel 2036, the infiltrator 2040 may attempt to gain access to the endpoint 2002 using various techniques, such as privilege escalation, decoy passwords, installation of administrative tools or other unauthorized tools, remote code execution, or some other technique, or a combination of techniques.

The endpoint's 2002 endpoint analytic engine 2026 may detect a condition that indicates a possible infiltration attempt or an actual infiltration. Once such a suspect access is detected, the endpoint analytic engine 2026 may cause the network interface 2022 to redirect communications between the endpoint and the site network 2030. For example, the network interface's 2022 control logic 2020 may disconnect the endpoint's 2002 communication channel 2038 with the site network 2030. The control logic 2020 may further connect the endpoint 2002 to the high-interaction network 2016. Disconnecting and connecting the endpoint 2002 may involve changing a physical connection or a logical connection. As a result of the redirection, the endpoint 2002 is isolated from, and can no longer communicate with the site network 2030. The endpoint 2002 can still communicate with the Internet 2050, so that the infiltrator 2040 can continue the access the endpoint 2002. The high-interaction network 2016 may be configured with an emulated site network 2014. The emulated site network 2014 may lead the infiltrator 2040 to believe that the endpoint 2002 is still able to communicate with the site network 2030. The infiltrator 2040 may thus be encouraged to continue his infiltration.

As discussed above, the infiltrator's 2040 activity can be analyzed in the high-interaction network 2016. In the high-interaction network 2016, the infiltrator 2040 is allowed to install tools, upload files, make modifications, and whatever other actions the infiltrator 2040 is interested in making. This activity may be captured, and the captured information may be used to generate indicators describing and/or identifying the activity. In some cases, it may be possible to establish the infiltrator's 2040 location on the Internet 2050; for example, it may be possible to establish the infiltrator's 2040 IP address and/or Internet domain.

As in the previous example, once a possible infiltration attempt is detected, the endpoint 2002 may be isolated from the site network 2030. The endpoint 2002 may be reconnected to the site network 2030 once the infiltration has been analyzed and blocked, or otherwise stopped. In some cases, the endpoint 2002 may need to be scrubbed or cleaned or rebuilt to remove any effects of the infiltration. Once the endpoint 2002 has been scrubbed, it may be reconnected to the site network 2030.

FIG. 20D illustrates another example of infiltration of the system 2000 by an infiltrator attempting to use the endpoint's 2002 network connection to infiltrate the endpoint 2002. In this example, the infiltrator 2040 is located outside the site network 2030, for example on the Internet 2050. The infiltrator 2040 is using the endpoint's 2002 communication channel 2036 with the Internet 2050 to interface with the endpoint 2002. Using this communication channel 2036, the infiltrator 2040 may attempt to gain access to the endpoint 2002 using various techniques, such as privilege escalation, decoy passwords, installation of administrative tools or other unauthorized tools, remote code execution, or some other technique, or a combination of techniques.

The endpoint's 2002 endpoint analytic engine 2026 may detect a condition that indicates a suspect access to the endpoint 2002 over the communication channel 2036 with the Internet 2050. Once the suspect access is detected, the endpoint analytic engine 2026 may cause the network interface 2022 to redirect communications between the endpoint and the site network 2030. For example, the network interface's 2022 control logic 2020 may disable the endpoint's 2002 communication channel 2038 with the site network 2030, and enable a connection between the endpoint 2002 and the high-interaction network 2016. The control logic 2020 may further establish a connection between the communication channel 2036 to the Internet 2050 and the high-interaction network 2016. Redirecting the endpoint's 2002 network communications may involve changing a physical or a logical connection. As a result of the redirection, communications between the Internet 2050 and endpoint 2002 are rerouted to the high-interaction network 2016. Furthermore, the infiltrator 2040 is not able to communicate with either the site network 2030 or the endpoint 2002. The site network 2030 as well as the endpoint 2002 are thus protected from the infiltrator's 240 activity. The high-interaction network 2016 may be configured with an emulated endpoint 2012 so that the infiltrator 2040 may be lead to believe that he is still communicating with the endpoint 2002. The high-interaction network 2016 may further be configured with an emulated site network 2014, so that the infiltrator 2040 may think he can still access the site network 2030.

As discussed above, the infiltrator's 2040 activity can be analyzed in the high-interaction network 2016. In some cases, the security of the emulated endpoint 2012 and the emulated site network 2014 may be lowered to encourage the infiltration. Encouraging the infiltration may provide more information about the infiltrator's 2040 methods and intent, and also about the security vulnerabilities in the endpoint 2002 and/or site network 2030. Data provided by monitoring the infiltrator's 2040 activity in the high-interaction network 2016 can be used to generate indicators describing and/or identify this activity. These indicators may be used to improve the security of the endpoint 2002 and/or the site network 2030.

In this example, the endpoint 2002 is isolated from any activity, and functions primarily as a pass-through for capturing the infiltrator's 2040 activity. Any data on the endpoint 2002 may thus be protected from access by the infiltrator 2040. Once the infiltration has been analyzed and stopped, the endpoint 2002 may be reconnected to the site network 2030. Even though the endpoint 2002 was isolated from activity by the infiltrator 2040, it may nevertheless by necessary to scrub the endpoint 2002 before reconnecting it to the site network 2030. For example, the condition that caused the endpoint analytic engine 2026 to detect attempted infiltration may have made some modification to the endpoint 2002, such as installation of an administrative tool or other unauthorized tool. These modifications may need to be undone before the endpoint 2002 can be reconnected to the site network 2030.

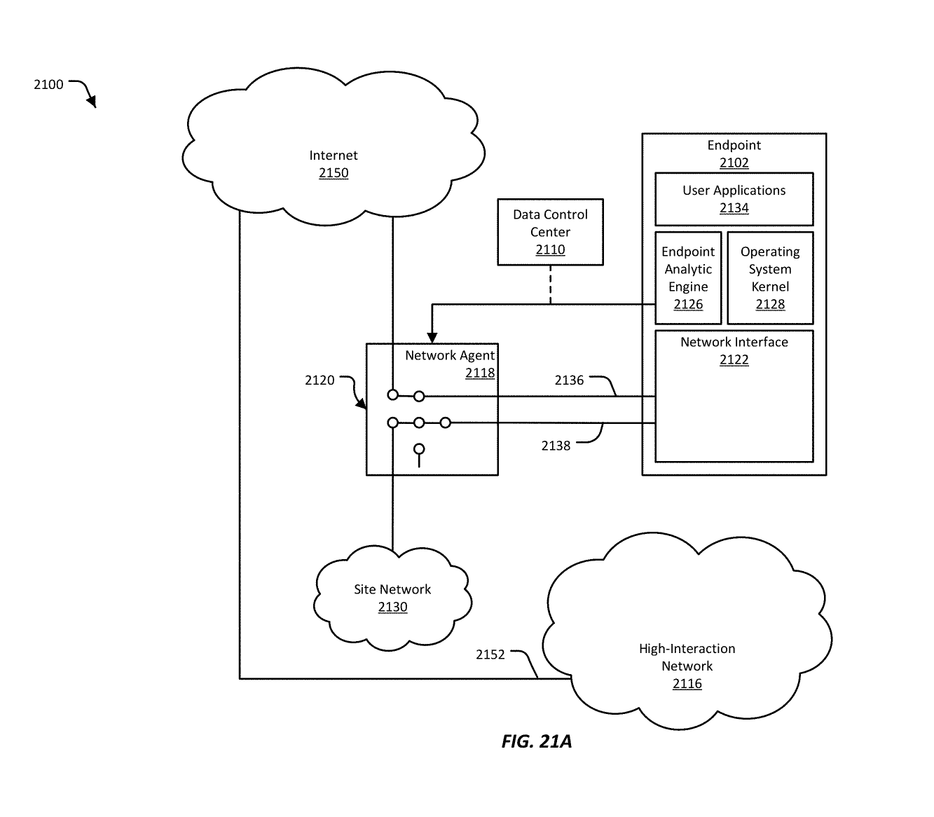

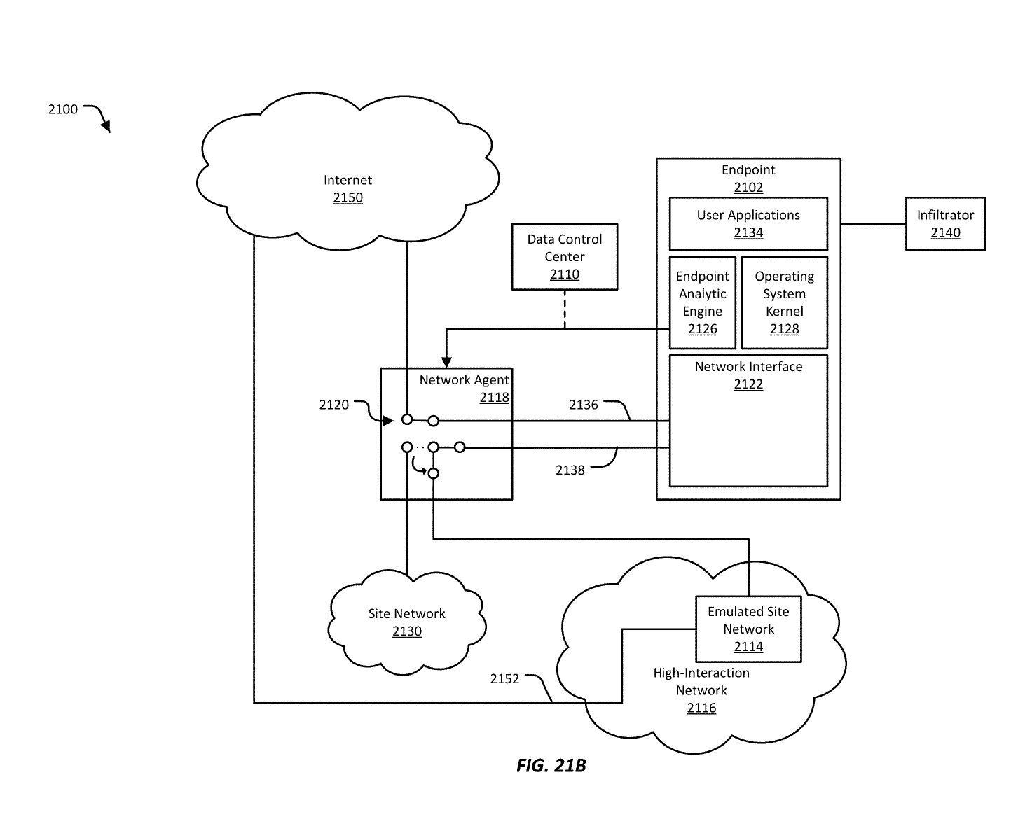

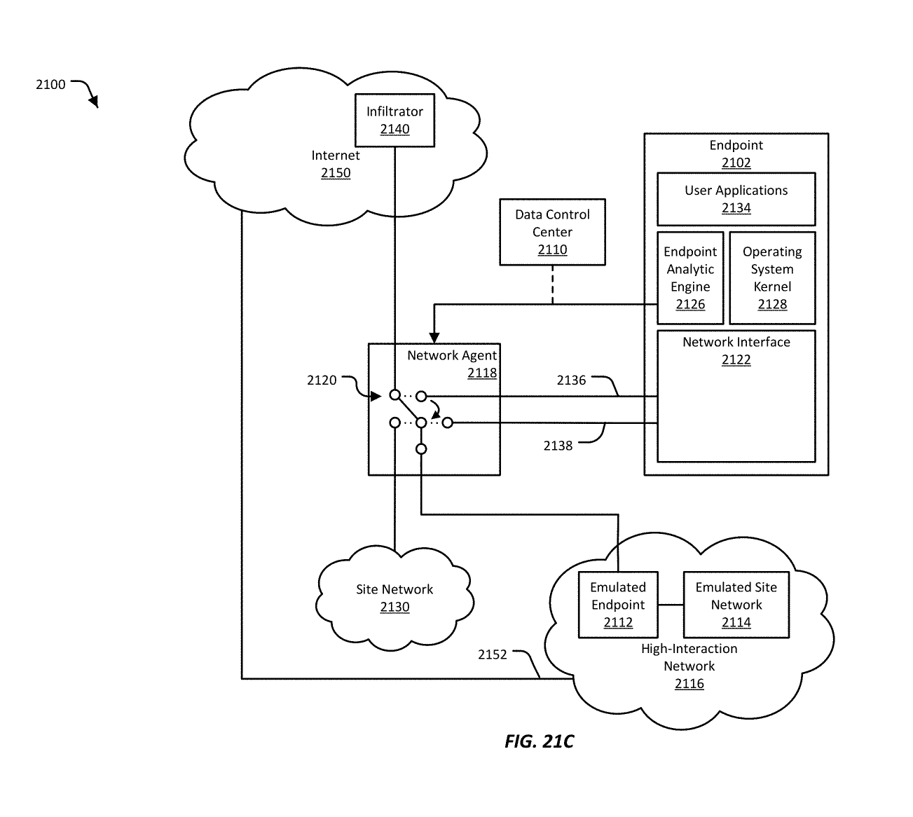

FIG. 21A illustrates an example of a system 2100 including an endpoint 2102 and a high-interaction network 2116. In this example, the endpoint 2102 may communicate with a network agent 2118. The network agent 2118 may be configured to control communications between the endpoint 2102 and a site network 2130. The network agent 2118 may also be configured to control communications between the endpoint 2102 and the Internet 2150. In some implementations, the network agent 2118 may be controlled by a data control center 2110. The endpoint 2102 may have a communication channel 2138 with the site network 2130, which is controlled by the network agent 2118. The endpoint 2102 may have a separate communication channel 2136 with the Internet 2150, which may also be controlled by the network agent 2118. While the endpoint 2102 may have one physical network connection, the network agent 2118 may be configured to separate the endpoint's 2102 network communications into separate channels 2136, 2138, one for communications within the site network 2130 and one for communications outside the site network. In some implementations, the endpoint 2102 is not configured to communicate with the Internet 2150. In these implementations, the endpoint 2102 has only one communication channel 2138 for communicating with the site network 2130.

An endpoint, such as the example endpoint 2102, executes user applications 2134 and operating system kernel 2128. The endpoint 2102 may also have an endpoint analytic engine 2126 and a network interface 2122. User applications are programs that may be executed by users of the endpoint 2102, including both ordinary users and users with administrative privileges. User applications typically execute in the endpoint's 2102 user space. The user space typically has limited access privileges, such that user applications 2134 can make very limited changes to the endpoint's 2102 software, and can only access the endpoint's 2102 hardware through the operating system.

The operating system kernel 2128 is the central part of the endpoint's 2102 operating system. The operating system kernel 2128 provides functions and processes that enable the user applications 2134 to access the endpoint's 2102 hardware. The operating system kernel 2128 may also coordinate the activities of the user applications 2134 and the rest of the operating system. Typically, the operating system kernel 2128 executes in kernel space, that is, a protected area of memory that generally cannot be written to by user applications 2134.

The endpoint analytic engine 2126 is software, hardware, or a combination of software and hardware configured to monitor the endpoint 2102 for conditions that indicate a suspect access to the endpoint 2102. The endpoint analytic engine 2126 may interface with the operating system kernel 2128 and the user applications 2134 to watch for certain conditions, discussed in further detail below. These conditions may indicate that an infiltrator has gained access, or is attempting to gain access to the endpoint 2102. In some implementations, the endpoint analytic engine 2126 may be implemented as a software process that executes in kernel space. In some implementations, the endpoint analytic engine 2126 may be implemented in an integrated circuit that can be added to the endpoint 2102, and that has access to the operations of the operating system kernel 2128. In some implementations, the endpoint analytic engine 2126 may be integrated into a processor that supports the operation of the endpoint 2102. In some implementations, the endpoint analytic engine 2126 may be a board that can be added to the endpoint's 2102 hardware. In these implementations, the endpoint analytic engine 2126 may be implemented in an integrated circuit and/or in firmware executing on an integrated circuit.

The network interface 2122 is software or a combination of software and hardware that provides the endpoint 2102 with the ability to communicate with the site network 2130 and the Internet 2150. For example, in some implementations, the network interface 2122 may be implemented as a network interface card. In some implementations, the network interface 2122 is controlled by the operating system kernel 2128 and/or the endpoint analytic engine 2126. In some implementations, the endpoint analytic engine 2126 is incorporated into the network interface 2122.

The site network 2130 is a local network that the endpoint 2102 is a part of. As used herein, a site network is generally a network that is under administrative control by one entity. The site network 2130 may also be referred to as a LAN or a group of LANS. The endpoint 2102 may be one of many endpoints in the site network 2130. The site network 2130 may also include routers, switches, hubs, gateways, and other network devices that provide the infrastructure for a network.

The high-interaction network 2116 is an isolated, self-contained, closely monitored network that can be quickly reconfigured, repaired, brought up, or taken down. The high-interaction network 2116 is not a part of the site network 2130, and exists within a physically and/or virtually isolated, contained space. The high-interaction network 2126, however, appears and behaves just as does a real network, including having a connection to the Internet 2150. Hardware supporting the high-interaction network 2116 may be located in the same physical site as the site network 2130. Alternatively or additionally, the high-interaction network 2116 may be provided by a cloud services provider, providing services over the Internet 2150.

The network agent 2118 is a device that may be configured to control network communications for the endpoint 2102. The network agent 2118 may have control logic 2120 that is able to control the communication channels 2136, 2138 between the endpoint 2102, the Internet 2150, and the site network 2130. The control logic 2120 may control physical connections or may control logical connections. In some implementations, the network agent 2118 may control network communications for multiple endpoints. In these implementations, the network agent 2118 may have separate control logic 2120 for each endpoint. In some implementations, the network agent 2118 is a standalone network device that connects the endpoint 2102 to the site network 2130 and the Internet 2150. In some implementations, the network agent 2118 is incorporated into another network device, such as a router, switch, or network controller. In some implementations, the network agent 2118 may be incorporated into the endpoint 2102.

In various implementations, the network agent 2118 may monitor access to the endpoint 2102. For example, in some implementations, an endpoint analytic engine 2126 may be running on the endpoint 2102, and the network agent 2118 may receive messages from the endpoint analytic engine 2126. A message from the endpoint analytic engine 2126 may indicate that a suspect access has occurred at the endpoint 2102. As discussed below, the endpoint analytic engine 2126 may subsequently redirect network communications for the endpoint 2102.

In some implementations, the network agent 2118 may be controlled by a data control center 2110. In various implementations, the data control center 2110 may be a central service for monitoring network security for the site network 2130. The data control center 2110 may collect information from some or all of the endpoints, as well as other network equipment, in the site network 2130. The data control center 2110 may further adjust the site network's 2130 security configuration, using the collected information. The data control center 2110 may be a server or a group of servers. Alternatively or additionally, the data control center 2110 may be a process running on a server or a group of servers. Alternatively or additionally, the data control center 2110 may be a dedicated network appliance.

In some implementations, the data control center 2110 may receive messages transmitted from the endpoint's 2102 endpoint analytic engine 2126. In some implementations, the data control center 2110 may add these messages to a log file and/or may analyze the contents of these messages to evaluate the current security of the site network 2130. In some implementations, the data control center 2110 may use these messages to inform the network agent 2118 that the network agent 2118 should redirect network communications to and from the endpoint 2102.

FIG. 21B illustrates an example of infiltration of the system 2100 at the endpoint 2102. In this example, a possible infiltrator 2140 has direct access to the endpoint 2102, meaning the infiltrator 2140 likely has physical access to the endpoint 2102, and does not need the endpoint's 2102 network connection to access the endpoint 2102. The infiltrator 2140 may be using various techniques to gain access to the endpoint 2102, such as privilege escalation, decoy passwords, installation of administrative tools or other unauthorized tools, remote code execution, or some other technique, or a combination of techniques. The endpoint analytic engine 2126 may detect a condition indicating that the infiltrator 2140 is attempting to gain access to the endpoint, or may detect a condition indicating that the infiltrator 2140 has already gained access to the endpoint 2102.

Once the endpoint analytic engine 2126 detects that a condition has occurred, indicating a suspect access, the endpoint analytic engine 2126 may cause the network interface 2122 to redirect communications between the endpoint 2102 and the site network 2130 to the high-interaction network 2116. For example, the endpoint analytic engine 2126 may transmit a request, where the request includes instructions to redirect the endpoint's 2102 network communications. In some implementations, the request may be received by the network agent 2118. The request indicates to the network agent 2118 that a suspect access has been detected at the endpoint 2102. In some implementations, the request maybe received by the data control center 2110, which then indicates to the network agent 2118 that a suspect access has occurred at the endpoint 2102.

Once the network agent 2118 has been informed that a suspect access has occurred at the endpoint 2102, the network agent 2118 may redirect communications between the endpoint 2102 and the site network 2130 to the high-interaction network 2116. For example, the network agent's 2118 control logic 2120 may disable the endpoint's 2102 connection with the site network 2130 and enable a connection between the endpoint 2102 and the high-interaction network 2116. Redirecting the endpoint's 2102 network communications may involve changing a physical connection or a logical connection. For example, in some implementations, the network agent's 2118 control logic 2120 may include relays or switching circuits. Alternatively or additionally, in some implementations, the control logic 2120 may reroute packets between the endpoint 2102 and the site network 2130 to the high-interaction network 2116 instead.

By disconnecting the endpoint's 2102 communication channel 2138 with the site network 2130, the endpoint 2102 is effectively isolated from the site network 2130. The infiltrator 2140 may thus be unable to cause any harm to the site network 2130. Instead, the endpoint 2102 may communicate with an emulated site network 2114 in the high-interaction network 2116. The emulated site network 2114 may emulate some or all of the hardware and data resources available in the site network 2130. Thus, should the infiltrator 2140 attempt to access the site network's 2130 resources, the infiltrator 2140 will instead be able to access emulated versions of these resources in the high-interaction network 2116. Thus, while the endpoint 2102 may no longer have access to the site network 2130, the infiltrator 2140 may be lead to believe that the endpoint 2102 is still able to communicate with the site network 2130. The infiltrator 2140 may thus be able to continue his infiltration.

In some implementations, the network agent 2118 maintains the endpoint's 2102 communication channel 2136 with the Internet 2150. In some cases, the infiltrator's 2140 attack on the system 2100 may include downloading or uploading data from or to the Internet 2150. Finding that he cannot reach the Internet 2150 from the endpoint 2102 may thus discourage the infiltrator 2140 from continuing his intrusion into the system 2100. Maintaining the Internet 2150 communication channel 2136 may thus both encourage the infiltration, and provide information about the infiltrator's 2140 activities.

Once the endpoint's 2102 network communications have been redirected, the infiltrator's 2140 activity can be analyzed in the high-interaction network 2116. In the high-interaction network 2116, the infiltrator 2140 is allowed to install tools, upload files, make modifications, and whatever other actions the infiltrator 2140 is interested in making. This activity may be captured, and the captured information may be used to generate indicators describing and/or identifying the activity. These indicators can be used to improve the security of the endpoint 2102 and/or the site network 2130. For example, the indicators may show where there are security vulnerabilities in the user applications 2134 and/or the endpoint's 2102 operating system. These security vulnerabilities can be fixed on the endpoint 2102, as well as on other endpoints in the site network 2130 that have the same user applications 2134 and/or operating system.

As noted above, once the network agent 2118 redirect's the endpoint's 2102 network communications, the endpoint 2102 may be isolated from the site network 2130. Once the infiltration has been analyzed and the infiltrator 2140 has been removed from the endpoint 2102, the endpoint 2102 can be reconnected to the site network 2130. In most cases, however, the endpoint 2102 may first need to be scrubbed to remove any effects of the infiltration (e.g., files added, removed, and/or modified) and to correct any security flaws.

FIG. 21C illustrates another example of infiltration of the system 2100, where the infiltrator 2140 is located outside the site network 2130, such as somewhere on the Internet 2150. In this example, the infiltrator 2140 may be attempting to access the endpoint 2102 through the endpoint's 2102 communication channel 2136 with the Internet 2150. Using this communication channel 2136, the infiltrator 2140 may attempt to gain access to the endpoint 2102 using various techniques, such as privilege escalation, decoy passwords, installation of administrative tools or other unauthorized tools, remote code execution, or some other technique, or a combination of techniques.

The endpoint analytic engine 2126 at the endpoint 2102 may detect a condition that indicates a possible infiltration attempt or an actual infiltration. Once the condition is detected, the endpoint analytic engine 2126 may send a request to the network agent 2118 requesting that the endpoint's 2102 network communications be redirected. This request may indicate to the network agent 2118 that a suspect access has occurred at the endpoint 2102. The network agent 2118 may subsequently redirect communications between the endpoint 2102 and the site network 2130. For example, the network agent 2118 may disconnect the communication channel 2138 between the endpoint 2102 and the site network 2130. The network agent 2118 may further disable the communication channel 2138 between the endpoint 2102 and the Internet 2150, and enable a connection between the Internet 2150 and the high-interaction network 2116. As a result of this redirection, the communications between the Internet 2150 and the endpoint 2102 are redirected to the high-interaction network 2116. Furthermore, the infiltrator 2140 is not able to communicate with either the site network 2130 or the endpoint 2102. The site network 2130 and the endpoint 2102 may thus both be protected from any actions by the infiltrator 2140. The high-interaction network 2116 may be configured with an emulated endpoint 2112 so that the infiltrator 2140 believes that he is still communicating with the endpoint 2102. The high-interaction network 2116 may further be configured with an emulated site network 2114, so that the infiltrator 2140 may think he can still access the site network 2130.

As discussed above, the infiltrator's activity 2140 can be analyzed in the high-interaction network 2116. In the high-interaction network, the infiltrator 2140 is allowed to access emulated network servers and data, install files (including malware), steal data, make modifications, or whatever other actions the infiltrator 2140 wants to make. This activity may be captured by the high-interaction network 2116, and be used to generate indicators describing and/or identifying the activity. The indicators may be used to improve the security of the endpoint 2102 and/or the site network 2130.

In this example, once the network agent 2118 redirects the endpoint's 2102 network communications, the endpoint 2102 may be disconnected from any network communications. Any data on the endpoint 2102 may thus be protected from access by the infiltrator 2140. Once the infiltration has been analyzed and stopped, the endpoint 2102 may be reconnected to the site network 2130. Even though the endpoint 2102 was isolated from activity by the infiltrator 2140, it may nevertheless by necessary to scrub the endpoint 2102 before reconnecting it to the site network 2130. For example, the condition that caused the endpoint analytic engine 2126 to detect attempted infiltration may have made involved a flaw in a user application 2134. This flaw may need to be corrected before the endpoint 2102 can be reconnected to the site network 2130.

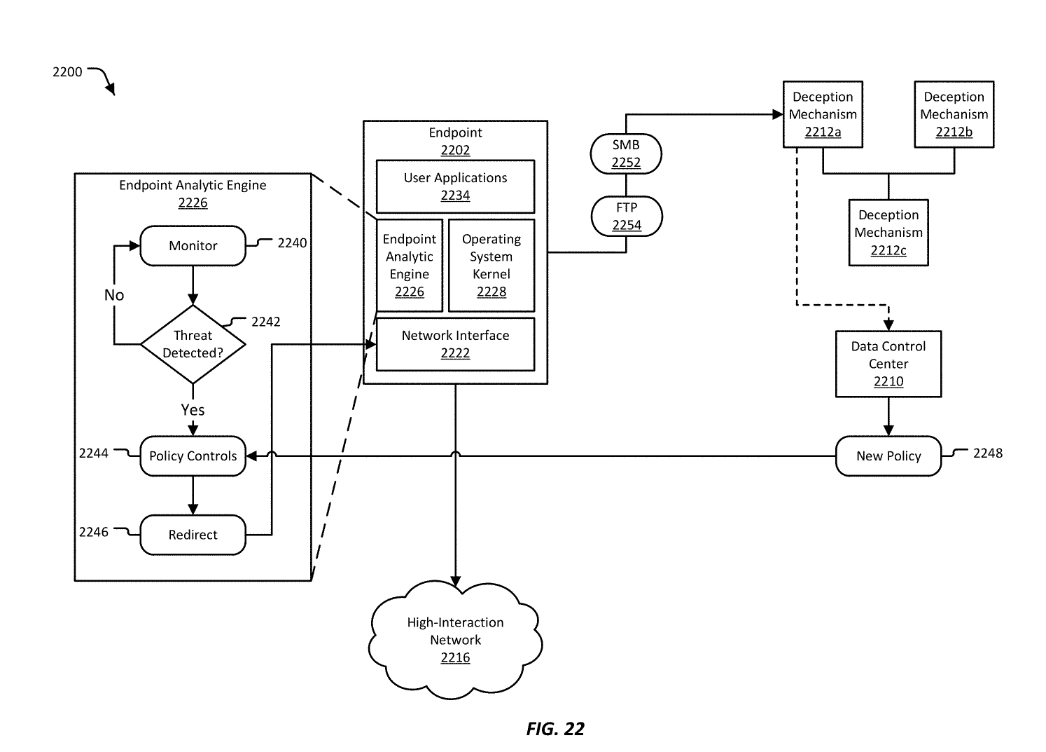

FIG. 22 illustrates an example of the operation of an endpoint analytic engine 2226 in an endpoint 2202, as well as an alternate implementation for detected whether the endpoint 2202 has been infiltrated. The example of FIG. 22 illustrates a system 2200 that includes the endpoint 2202, a number of deception mechanisms 2212a-2212c that can be used to detect suspicious activity occurring on the endpoint 2202, a high-interaction network 2216 that can be used to analyze network traffic to and from the endpoint, and a data control center 2210 that can control redirection of the endpoint's 2202 network traffic. The example endpoint 2202 is part of a site network, not illustrated here, which can include other endpoints and network devices.

The endpoint 2202 executes user applications 2234 and operating system kernel 2228. User applications are programs that may be executed by users of the endpoint 2202, including both ordinary users and users with administrative privileges. The operating system kernel 2228 is the central part of the endpoint's 2202 operating system, and provides functions and processes that enable the user applications 2234 to access the endpoint's 2202 hardware.

In the illustrated example, the endpoint 2202 also includes a network interface 2222. The network interface 222 can be hardware and/or software that enable the endpoint 2202 to communicate with a network. Communication with a network can include communicating with the high-interaction network 2216.

The example endpoint 2202 of FIG. 22 also include an endpoint analytic engine 2226. An example operation of the endpoint analytic engine 2226 is illustrated in a detail view, and will be discussed further below.

The example deception mechanisms 2212a-2212c are hardware, software, or a combination of hardware and software configured to represent systems that are or can be found in the site network in which the endpoint 2202 is located. For example, one of the deception mechanisms 2212a-2212c can be configured as another endpoint, as a web server, as a database, as a remote desktop, as a shared directory, and so on. The hardware and/or software emulated by the deception mechanisms 2212a-2212c can be made to be attractive to a network threat. For example, the deception mechanisms 2212a-2212c can appear to include valuable data or resources, and/or can include vulnerabilities that may be attractive to exploitation. In some cases, some of the deception mechanisms 2212a-2212c can be physically or virtually located in the site network. In some cases, some of the deception mechanisms 2212a-2212c can be located in the high-interaction network 2216. The deception mechanisms 2212a-2212c are generally not part of the normal operation of the site network, meaning that legitimate users of the site network would not normally be accessing the deception mechanisms 2212a-2212c.

In various implementations, the data control center 2210 may monitor activity at the deception mechanisms 2212a-2212c and/or may receive data from the deception mechanisms 2212a-2212c. In various implementations, the data control center 2110 may be a central service for monitoring network security for the site network. In the illustrated example, monitoring network security includes watching for any accesses to the deception mechanisms 2212a-2212c. Because the deception mechanisms 2212a-2212c are not typically accessed during normal operation of the site network, any contact with the deception mechanisms 2212a-2212c is unexpected and should be investigated.

An unexpected access to a deception mechanism 2212a-2212c may come from the illustrated endpoint 2202. The endpoint 2202 can be configured with decoy data, such as for example decoy links to decoy shared directories, decoy log files that record previous FTP sessions with decoy IP addresses, decoy email addresses stored in an address book on the endpoint 2202, and so on. If the endpoint 2202 has been infiltrated, either by a local or remote infiltrator, the infiltrator may attempt to use the decoy data to move laterally to another system on the network, particularly if it appears that the other system has valuable data or resources. The decoy shared directories, decoy IP addresses, decoy email addresses, etc., however, can be configured to cause the infiltrator to move laterally to a deception mechanism 2212a-2212c.

In various implementations, the endpoint analytic engine 2226 can be configured to monitor the endpoint 2202, and redirect network traffic to and from the endpoint 2226 should it be determined that the endpoint 2202 has been compromised. FIG. 22 illustrates a detail view of an example of the operation of the endpoint analytic engine 2226. At step 2240, the endpoint analytic engine 2226 can monitor the endpoint 2202 to watch for possible infiltration or compromise of the endpoint 2202. For example, the endpoint analytic engine 2226 can be configured to detect whether decoy data on the endpoint 2202 has been touched or used. Alternatively or additionally, the endpoint analytic engine 2226 can be configured to detect privilege escalation on the endpoint 2202. In some implementations, upon detecting questionable activity, the endpoint analytic engine 2226 may immediately proceed to step 2242, and determine whether a threat has been detected. In some implementations, the endpoint analytic engine 2226 may alternatively or additionally periodically proceed to step 2242, to review the current state of the endpoint 2202.

When, at step 2242, the endpoint analytic engine 2226 determines that no threat has occurred, the endpoint analytic engine 2226 may return to step 2240. When, at step 2242, the endpoint analytic engine 2226 determines that a threat has occurred, the endpoint analytic engine 2226 may proceed to step 2244.

At step 2244, the endpoint analytic engine 2226 may wait for updated policies. In various implementations, policies can control the endpoints 2202 communications with a network. For example, policies defined for the endpoint 2202 can control local and remote network access, as well as network authentication and authorization rules and other access controls for the endpoint 2202. Policies can be used, for example, to forward some or all network packets received by the endpoint 2202 to the high-interaction network 2216. Conversely, network traffic from the high-interaction network 2216 can be forwarded through the endpoint 2202 to the Internet or some other location. Policies may also be referred to as access controls or access protocols.

In some implementations, the endpoint analytic engine 2226 may autonomously determine a new policy for the endpoint 2202. For example, the nature of the threat detected at 2242 may inform the endpoint analytic engine 2226 as to the new policy to implement. In some implementations, the endpoint analytic engine 2226 may wait for a new policy 2248 to be provided by the data control enter 2210.

As noted above, in some cases the threat detected at step 2242 can indicate that an infiltrator on the endpoint 2202 has attempted a lateral movement using decoy data, such that the movement landed on a deception mechanism 2212a-2212c. For example, the infiltrator may have accessed a decoy link to a shared directory that is hosted by a deception mechanism 2212a, resulting in SMB 2252 packets being sent to the deception mechanism 2212a. As another example, the infiltrator may have attempted to establish an FTP connection using an IP address that belongs to a deception mechanism 2212a, resulting in FTP 2254 packets being sent to the deception mechanism 2212a. As another example, the infiltrator may use a decoy email address, found on the endpoint 2202, to email malicious data. In this example, the decoy email address can be associated with a deception mechanism 2212a, so that the malicious data is email to the deception mechanism 2212a.

In these and other examples, when the deception mechanism 2212a receives the SMB 2252, FTP 2254, or other network traffic, the deception mechanism 2212a may inform the data control center 2210 that the deception mechanism 2212a has been accessed. The data control center 2210 may examine the nature of the access, and determine a new policy 2248 (or set of policies) for the endpoint 2202. For example, in some cases, the new policy 2248 may configure the endpoint 2202 to forward traffic for only certain protocols (e.g., SMB, FTP, or another protocol) to the high-interaction network 2216. As another example, the new policy 2248 can disable logins by legitimate users, so that the endpoint 2202 can be isolated from the site network.

Once the endpoint analytic engine 2226 has received the new policy 2248 from the data control center 2210, the endpoint analytic engine 2226 may, at step 2246 use the new policy 2248 to redirect some or all network traffic to or from the endpoint 2202. As discussed above, in some cases, the high-interaction network 2216 can be configured so that it appears that the endpoint 2202 is still in communication with the site network. Alternatively, the endpoint 2202 itself may be emulated in the high-interaction network 2216, so that the physical endpoint 2202 is no longer accessible to the infiltrator. In these and other examples, the behavior of the infiltrator can be analyzed using data collected in the high-interaction network 2216.

As discussed above, certain conditions at an endpoint may indicate that an infiltrator is attempting to gain access to the endpoint. Examples of conditions include privilege escalation, in which a user account or an application may gain higher access privileges than were assigned to the user account or application; use of decoy passwords, which were configured and made public to entrap infiltrators; installation of administrative tools for an illegitimate purpose; installation of other unauthorized tools such as password crackers and dumpers; and remote code execution, which may result in malware being installed on an endpoint, a user account gaining higher access privileges, or some other unwanted effect. Other conditions are possible and detectable, and these conditions are described here as examples of conditions that an endpoint analytic engine can detect. Once the endpoint analytic engine detects one of these conditions, the endpoint analytic engine may redirect network communications from the endpoint to a high-interaction network.

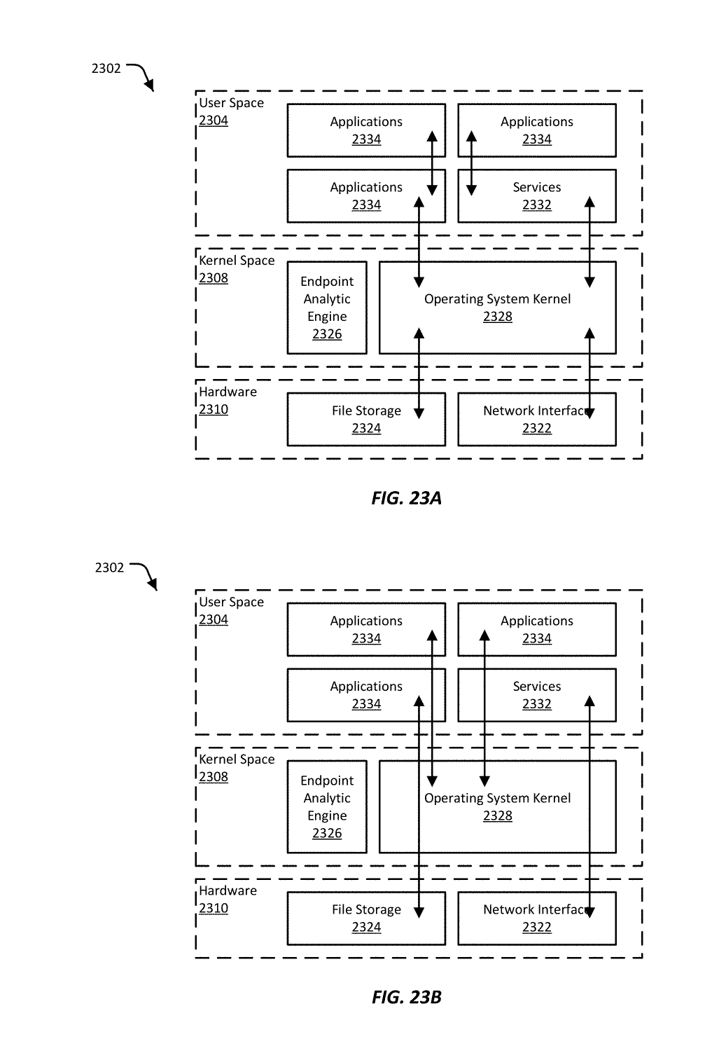

FIGS. 23A-23B illustrate an example of privilege escalation, which is one condition that may indicate an infiltration attempt at an endpoint 2302.

FIG. 23A illustrates an example of an endpoint 2302, and the privilege layers that the endpoint 2302 may include. An endpoint is a network device, such as a desktop computer, a laptop computer, a tablet computer, a personal digital assistant, a smart phone, some other hand-held computing device, a server, or some other computing system that has an operating system, is capable of executing user applications, and is connected to a network. An endpoint is typically configured with user space 2304 and kernel space 2308, each of which run on top of the endpoint's hardware 2310.

The user space 2304 is where applications 2334 run. Applications 2334 are the programs used by users of the endpoint 2302, and can include, for example, word processing, spreadsheet, presentation, email, and web browser programs, among many others. Services 2332 may also be running in the user space 2304. Services 2332 are programs that run in the background, and provide services for a user account and/or for applications 2334. For example, the endpoint 2302 may include services 2332 for managing background tasks, running a web server, configuring IP addresses for the endpoint 2302, listening to network connection requests, sending email, logging activity on the endpoint 2302, and so on. In some contexts, these services 2332 may be referred to as daemons.

In many cases, the user space 2304 may also define accounts for different users, with each account having a unique user space 2304. Alternatively or additionally, user accounts may share some of the user space 2304. For example, some applications 2334 may be used by multiple user accounts, and thus may reside in a shared area of the user space 2304. Generally, each user account has its own set of access privileges. Furthermore, generally one user account cannot access the files applications 2334 assigned to another user account unless the one user account has been granted access privileges to the other user account. In some cases, a user account can access applications 2334 and data in a shared area of the user space 2304, but is not allowed to make modifications (e.g., adding applications or deleting data) in the shared space. User accounts thus may provide a secure space, where each user of the endpoint 2302 can work without interference from other users.

The kernel space 2308 is where the endpoint's 2302 operating system runs. The operating system coordinates the operations of the endpoint 2302, including managing the execution of applications 2334, managing the activities of the hardware 2310, and providing the applications 2334 and services 2332 with access to the hardware 2310. The operating system kernel 2328 is the primary process for the operating system. In various implementations, an endpoint analytic engine 2326 may also be running in the kernel space 2308. As discussed above, the endpoint analytic engine 2326 may be monitoring the endpoint 2302 for conditions that indicate an infiltration or an attempted infiltration. In some implementations, the endpoint analytic engine 2326 is monitoring processes in the operating system kernel 2328, and hence runs in the kernel space 2308 to have sufficient access privileges. In some implementations, the endpoint analytic engine 2326 runs in the user space 2304, and monitors the activities of the applications 2334 and services 2332. In some implementations, the endpoint analytic engine 2326 runs in both the user space 2304 and the kernel space 2308.

The hardware 2310 includes the processor, memory, input devices, output devices, and other peripheral devices of the endpoint 2302. In the illustrated example, the endpoint 2302 includes at least a network interface 2322, for connecting the endpoint 2302 to a network, and file storage 2324, where data is stored. Typically, only the operating system has direct access to the hardware 2310. The operating system may provide an application programming interface that applications 2334 and services 2332 can use to access the hardware 2310. Operating system may further manage access to the hardware 2310, so that, for example, one application 2334 does not interfere with another application's 2334 access to some hardware, or so that an application 2334 does not misuse the hardware 2310.

The user space 2304 and the kernel space 2308 typically have different access privileges. Access privileges are rules that define, for example, which files can be accesses and/or modified by programs running in either user space 2304 or kernel space 2308, what code the programs can run, and/or how the programs can access the hardware 2310. For example, in the illustrated example, some applications 2334 can access services 2332 and other applications 2334, while some applications 2334 and services 2332 can access the operating system kernel 2328. Furthermore, only operating system kernel 2328 can access the hardware 2310. Access rules provide some fault tolerance and security, meaning that wayward programs cannot accidentally or intentionally disrupt the normal operation of the endpoint 2302 by making changes to files or running processes. Access privileges are typically also assigned to each user account configured for the endpoint 2302, so that some accounts may have higher access privileges than others.

One method for defining access privileges is to designate a part of the endpoint's 2302 memory as the user space 2304 and another part as the kernel space 2308. Applications 2334 and services 2332 running in the memory designated as user space 2304 are mostly free to create, access, and modify files and to run code, but have very restricted access to the memory designated as kernel space 2308. Often, applications 2334 running in user space 2304 cannot create, access, or modify files in the kernel space 2308 without placing a request with the operating system kernel 2328, which can then control the execution of the request. This prevents user applications 2334 and user-level services 2332 from, for example, making modifications to the operating system code or from accessing files that belong to a different user account.

Some user accounts have administrative privileges. Administrative accounts, or “admin” accounts, may be used to maintain the endpoint 2302. Generally, administrative accounts have full access privileges, and are able to access the user space 2304, kernel space 2308, and also the hardware 2310. A user logged into an administrative account thus can, for example, install new applications 2334, start and/or stopping services 2332, upgrade the operating system, install new hardware 2310, and so on.

FIG. 23B illustrates an example of the effect of privilege escalation. Privilege escalation describes exploitation of, for example, an error the code of an application 2234 or the operating system, a design flaw in an application 2234 or in the operating system, or an assumption made by the writers of an application 2234 or the operating system that can be taken advantage of. By exploiting one of these flaws, a user account or an application may gain higher access privileges than had been assigned to the user account or application. As a result of privilege escalation, a user account or application may be able to access resources on the endpoint that are not normally available to the user account or application. For example, privilege escalation may result in an application 2234 having direct access to the File Storage 2224, and being able to access files that are otherwise not accessible to the application 2234. As another example, an application 2234 may obtain kernel-level functionality, and be able to install malware, delete files, and/or view private information in user accounts.

Privilege escalation typically involves exploiting a flaw in an application 2234 or the operating system, or a mistaken assumption about how the applications 2234 or operating system will be used. For example, service 2232, such as a screen saver, that runs in use space 2204 may have been configured to run in an administrative account. In this example, a user account may be able to replace the code for the screen saver, thus allowing the user account to run under the access privileges of the administrative account. As another example, remote code execution, which is described in more detail below, can occur when a program experiences an error, and the error is not handled correctly, allowing malicious code to be executed.

Privilege escalation can also occur by obtaining the security tokens of the endpoint's 2202 legitimate users. A security token authenticates a user on the endpoint 2202, and may be used in addition to or instead of an account password. Security tokens may be physical devices or software, which may be stolen or copied, respectively. Types of physical security tokens include, for example, Universal Serial Bus (USB) keys, smart cards, key fobs, and other small, electronic devices. Software tokens are code that may be stored on a desktop computer, laptop computer, or a mobile phone, among others. Generally, security tokens do not necessarily automatically authenticate a user, but rather provide a cryptographic key that can only be used one time. The endpoint 2202 may have software that is able to generate a matching key, and when the keys match, the user is authenticated.

Privilege escalation can be detected in a number of ways. For example, the endpoint analytic engine 2226 may monitor access control lists. Access control lists may be used by the operating system to determine the access privileges for a user account or an application 2234. A change in an access control list, particularly one that increases the privileges associated with a user account or an application 2234, may indicate an incident of privilege escalation. As another example, the endpoint analytic engine 2226 may watch for suspect use of security tokens. For example, a security token may be assigned to a specific endpoint 2202, such that use of a security token on a different endpoint 2202 is suspect. As another example, the endpoint analytic engine 2226 may monitor the process tree for an application, and be able to determine that remote code execution has taken place. Remote code execution may be indicated by a user-level process moving into kernel-level access unexpectedly. Once the endpoint analytic engine 2226 detects one of these conditions, the endpoint analytic engine 2226 may cause the endpoint's 2202 network communications to be redirected to a high-interaction network.

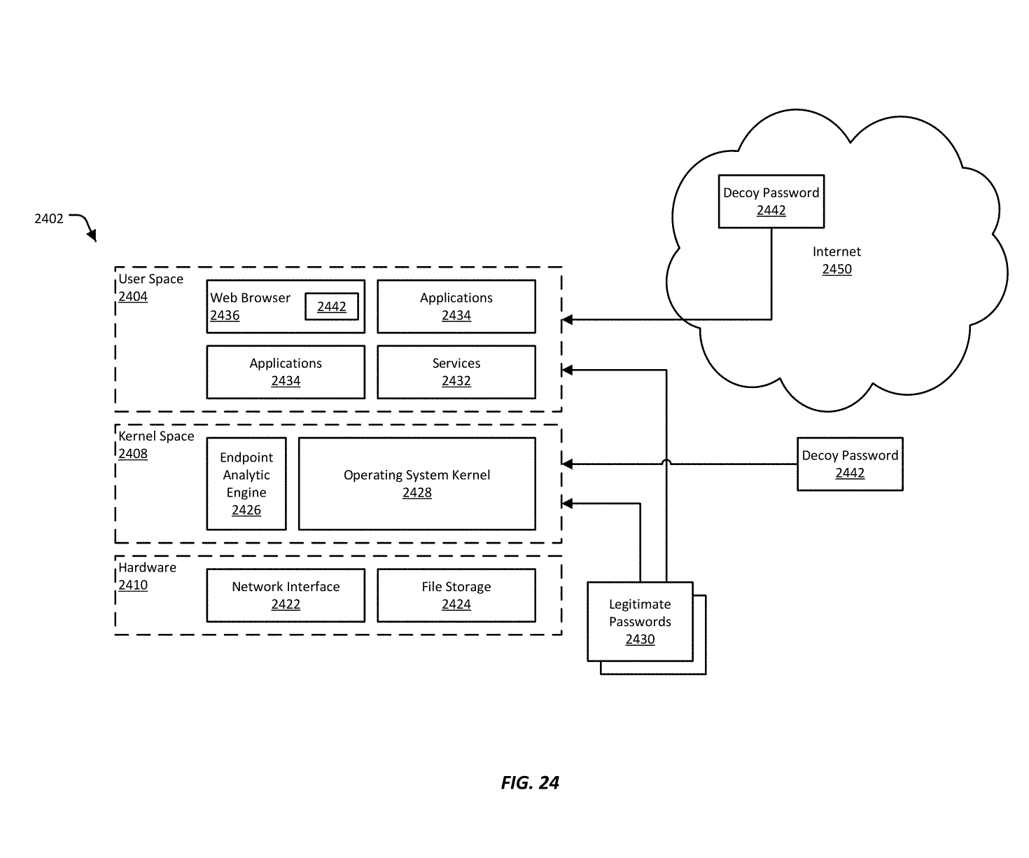

FIG. 24 illustrates an example of use of decoy passwords 2442, which is another condition that may indicate infiltration or attempted infiltration of an endpoint 2402. A decoy password is a password for a user account that was specifically set up to be found and be attractive to a potential infiltrator.

In some implementations, a decoy password 2442 may be stored in an application used to log into user accounts. For example, a web browser 2436 may be configured to store usernames and passwords when a user logs into websites. Alternatively or additionally, the web browser 2436 may store or cache security credentials, so that the user does not need to log in every time she visits the particular website that is associated with the security credentials. Alternatively or additionally, the endpoint 2402 may have an application that stores passwords for a user for various websites and/or applications 2434 on the endpoint 2402. Continuing the example, web browser 2436 (or password storage application) can be configured with a decoy password 2442, along with a username and the address of the website that the username and decoy password 2442 are associated with. At least some of this information, such as the decoy password 2442, is typically encrypted, but an infiltrator on the endpoint 2402 may be able to determine at least that the web browser 2436 has stored login information for a particular website address. While the address may be for a real website, the username and decoy password 2442 in most cases are not associated with a real user account on that website. Furthermore, when the infiltrator visits the particular website, assuming that the web browser 2436 will automatically log him into a user's account, the endpoint 2402 may instead by connected to a high-interaction network. The high-interaction network may be configured to emulate the particular website, so that the infiltrator believes he has gained access to a user's account.

In some implementations, a decoy password 2442 may be configured for a user account that is used to access the endpoint 2402. In these implementations, the decoy passwords 2442 can be deliberately published, for example, on social media sites or hacking forums. The user accounts associated with the decoy passwords are configured just as are any other user accounts, but are not used by any user of the endpoint 2402. Thus any attempt to log in using one of these user accounts is automatically suspect.

The illustrated endpoint 2402 may be configured with ordinary user accounts that can be logged into using legitimate passwords 2430. The endpoint 2402 may be configured with a user space 2404, where user applications 2434 and services 2432 run. The endpoint 2402 may also be configured with a kernel space 2408, where the operating system kernel 2428 runs. An endpoint analytic engine 2426 may also be running in the kernel space 2408. The endpoint analytic engine 2426 may monitor the endpoint 2402 for suspect accesses, including use of decoy passwords 2442. The endpoint 2402 may further have hardware 2410, including at least a network interface 2422 for connecting to a network, and file storage 2424, where data may be stored.

The endpoint 2402 may be configured with legitimate passwords 2430, for legitimate user accounts. Some legitimate user accounts may be configured for regular users of the endpoint 2402. These user accounts provide access to the user space 2404 and application 2434 and services 2432 that run in the user space 2404. Some legitimate user accounts may be configured for administrative users. These administrative accounts provide access to the kernel space 2408, and typically also to the user space 2404.

Decoy passwords 2442 can be configured for both user accounts and administrative accounts. The endpoint analytic engine 2426 may monitor the endpoint 2402 for use of any decoy password 2442. Decoy passwords 2442 may be used by a person with physical access to the endpoint 2402. Decoy passwords 2442 may be used by an entity located somewhere on the Internet 2450 who is attempting to gain access to the endpoint 2402 over the endpoint's 2402 network connection. Decoy passwords 2442 may be used to gain access to the endpoint 2402. Alternatively or additionally, decoy passwords 2442 may be used to gain access to a specific application 2434, service 2432, or web site. Once the endpoint analytic engine 2426 detects one of these uses, the endpoint analytic engine 2426 may signal that the endpoint's 2402 network communications should be redirected to a high-interaction network.

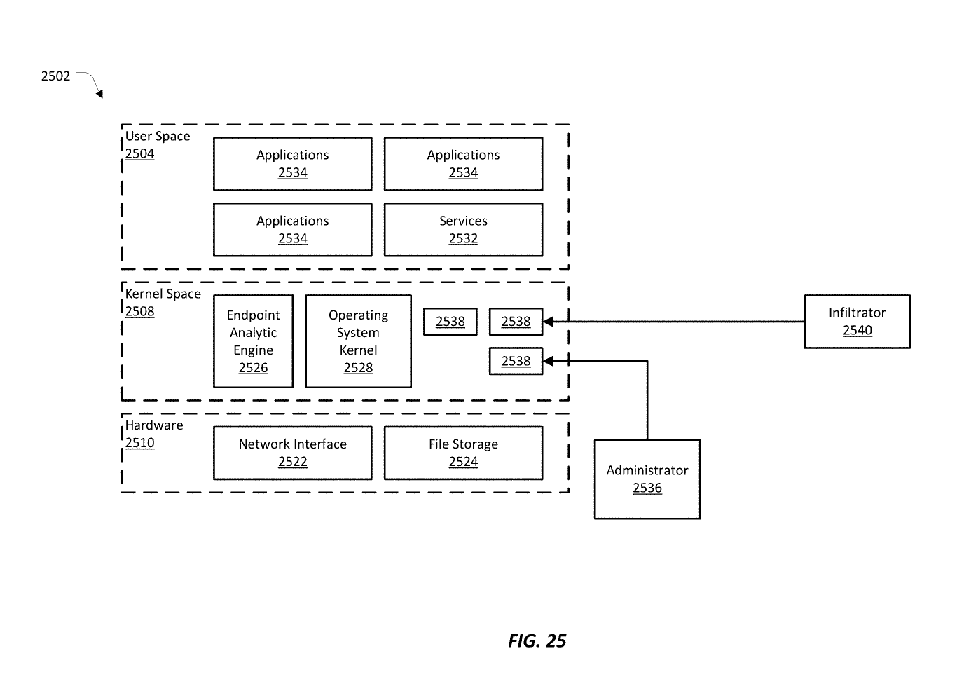

FIG. 25 illustrates installation of administrative tools 2538, another condition which may indicate infiltration or attempted infiltration of an endpoint 2502. Administrative tools are software programs that may be legitimately used by an administrator 2536 for the maintenance of the endpoint 2502. Examples of administrative tools 2538 include remote access tools and password cracking tools, among others. Administrative tools 2538 may be designed to circumvent security measures. Forgotten passwords, operating system errors, viruses, and other problems may make the endpoint 2502 inaccessible to even an administrative account. Administrative tools 2538 thus provide ways for administrators to gain access to the endpoint 2502. But while administrative tools 2538 may be used for legitimate purposes, they can also be taken advantage of by an infiltrator 2540.

An administrator 2536 may install administrative tools 2538 on the endpoint 2502, where the administrative tools 2538 have access to kernel space 2508. The endpoint 2502 may be configured with a user space 2504, where user applications 2534 and services 2532 run. The endpoint 2502 may also be configured with a kernel space 2508, where the operating system kernel 2528 runs. An endpoint analytic engine 2526 may also be running in the kernel space 2508. The endpoint analytic engine 2526 may monitor the endpoint 2502 for suspect accesses, including installation of administrative tools 2538. The endpoint 2502 may further have hardware 2510, including at least a network interface 2522 for connecting to a network, and file storage 2524, where data may be stored.

An infiltrator 2540 may also attempt to install administrative tools 2538 on the endpoint 2502. In this context, the administrative tools 2538 are unauthorized, in that the tools were not installed by an administrator 2536 or other individual with the authority to install such tools. In other examples unauthorized tools can also include password dumping tools, password scraping tools, reconnaissance tools, keyboard loggers, and so on.

The endpoint analytic engine 2526 may monitor the endpoint 2502 for installation of files that may be identified as associated with administrative tools 2538 or other unauthorized tools. For example, the endpoint analytic engine 2526 may be configured with digital signatures for commonly used administrative tools 2538 and/or known hacking tools. A digital signature is a unique numeric or alphanumeric identifier for a file. A digital signature may be generated, for example, by applying the MD5 algorithm, Secure Hash Algorithm 1 (SHA-1), or SHA-2 to a file. When a tool is installed on the endpoint 2502, the endpoint analytic engine 2526 can generate a digital signature for any file or files used to install the tool or installed with the tool. The endpoint analytic engine 2526 can further compare the generated digital signature against lists of digital signatures for unauthorized tools.

Alternatively or additionally, the endpoint analytic engine 2526 can attempt to identify a source of the installation, and validate whether the source is authorized to install the administrative tool 2538. For example, the infiltrator 2540 may introduce an administrative tool 2538 by through an email downloaded to the endpoint 2502, through a protocol for sharing files between endpoints 2502, such as Server Message Block (SMB), through web cookies, by having the file downloaded from a website, through a USB drive plugged into the endpoint 2502, or some other method. Alternatively or additionally, the infiltrator 2540 may be using an unauthorized account or a hacked account to obtain access to the endpoint 2502. In these and other examples, the endpoint analytic engine 2526 may determine that the administrative tool 2538 was not installed by an authorized administrator 2536.

The endpoint analytic engine 2526 may monitor for installation of a file associated with an administrative tool 2538, and upon detecting that an administrative tool 2538 has been installed, may cause network communications for the endpoint 2502 to be redirected to a high-interaction network. A legitimate administrator 2536 of the endpoint 2502 would be aware that the endpoint analytic engine 2526 is running on the endpoint 2502. The administrator 2536 thus would disable the endpoint analytic engine 2526 prior to installing an administrative tool 2538 for a legitimate purpose. Alternatively or additionally, the endpoint analytic engine 2526 may be configured to send alerts to an administrative account when it detects installation of an administrative tool 2538. These alerts may inform the administrator 2536 that she needs to disable the endpoint analytic engine 2526, and/or that endpoint's 2502 network communications have been redirected to the high-interaction network.

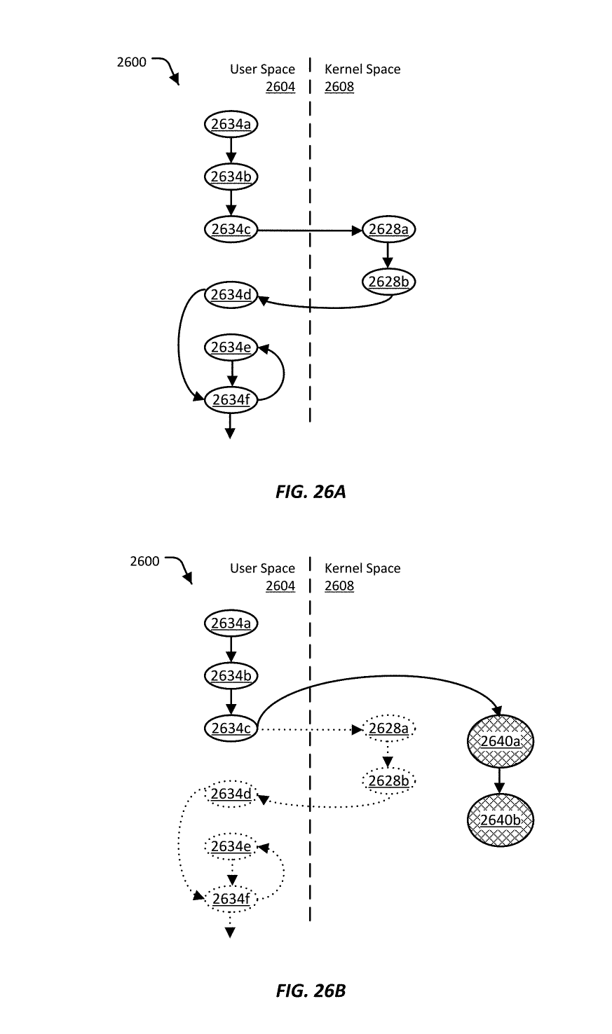

FIG. 26A-26B illustrate an example of remote code execution, which is another condition which may indicate that an infiltrator is attempting to gain access to an endpoint. Remote execution describes exploitation of a vulnerability in an application that allows malicious code to hijack the normal execution flow of the application. The malicious code could disrupt the operation of the endpoint, and/or may give the infiltrator escalated access privileges to the endpoint.

FIG. 26A illustrates a flow of execution 2600 for an application. The application may be, for example, a document reader. During the normal flow of execution 2600, the application may execute some steps 2634a-c. Being a user application, these steps 2634a-c are executed in user space 2604. Upon reaching step 2634c, the application may experience an error. The flow of execution 2600 may at this point jump to kernel space 2608, where steps 2628a-b in an error handling process takes care of the error. Once the error is managed, the execution flow 2600 may then return to the steps of the application 2634d-f in user space 2604. The application may then continue executing, including making jumps, loops, and decisions.

FIG. 26B illustrates how the normal flow of execution 2600 can be taken over by remotely executing code. In this example, the document reader application may have a flaw (that is, a bug). For example, a document being opened by the application may have a large amount of hidden bad data in it. When the document is opened, the bad data may cause some kind of overflow error in the application, possibly causing the application to crash. Due to a bug in the application, however, instead of jumping to the error handling steps 2628a-b in the operating system kernel, the execution flow 2600 jumps to other code 2640a-b, masquerading as the error handling process.

Because this other code 2640a-b is executing in place of the error handling steps 2628a-b, this other code 2640a-b may be executing in kernel space 2608, and thus may have broad access to do harm. For example, the other code 2640a-b may be a virus intent on crashing the endpoint. As another example, the other code 2640a-b may be configured to open ports on the endpoint or to remove security barriers. As another example, the other code 2640a-b may be designed to locate and steal password files. As another example, the other code 2640a-b may rewrite access privileges, and provide user accounts with administrative privileges.

The file that cause the other code 2640a-b to launch may be placed on an endpoint in a number of innocent ways. For example, the file may have been sent through email, may have been copied from files shared through SMB, may have been downloaded from a website, or may have been copied from a USB drive. The other code 2640a-b may have been part of the file. For example, the other code 2640a-b may have been a script embedded and hidden in the file. Alternatively or additionally, the other code 2640a-b may have been placed on the endpoint separately, attached to an email, downloaded from the Internet, or copied from a USB drive. The file and/or the other code 2640a-b may have been placed on the endpoint by an innocent, legitimate user, without awareness as to the nature of the files or code 2640a-b. Additionally, a legitimate user, by opening the file, may have triggered the infiltration attempt.

FIGS. 23A-23B, 24, 25, and 26A-26B provide examples of conditions that indicate that an infiltrator is attempting to gain access to an endpoint. In the attempt, the infiltrator can be directed away from the endpoint's site network, and possibly also away from the endpoint itself, as discussed above. Once an infiltrator has gained access to an endpoint, the infiltrator can also be detected, and be redirected to a high-interaction network. In various implementations, the endpoint can be configured with decoy data that may appear attractive to an infiltrator, but which redirects the infiltrator to the high-interaction network.

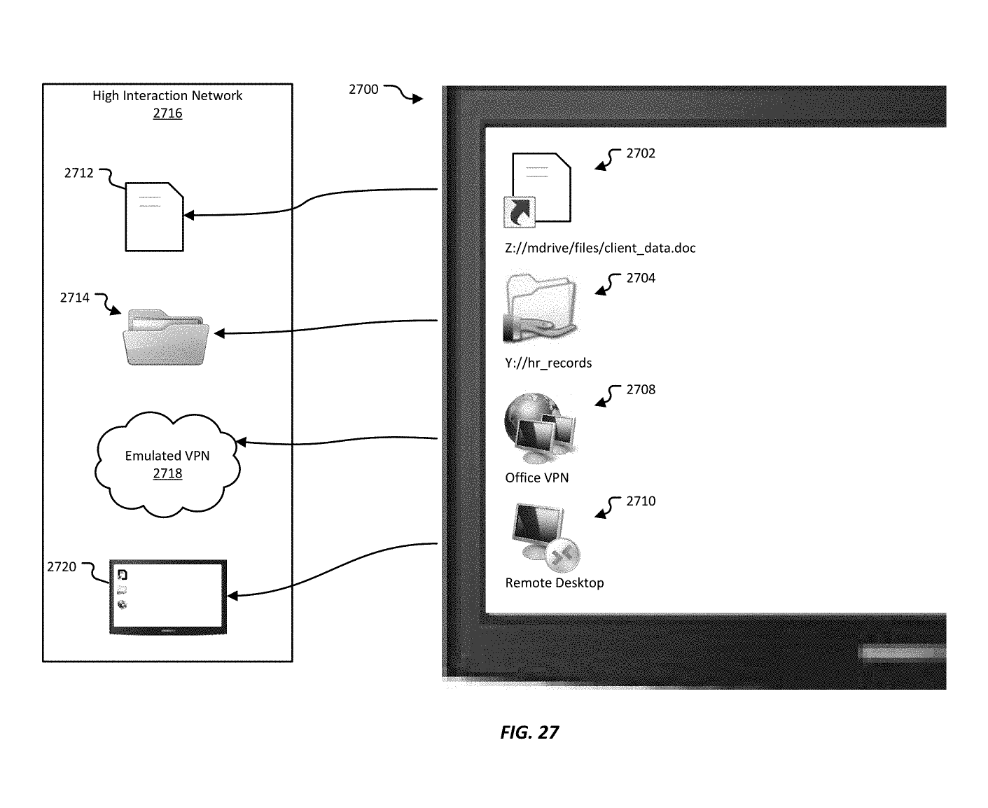

FIG. 27 illustrates several examples of decoy data 2702, 2704, 2708, 2710 that can be configured on an endpoint. In this example, the decoy data 2702, 2704, 2708, 2710 could be placed on the endpoint's “desktop” 2700, that is, the graphical user interface provided by the operating system for interfacing with the endpoint. Thus an infiltrator with access to the endpoint may see the decoy data 2702, 2704, 2708, 2710. The decoy data 2702, 2704, 2708, 2710 may also be visible to an infiltrator that has access only to the file system on the endpoint, such as for example an infiltrator who has gained access to the endpoint remotely, through the endpoint's network connection. Legitimate users of the endpoint may also see the decoy data 2702, 2704, 2708, 2710, but could be informed that the decoy data 2702, 2704, 2708, 2710 is not real data. The examples of FIG. 27 illustrate three types of decoy data: a linked file 2702, a shared directory 2704, a VPN shortcut 2708, and a shortcut for a remote desktop 2710.

Most operating systems provide a way to create a symbolic link to a file. The file itself may be located in one directory on an endpoint or on a network. The link, which may itself be a small file or a placeholder, may be located in another directory, and store only a reference or a pointer to the file. Opening the link opens the file that is referenced by the link. Symbolic links can typically also be made to directories and applications. Opening a link to a directory opens the directory, and opening a link to an application may launch the application.

In this example, a decoy link 2702 to a file has been added to the desktop 2700 of an endpoint. The decoy link 2702 may be made to look as if it links to a legitimate file with valuable data. For example, the decoy link 2702 may be made to look like it points to a file called “client_data.doc”. The path, or directory hierarchy that leads to the file, can also be made to look like a path that would be found on the endpoint or on a network drive. In reality, however, the decoy link 2702 would link to file 2712 in a high-interaction network 2716. Thus when an infiltrator opens the decoy link 2702, the infiltrator is, in fact, opening the file 2712 in the high-interaction network 2716. The file 2712 may contain authentic-looking data, to further fool the infiltrator. The high-interaction network 2716 may subsequently monitor the infiltrator's activity with respect to the file 2712, and attempt to determine the infiltrator's intentions.

In this example, the endpoint has also been configured with a decoy shared directory 2704. A shared directory is a special directory that some operating systems provide so that different user accounts can share files. Typically, a shared directory is visible from all user accounts that belong to a specific group, or possibly to all user accounts within an organization. Files placed within a shared directory are thus also visible to all user accounts that have access to the shared directory.

The decoy shared directory 2704 in this example has been configured so that it appears to be associated with a user account that has valuable information. For example, here the decoy shared directory 2704 appears to be for an “hr_records” account. In reality, however, the shared directory may be associated with a directory 2714 in the high-interaction network 2716. Thus, when an infiltrator opens the shared directory 2704, the infiltrator is, in fact, opening the directory 2714 in the high-interaction network 2716. The directory 2714 in the high-interaction network 2716 may be configured with files that look both real and valuable. The high-interaction network 2716 may be configured to monitor whether the infiltrator accesses these files, and/or what the infiltrator does with them.

The examples of FIG. 27 also include a decoy shortcut to a Virtual Private Network (VPN) 2708. A shortcut is a term used by some operating systems to describe a symbolic link. In this example, the endpoint has been configured with a shortcut to an application that automatically logs a user into a VPN. A VPN is a private network within another network. For example, a company may configure a VPN that is accessible over public networks, such as the Internet. In most cases, a user must log into a VPN to be able to access it. Network owners may configure one or more VPNs for their network so that network users can access the network securely and easily. VPNs may be particularly useful when network users are remote from the network, and must access the network over public networks. Network owners can also configure VPNs that are accessible from within the network to provide, for example, a private space for a group of users.

In FIG. 27, the endpoint has been configured with a decoy VPN shortcut 2708. The decoy VPN shortcut 2708 appears to be a link to a legitimate VPN. Opening the decoy VPN shortcut 2708 may cause an application to launch, where the application appears to be logging the user into the VPN, including possibly requesting login credentials. In reality, however, the decoy VPN shortcut 2708 logs the user into an emulated VPN 2718 located within the high-interaction network 2716. The emulated VPN 2718 may be configured to resemble a real VPN for a site network, with servers, network connections, and data that may be found in the site network. The high-interaction network 2716 may be configured to monitor any activity within the emulated VPN 2718. Monitoring activity in the emulated VPN 2718 may provide useful information about the infiltrator and/or about vulnerabilities in a site's network.

The examples of FIG. 27 also include a decoy shortcut to a remote desktop application 2710. A remote desktop application is a program that allows a user to connect to a graphical interface running on another computer, and, usually, use the computer through the graphical interface. In many cases, the graphical interface running on the other computer is the same desktop application provided when a user has direct access to the other computer. Examples of remote desktop protocols include Virtual Network Computing (VNC), Remote Desktop Protocol (RDP), and Remote Framebuffer (RFB), among others.

In this example, a shortcut to a remote desktop application 2710 has been added to the desktop 2700. The remote desktop shortcut 2710 has been configured so that, when it is opened and launched, it appears to log an infiltrator into a remote desktop running on a computer in the site network. In reality, however, the remote desktop shortcut 2710 will log the infiltrator into a remote desktop 2720 running in the high-interaction network 2716. The remote desktop 2720 in the high-interaction network 2716 may be configured as if it is running on a computer that may be found in site network, including apparently providing access to files, hardware resources, and network resources. Furthermore, the remote desktop 2720 may appear to provide network connections to servers that could be found in the site network. Thus the infiltrator may be lead to believe that he has access to a real user's remote desktop, when, in fact, the infiltrator's activity with respect to the remote desktop 2720 is being monitored by the high-interaction network 2716.

As discussed, the decoy data 2702, 2704, 2708, 2710 may redirect an infiltrator's activity to the high-interaction network 2716. Detecting an access to the decoy data 2702, 2704, 2708, 2710 may also trigger isolation of the endpoint from a site network. For example, once an access to the decoy data 2702, 2704, 2708, 2710 is detected, further network communication between the endpoint and the site network may be redirected to the high-interaction network 2716. In some implementations, the endpoint may have already been isolated. For example, the endpoint's network communications may have been redirected when the infiltrator gained access to the endpoint. Otherwise, an access to the decoy data 2702, 2704, 2708, 2710 may also be a condition used to determine that the endpoint should be isolated.

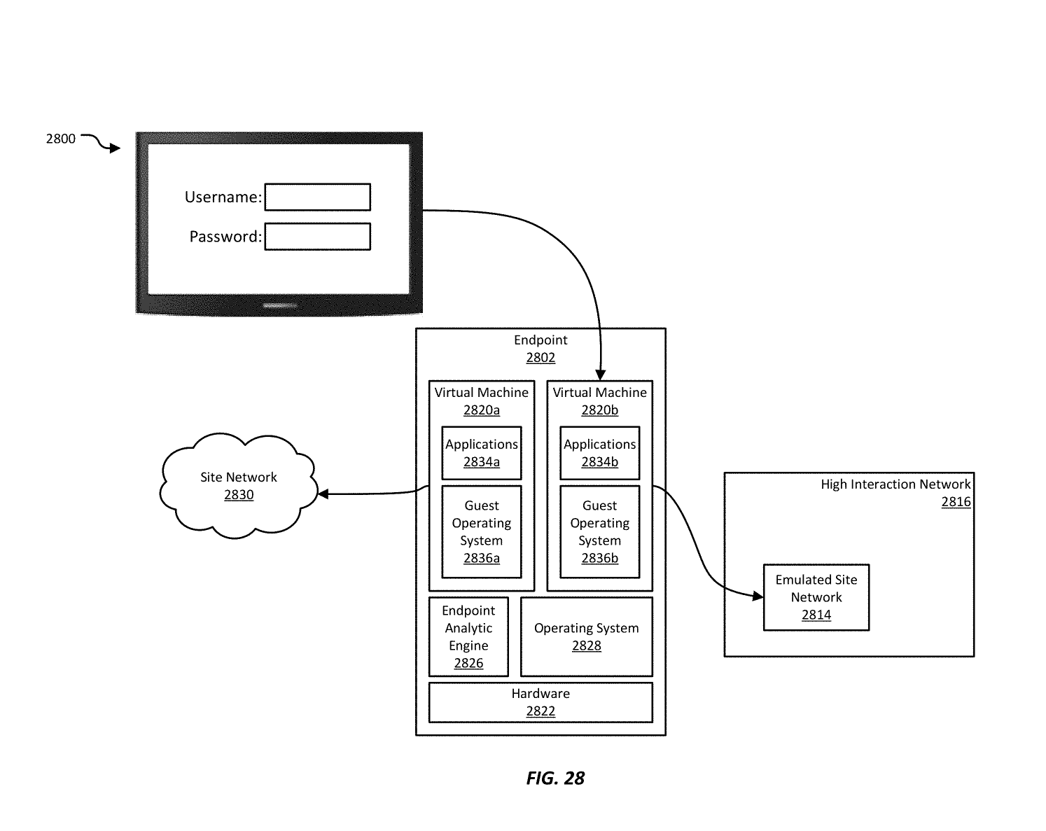

FIG. 28 illustrates another example of an endpoint 2802 configured with decoy data. In this example, the decoy data is in the form of an application, specifically, a virtual machine 2820b application. A virtual machine is an emulated computer running on the hardware of a real, physical computer. The virtual machine typically has its own operating system 2836a-b and user applications 2834a-b, and represents some virtual hardware resources to a user. These virtual hardware resources may be the same as or different from the physical hardware 2822 of the computer that the virtual machine is running on. The computer that is supporting a virtual machine typically has its own operating system 2828, and may have additional software and/or hardware to manage the virtual machines running on the computer.

The endpoint 2802 in this example may also include an endpoint analytic engine 2826. The endpoint analytic engine 2826 may be configured to monitor user log-ins 2800 into the endpoint 2802. For example, the endpoint analytic engine 2826 may be configured to match usernames and passwords against lists of legitimate users and lists of decoy user accounts and passwords.

The endpoint 2802 in this example may be configured with several virtual machines 2820a-b. One virtual machine 2820a may be configured to connect to a site network 2830. When a normal, legitimate user of the endpoint 2802 logs in 2800 to the endpoint 2802, the endpoint analytic engine 2826 may log the user into the first virtual machine 2802a. Legitimate users thus are provided with normal access to the site network 2830.

A second virtual machine 2820b may be configured to connect to a high-interaction network 2816 instead of the site network 2830. When an infiltrator logs into 2800 the endpoint 2802 using, for example, a decoy or stolen password, or a stolen or copied security token, the endpoint analytic engine 2826 may log the infiltrator into the second virtual machine 2820. The second virtual machine 2820b may be configured with the operating system 2836b, applications 2834b, and hardware 2822 resources that may be found on the endpoint 2802, so that the infiltrator may be lead to believe that he has logged into the endpoint 2802. The second virtual machine 2820b, however, does not communicate with the site network 2830, but rather with an emulated site network 2814 in the high-interaction network 2816. The emulated site network 2814 may give the infiltrator the illusion that he is able to communicate with the site network 2830. The high-interaction network 2816, however, may be monitoring his activity in the emulated site network 2814. The infiltrator's methods and intent may thus possibly be determined.

In some implementations, when the endpoint analytic engine 2826 determines that an infiltrator has logged into 2800 the endpoint 2802, the endpoint analytic engine 2826 may cause the endpoint 2802 to be isolated from the site network 2830. In some implementations, however, this may not be necessary, since the virtual machines 2820a-b provide some containment for the infiltrator's activity.

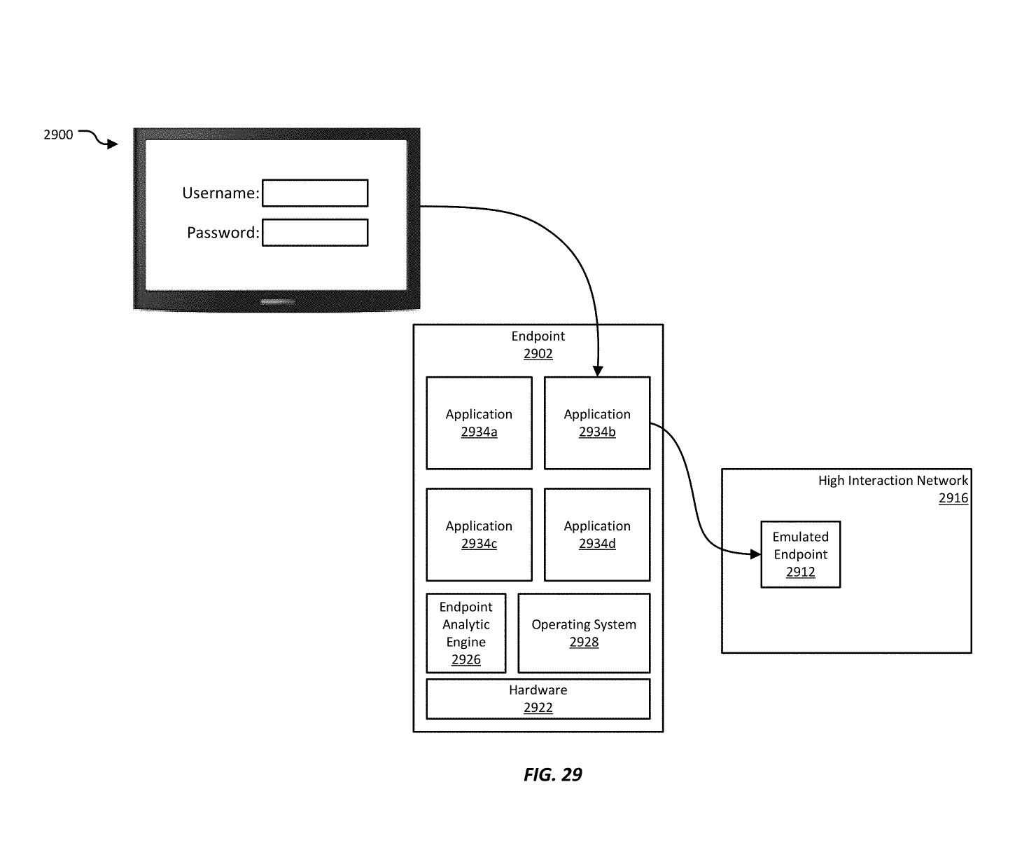

FIG. 29 illustrates another example of configuring decoy data to redirect an infiltrator as the infiltrator logs into 2900 an endpoint 2902. The endpoint 2902 in this example may be running a number of applications 2934a-d, as well as an operating system 2928 and an endpoint analytic engine 2926. The applications 2934a-d and operating system 2928 may be supported by the endpoint's 2902 hardware 2922.

One application 2934b on the endpoint 2902 may be a Virtual Network Computing (VNC) client, or something similar, such as Remote Desktop Protocol (RDP), Remote Framebuffer (RFB), or the like. VNC provides a framework in which a user can configure a virtual desktop on one computing system, and access this virtual desktop from another computing system. VNC implementations typically provide a graphic desktop similar to the desktop provided by an operating system. Thus a user may be able to interact with a running VNC session as if the user is interacting with a computer the user has physical access to.

The VNC client application 2934b may be configured as decoy data, to divert an infiltrator of the endpoint 2902. The endpoint analytic engine 2926 may be configured to monitor log-ins 2900 into the endpoint 2902. When a normal, legitimate user logs into 2900 the endpoint 2902, the user may be logged into the endpoint 2902, and have normal access to the endpoint's 2902 application s 2934a-d and hardware 2922. When an infiltrator logs into 2900 the endpoint 2902, for example using a decoy or stolen password, or a stolen or copied security key, the endpoint analytic engine 2926 may launch the VNC client application 2943b. The VNC client application 2943b may be configured to connect to an emulated endpoint 2912 in a high-interaction network 2916. The emulated endpoint 2912 may resemble the endpoint 2902 in all aspects, and thus may fool the infiltrator into believing that he has logged into the endpoint 2902. The infiltrator, however, never logs into the endpoint 2902, and all his activity relative to the emulated endpoint 2912 may be monitored by the high-interaction network 2916. In this way, the endpoint 2902, and a site network the endpoint may be connected to, may be protected from the infiltration.

In some implementations, when the endpoint analytic engine 2926 detects that an infiltration attempt using, for example, a decoy or stolen password, the endpoint analytic engine 2926 may also cause the endpoint 2902 to be isolated from a site network. In some implementations, however, this may not be necessary, since the VNC client application 2943b may isolate the infiltrator from the endpoint 2902, and thus also from the site network.

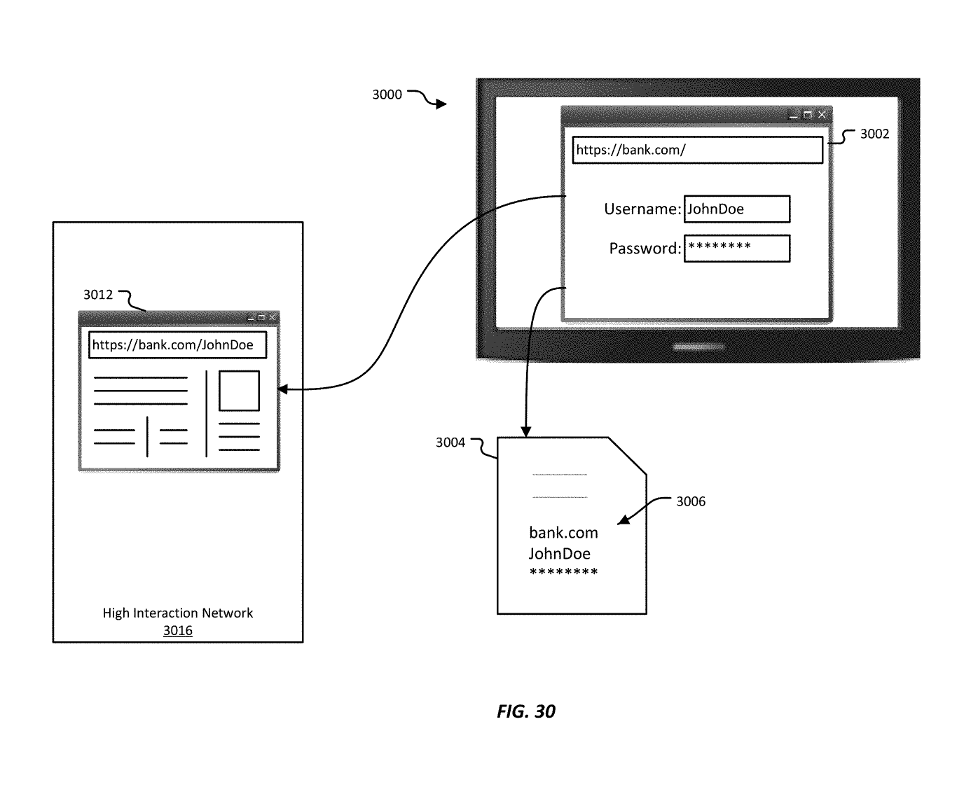

FIG. 30 illustrates another example of a way in which decoy data can be configured for an endpoint. The example of FIG. 30 uses the data 3004 that may be stored by web browsers 3002 and other applications. Web browsers 3002 often store data 3004 as users visit websites, so that visiting these websites in the future may be both faster and more convenient for the user. The website-related data 3004 is typically stored in an area often referred to as a cache. The data 3004 may store, for example, information for webpages that have been visited such as graphics and other content, and/or information entered by a user into the webpages. The data 3004 may also store a user's log-in credentials for a particular website, including a username, password, and the address of website. When the user visits this particular website, the web browser 3002 may use the stored username and password to automatically log the user into the site. Alternatively, the web browser 3002 may use the stored information to automatically fill in the user's login credentials when the user visits the particular website. Other applications may also store a user's log-in credentials, so that the user is automatically logged in when the user launches the application. Alternatively or additionally, other applications may store a user's log-in credentials to automatically connect the user to related services on the Internet.

In this example, the web browser's 3002 cached data 3004 has been modified to include decoy login credentials 3006. The decoy login credentials 3006 include a decoy username, a decoy password, and the address (e.g. a Uniform Resource Locator (URL) and/or an IP address) of a website. The decoy username and decoy password may resemble a real user's credentials, and/or may be encrypted as would a real user's credentials. In some implementations, the website's address may be for a real website, particularly a website that may have valuable information, such as a banking website. In some implementations, legitimate users of the endpoint may be told that they cannot visit the website used for the decoy login credentials 3006. Alternatively or additionally, the website chosen may be one that legitimate users of the endpoint are not likely to visit. Alternatively or additionally, the cached data 3004 may include information (e.g., a domain name) that associates the website address with a real website, while the website address is, in fact, for a website 3012 hosted by a high-interaction network 3016.

An infiltrator who has access to the endpoint's desktop 3000 may, while exploring the endpoint, come across the web browser's 3002 cached data 3004, and see the decoy login credentials 3006. Though the decoy username and/or decoy password, may be encrypted, the infiltrator may at least see the associated website address. Believing the decoy login credentials 3006 to be legitimate, the infiltrator may visit the website. The web browser 3002 may appear to log the infiltrator into the website, but in fact logs the infiltrator into a website 3012 hosted by the high-interaction network 3016. The website 3012 in the high-interaction network 3016 may be configured to resemble a real website, including having the domain name, webpages, and data that may be found at the website. The infiltrator may thus be encouraged to explore the website 3012 and steal data. Because the website 3012 is running in the high-interaction network 3016, however, the infiltrator's activities inside the website 3012 may be captured and analyzed.

In some implementations, visiting the website associated with the decoy credentials 3006 may be a condition that causes the endpoint to be isolated. Isolating the endpoint means that network communications between the endpoint and a site network may be redirected to the high-interaction network 3016. Isolating the endpoint in this way, the site network may be protected from activity by the infiltrator.

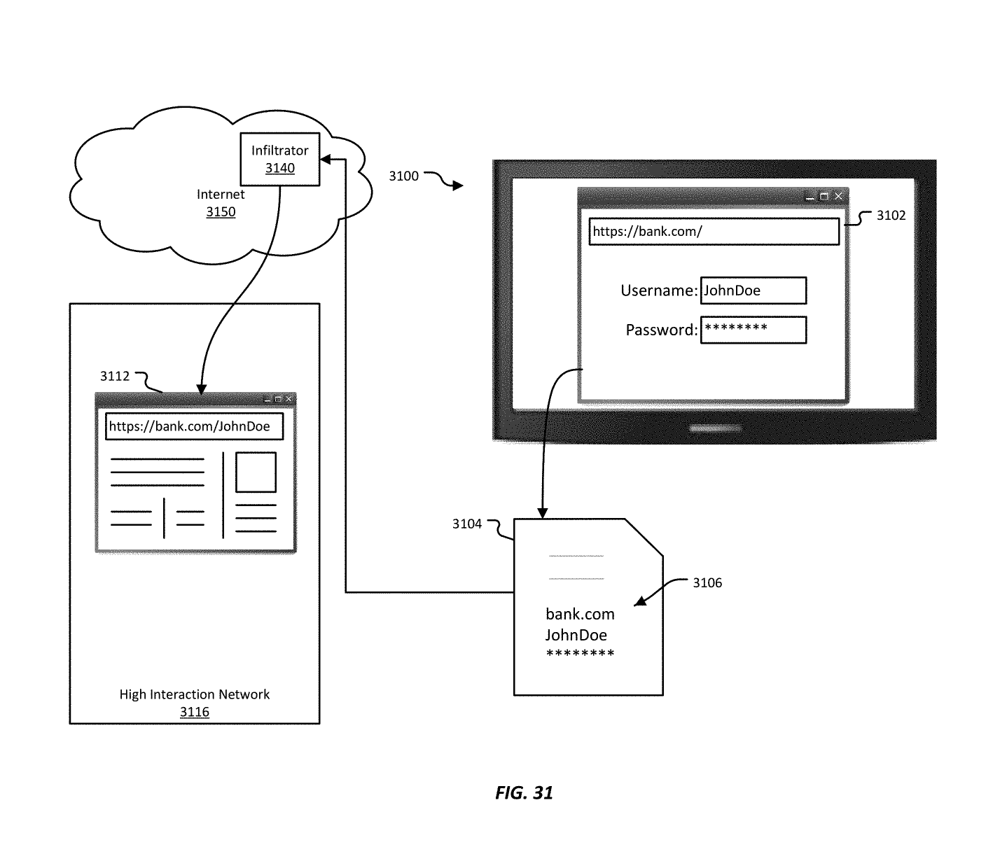

FIG. 31 illustrates another example of using an application's stored data as decoy data. In this example, decoy login credentials 3006 have been added to the data 3004 that is stored by a web browser application 3002. As discussed above, web browsers 3002 typically store data 3004 for websites that users visit. The web browser 3004 may use this cached data 3004 when the user visits these sites again, so that the webpages can be loaded faster and/or so that use of the website can be more convenient.

In this example, decoy login credentials 3006 have been added to the cached data 3004. The decoy login credentials 3006 may include a username, password, and a decoy website address. The username and password, which may be encrypted, may appear to be for a legitimate user. Alternatively, the username and password may, in fact, be for a real, legitimate user of the endpoint. The decoy website address, however, may be for a website 3012 hosted by a high-interaction network 3016. The decoy website address may include only a numeric address, or the cached data 3006 may include information (e.g. a domain name) that associates the decoy website address with a real website. The website chosen may be one that potentially has valuable data, such as banking, email, and/or social media websites.

In this example, an infiltrator 3040 located outside the site network has gained access to the endpoint. For example, the infiltrator 3040 may have hacked into the endpoint, and/or may have succeeded in installing malware on the endpoint. Since the infiltrator 3040 is accessing the endpoint remotely, he would not likely have access to the endpoint's desktop 3000. The infiltrator 3040, however, may be able to find the web browser's 3002 cached data 3004, which is typically stored in a predictable location. Using, for example, malware, the infiltrator 3040 may upload the cached data 3004 to the Internet 3050. In examining the cached data 3004, the infiltrator 3040 may discover the decoy login credentials 3006, and may have the tools to decrypt the username and password. Believing he now has valid login credentials for a valid website, the infiltrator 3040 may then attempt to login to seemingly valid website, using the username and password. Unbeknownst to the infiltrator, however, the seemingly-valid website is, in fact, a decoy website 3012 hosted inside the high-interaction network 3016. The decoy website 3012 may resemble a real website in all aspects, including having the webpages and data that would be found at the decoy website 3012, were it real. Since the infiltrator 3040 believes he has logged into a real users account, the decoy website 3012 may also include user-specific data, including seemingly valuable data, though none of the data may be truly valuable. The infiltrator 3040 may thus be encouraged to explore the decoy website 3012 and possibly to steal data. The high-interaction network 3016 may capture and analyze the infiltrator's 3040, and attempt to ascertain the infiltrator's 3040 motives, method of attack, and possibly his location on the Internet 3050.

In some implementations, the endpoint may be isolated from its site network either when the infiltrator 3040 hacks into the endpoint, when the infiltrator 3040 manages to install malware on the endpoint, and/or when the cached data 3006 is uploaded from the endpoint to the Internet 3050. Alternatively, the endpoint may be isolated when the decoy website 3012 is accessed. Isolating the endpoint may include redirecting network communications between the endpoint and the site network to the high-interaction network 3015. Though the infiltrator 3040 in this example is located outside the site network, the endpoint in this example appears to have been compromised, in that the infiltrator 3040 managed to obtain the web browsers 3002 cached data 3004. The endpoint thus may need to be isolated from the site network until it has been scrubbed.

### VII. Multiphase Threat Analysis and Correlation

Understanding the course of events in an attack that lead to harm on network may be useful in better defending a network. As discussed above, a network threat detection and analysis system may include a targeted threat intelligence engine that can analyze data collected over the course of an attack, and correlate seemingly unrelated events to reconstruct how the attack occurred.

As discussed above, network traffic to and from an endpoint can be redirected to a high interaction network when it is determined that the endpoint has possibly been compromised. The high-interaction network can be configured to engage the apparent threat, to attempt to understand the threat and determine what harm is intended by the threat.

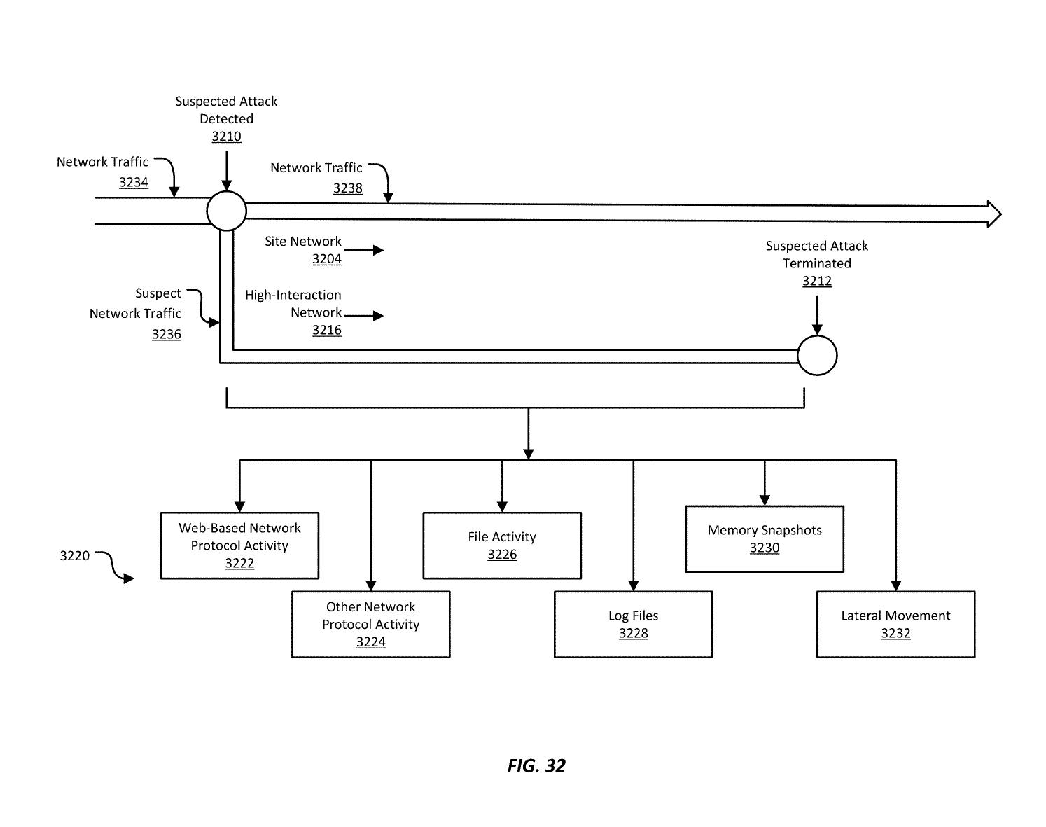

FIG. 32 illustrates examples of the data 3220 that may be captured by a high-interaction network 3216 as the high-interaction network 3216 interacts with and analyzes suspect network traffic 3236. In various implementations, a threat intelligence engine may be configured to capture data 3220 over the course of an incident. An “incident” is an attack or suspected attack on a site network. Using the high-interaction network 3216, the threat intelligence engine may be able to capture data 3220 of various types as the attack or suspected attack progresses within the high-interaction network 3216. As discussed further below, once data 3220 for the majority of the incident has been captured, the threat intelligence engine may analyze the data 3220 and determine the course of events in the incident.

Before a suspected attack is detected 3210, a large amount of network traffic 3234 may be flowing through the site network 3204. As discussed above, once a suspected attack is detected 3210, suspect network traffic 3236 may be redirected to a high-interaction network 3216, while non-suspect network traffic 3238 continues to the site network 3204. The high-interaction network 3216 may thus capture data 3220 primarily for network traffic that appears to be related to the incident, rather than for all network traffic 3234 that may be flowing through the site network 3204 during the course of the incident. A large amount of the network traffic 3234 flowing through the site network 3204 during the incident may not be relevant to the incident, and thus need not be analyzed. Some unrelated network traffic may still be redirected to the high-interaction network 3216, but by attempting to segregate suspect network traffic 3236 from other network traffic 3238, the probability that the high-interaction network 3216 receives network traffic related to the incident is increased.

Some relevant network traffic may also be missed. For example, in some cases, the suspected attack may only be detected 3210 after some events related to the attack have occurred. In these cases, the events occurring before the suspected attacked is detected 3210 may be found during correlation of events relating to the incident, which is discussed further below.

As the suspect network traffic 3236 flows through the high-interaction network 3216, in various implementations, the threat intelligence engine may not yet attempt to ascertain what the suspected attack is attempting to do and/or how it is attempting to accomplish its goal. Events occurring in real time may be difficult to relate to events that have already occurred or have not yet occurred. Furthermore, many events may be themselves may appear harmless, and can be identified as harmful only once the entire course of events can be seen. Thus the threat intelligence engine captures as much data 3220 as possible during the course of the incident, and, as discussed below, attempts to analyze the course of the incident as a whole.

The incident may occur over the course of seconds, minutes, or hours. For example, an attack may involve visiting various webpages, logging into a website, downloading content, and/or uploading content. These events may require up to several minutes. During this time, the high-interaction network 3216 may capture data 3220 of various types. This data may include web-based network protocol activity 3222, other network protocol activity 3224, file activity 3226, log files 3228, memory snapshots 3230, and lateral movement 3232. Each of these data types are described in further detail below.

The threat intelligence engine may stop capturing data once a suspected attacked has terminated 3212. The suspected attack may be considered terminated 3212 when the suspected attack has accomplished its goal, such as stealing data, installing malware, or crashing the network. Alternatively or additionally, the suspected attack may be considered terminated 3212 when it appears that the suspected attacker has left the network. Alternatively or additionally, the suspected attack may be considered terminated 3212 when a suspected attacker's access to the high-interaction network 3216 is terminated by, for example, a network administrator. Additionally, in some implementations, the threat intelligence system may continue to capture data 3220 as the effects of the suspected attack on the high-interaction network 3216 are repaired or corrected, to put the high-interaction network 3216 back into the state it was in before the suspected attack was detected 3210.

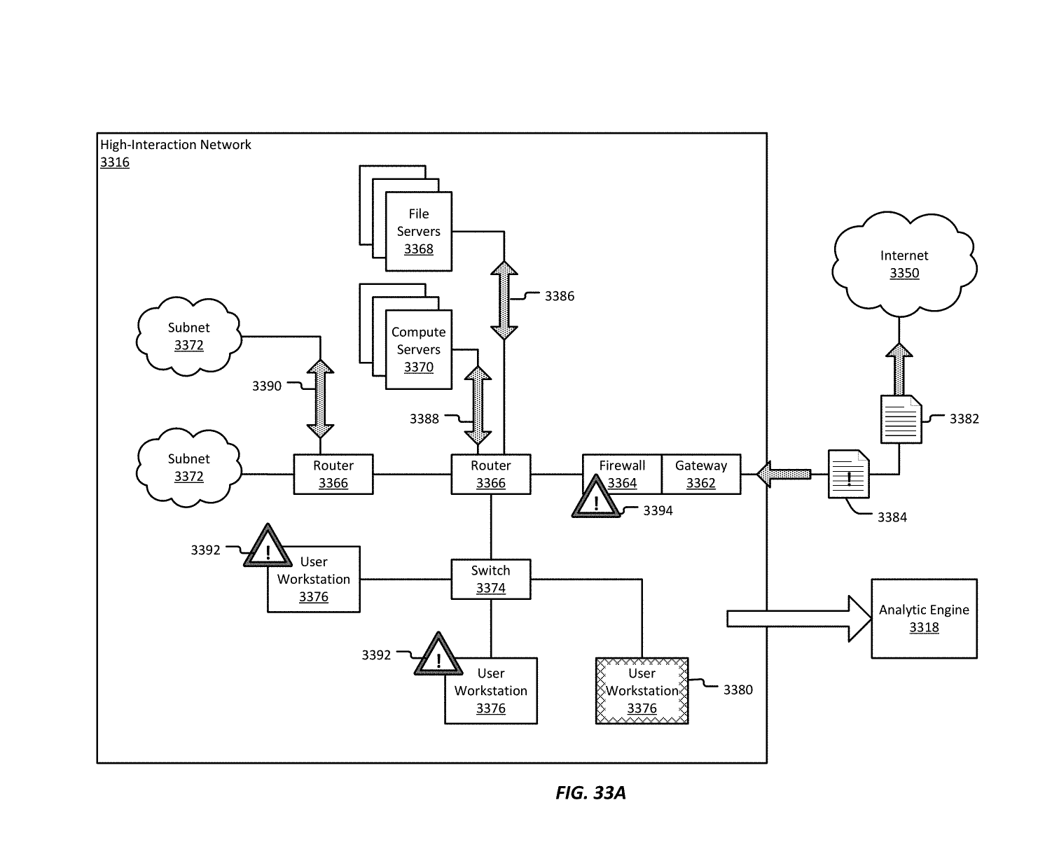

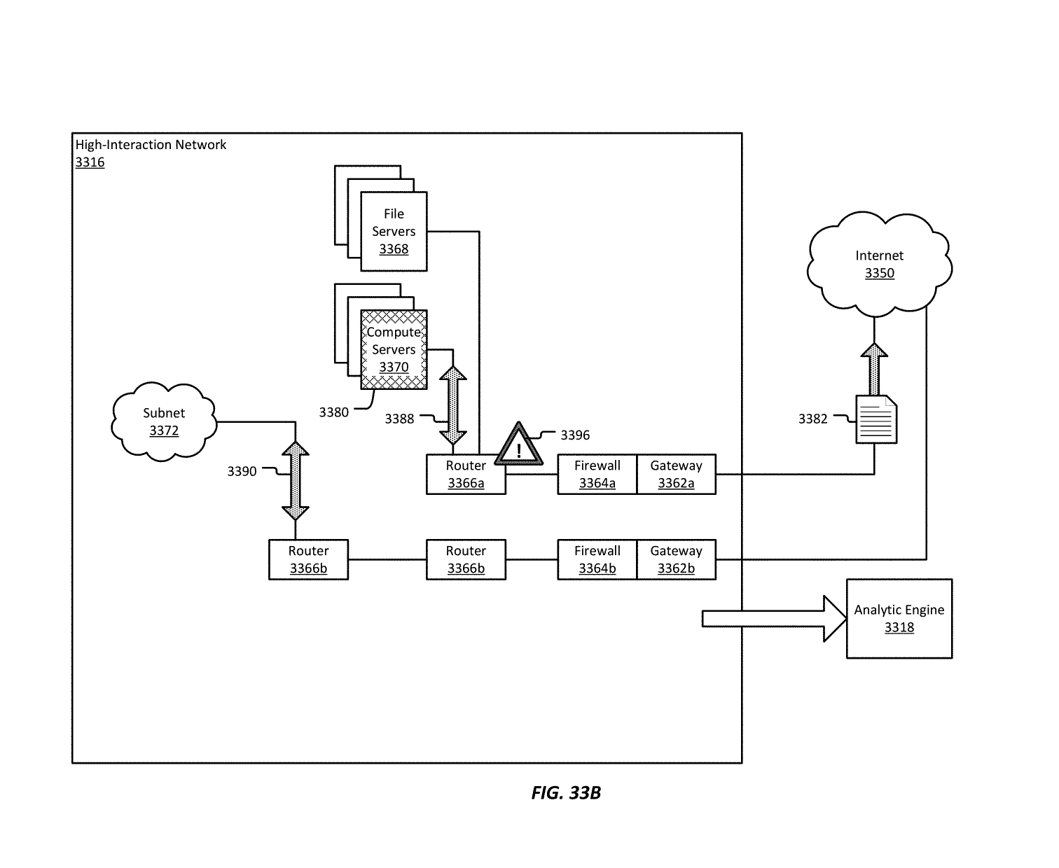

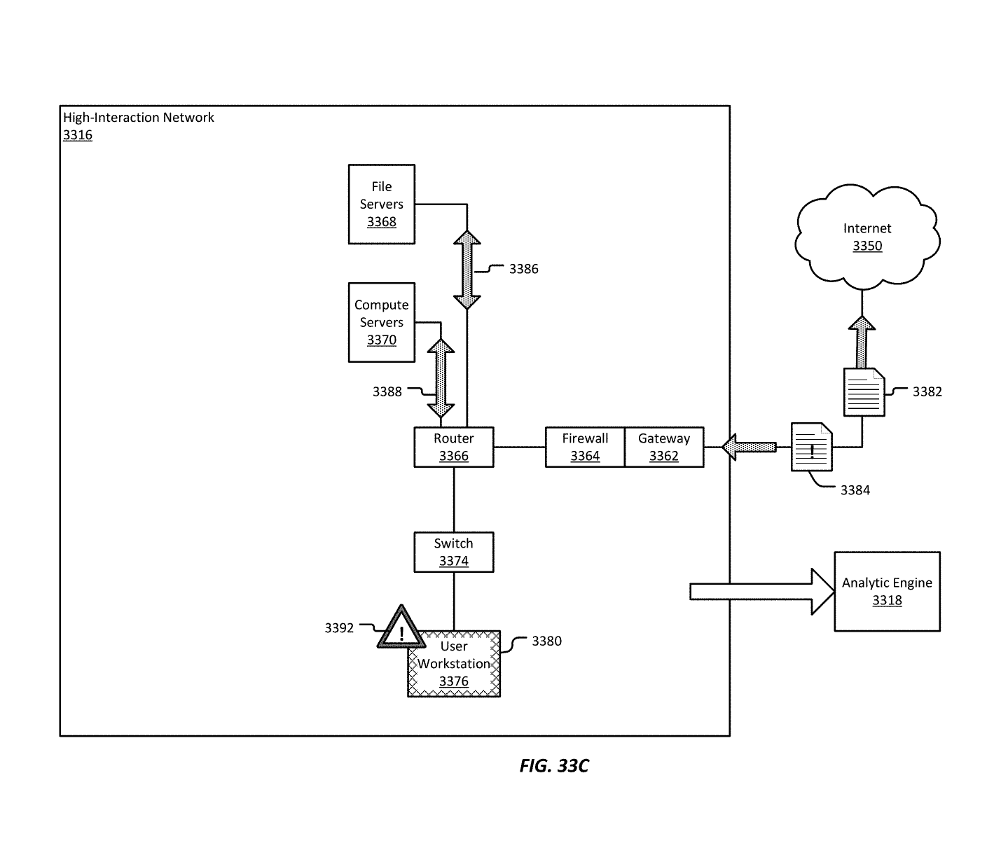

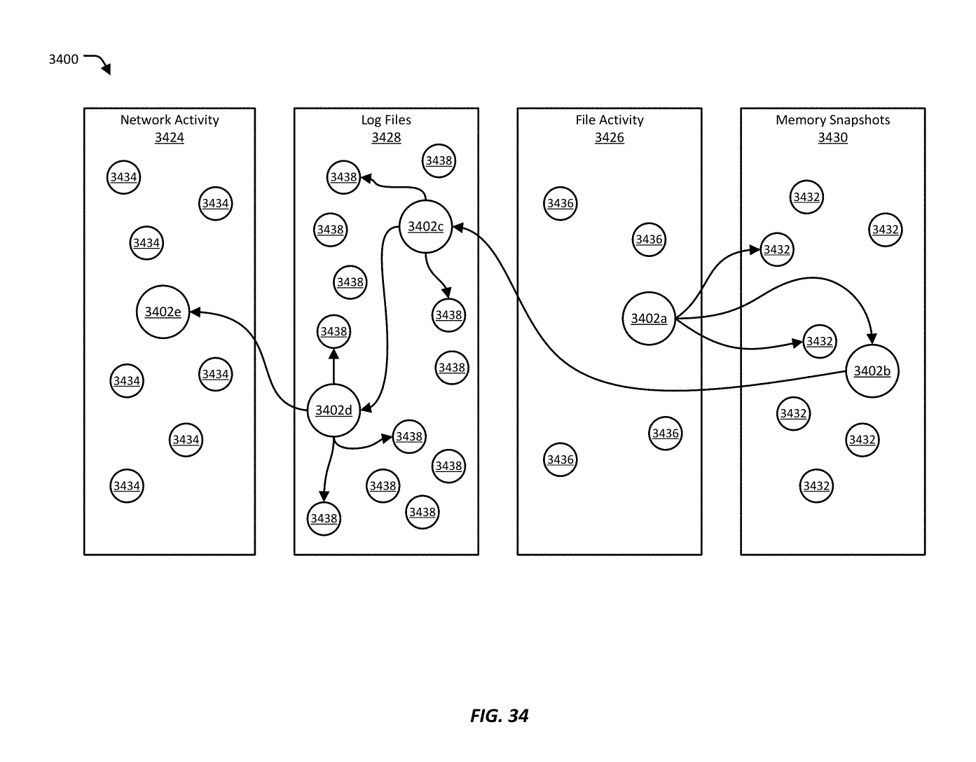

As noted above, the threat intelligence engine's high-interaction network can be configured to emulate all or part of a customer site's network. FIG. 33A illustrates one example of the configuration of a high-interaction network 3316. In this example, the high-interaction network 3316 has been configured to emulate nearly all of a site's network. Emulating all or nearly all of a site network may be useful when, for example, suspect network traffic has a potentially broad effect, or when the behavior of suspect network is particular unpredictable, or when the suspect network traffic is driven based on being fooled into believing it has infiltrated the site's real network.

In this example, the high-interaction network 3316 has been configured to emulate the site network for a particular customer site. As such, the high-interaction network 3316 of FIG. 33A includes test devices configured as routers 3366, a switch 3374, user workstations 3376, multiple servers 3368, 3370, and several subnets 3372. These user workstations 3376 may be configured just as are the user workstations in the site network, and may further include automated processes that emulate the activity of the site network's users. The servers include a group of file servers 3368 that emulate the files stored by the file servers in the site network. The servers also include a group of compute servers 3370 that provide the same processing resources provided by the compute servers in the site network. The high-interaction network 3316 may further include subnets 3372 that emulate the subnets found in the site network. The high-interaction network 3316 may further include a gateway 3362 that connects the high-interaction network 3316 to the Internet 3350, just as the site network has a gateway that connects it to the Internet. The gateway 3362 is attached to a firewall 3364, or may have an integrated firewall 3364, just as does the site network.

In some implementations, the high-interaction network 3316 may have fewer security measures than does the site network, so that the high-interaction network 3316 is more vulnerable to attack. For example, in the example illustrated in FIG. 33A, the high-interaction network 3316 does not include a network security infrastructure other than a firewall. In this example, the high-interaction network 3316 may be used to analyze the effect of suspect network traffic within the site network. In other words, the suspect network traffic can be released into what appears to be the site network as if the suspect network traffic was not caught by any network security tools. In other cases, the high-interaction network 3316 may include the network security infrastructure, for example when analyzing suspect network traffic's effect on the network security infrastructure as well as the site network.

Absence of the network security infrastructure also may make the high-interaction network 3316 more vulnerable to an attack. When suspect network traffic that constitutes a real attack is received at the site network, it is desirable to stop the attack as soon as possible, and mitigate or repair any damage it caused. But when an actual attack is stopped right away, it may not be possible to learn what the intent of the attack was and what harm may have resulted. Having this information may be useful for, for example, gaining a better understanding network vulnerabilities, finding new or existing vulnerabilities in the site network, and possibly tracking down attackers, among other things. Thus making the high-interaction network 3316 more vulnerable to attack may encourage an attack, and by encouraging an attack more may be learned about it.

Processes in the high-interaction network 3316 may analyze suspect network traffic in several ways, including conducting static, dynamic, and network analysis. Static analysis involves extracting the contents of the suspect network traffic and applying various tools to the content to attempt to identify the content, determine what the content does (if anything), and/or determine whether the content is harmless or malicious. The content of the suspect network traffic may include, for example, webpages, email, and files such as formatted documents (e.g., Microsoft® Word, Excel, or PowerPoint documents or Portal Document Format (PDF) documents), text files documents, images (e.g. Joint Photographic Experts Group (JPEG) files or Graphic Interchange Format (GIF) files), audio, video, archives (e.g., “zip,” tape archive (tar), Java archive (jar) files, etc.), or executable files, among others.

Static analysis of the content of suspect network traffic may include, for example, applying virus scanning to the content, extracting components from the content such as macros or scripts and then scanning the content, and/or opening the content using an appropriate application. Opening an executable file may trigger execution of the file, which may be conducted in a contained, emulated environment. Additionally, macros and/or scripts extracted from a file may be executed in an emulated environment. In some cases, static analysis may alternatively or additionally include deconstructing the content, including decompressing, decrypting, un-encoding, decompiling, and/or converting the content into another format, as appropriate. Subsequent to being deconstructing the content may be further analyzed to attempt to discover any hidden purpose behind the content. Malicious intent may be indicated, for example, by instructions to access password files, instructions to connect to input devices such as a keyboard or a screen, or code that attempts to exploit a vulnerability in a software application, among others. The result of the static analysis may be provided to the analytic engine 3318. The analytic engine may generate indicators describing the content, which may be referred to as static indicators. Static indicators may include, for example, the content's type (e.g., webpages, email, documents, or programs), a description of anything questionable found in the content, and/or identification information that uniquely identifies the content. In some implementations, the identification information may be a digital signature, generated, for example, by applying the MD5 algorithm, Secure Hash Algorithm 1 (SHA-1), or SHA-2 to the content. The static analysis results may also be used to drive dynamic analysis.

Dynamic analysis of the suspect network traffic involves interacting with content extracted from the suspect network traffic and monitoring and recording any activity that results from interacting with the content. For example, in some implementations, the high-interaction network 3316 may launch a virtual machine that emulates a user workstation 3376. This emulated user workstation 3376 may hereafter be referred to as the release point 3380, because it serves as the point from which the content is released. At the release point, the content may be downloaded, opened, and/or executed, as appropriate for the specific content. For example, when the content includes webpages, the webpages maybe downloaded, including downloading any graphic or executable files included in the webpages. Automated processes may then interact with the webpages, including selecting links and causing additional webpages, graphics, and/or executable files to be downloaded. Any executable files, if not automatically launched, may be launched by an automated process.

In some cases, depending on the nature of the content found in the suspect network traffic, the high-interaction network 3316 may release the content elsewhere, such as at a compute 3370 or file server 3368, or at the firewall 3364. For example, suspect network traffic that is attempting to open ports at the firewall 3364 may be more effectively released at the emulated firewall 3364.

Monitoring tools may track any calls made by programs launched by executing files found in the suspect network traffic, including calls made to an emulated operating system and/or to emulated hardware. In some cases, these calls may be harmless, while in other cases the calls may be malicious. For example, the high-interaction network 3316 may see questionable file activity. Questionable file activity may include uploading 3382 of files from the high-interaction network 3316 to the Internet 3350. Files may be uploaded 3382 from the release point 3380 by a process triggered by interacting with the content of the suspect network traffic. Questionable file activity may also include downloading of files 3384 from the Internet 3350. For example, the content may trigger downloading 3384 of malware, key logging or screen capture tools, or some other program intended to infiltrate or attack the high-interaction network 3316. Questionable file activity may also include creating, copying, modifying, deleting, moving, decrypting, encrypting, decompressing, and/or compressing files at any device in the high-interaction network 3316.

Any activity triggered by interacting with the content of suspect network traffic is recorded and delivered to the analytic engine 3318. The analytic engine may produce indicators that describe the activity and/or uniquely identify the content that triggered the activity. These indicators may be referred to as file indicators. File indicators may include, for example, a list of modified files and/or directories, a list of content uploaded 3382 to or downloaded 3384 from the Internet, and/or a digital signature identifying the content from the suspect network traffic.

The high-interaction network 3316 may also conduct network analysis of the suspect network traffic. Network analysis may include analyzing and/or interacting with network protocol-related packets in suspect network traffic, and attempting to ascertain what effect the suspect network traffic is trying to achieve. For example, the suspect network traffic may include packets attacking 3394 the firewall 3364 by attempting to use a closed port at the firewall 3364. The high-interaction network 3316 may open the closed port to allow the packets into the high-interaction network 3316, and analyze these packets as suspect network traffic. As another example, the suspect network traffic may include domain name system (DNS) packets attacking 3390 one of the subnets by attempting to ascertain IP addresses the subnets 3372. The high-interaction network 3316 may provide IP addresses of the subnet 3372, and see if any suspect network traffic is received at those IP addresses. As another example, the user workstations 3376 may be attacked 3392 by packets making repeated login attempts. The high-interaction network 3316 may allow the login attempts to succeed.

Network analysis may occur in conjunction with dynamic analysis of the contents of suspect network traffic. For example, the contents may include tools for attacking 3392 the user workstations 3376 to steal credentials. Automated processes may provide credentials, and then watch for login attempts that use those credentials. Attacks 3390, 3392, 3394 may be encouraged so that as much information as possible can be learned about, for example, how the attack is initiated, what entity is behind the attack, and/or what effect each attack has, among other things. To encourage the attacks 3390, 3392, 3394, the high-interaction network 3316 may lower security barriers, and/or may deliberately provide information for infiltrating the high-interaction network 3316.

Network analysis also looks for lateral movement that may result from suspect network traffic. Lateral movement occurs when an attack on the high-interaction network 3316 moves from one device in the network to another. Lateral movement may involve malware designed to spread between network devices, and/or infiltration of the network by an outside entity. For example, an attack 3392 on the user workstations 3376 may result in user credentials being stolen and uploaded 3382 to an outside entity on the Internet 3350. The attack 3392 may also inform the outside entity about files available on the file servers 3368 and services provided by the compute servers 3370. The high-interaction network 3316 may subsequently see an attack 3386 on the file servers 3368 that uses the stolen credentials to gain access and ransom the files. The high-interaction network 3316 may also see an attack 3388 on the compute servers 3370, using the stolen credentials, to take the compute servers 3370 offline. Each of these attacks 3386, 3388 may be considered lateral movement of an attack 3392 that started at the user workstations 3376. The lateral movement can be captured and traced, for example, through log files generated by the user workstations 3376, the gateway 3362 and firewall, and the servers 3368, 3370, and/or memory snapshots of any of these devices.

The results of the various network analysis methods are provided to the analytic engine 3318. The analytic engine 3318 may produce indicators, which may be referred to as network indicators. Network indicators may include, for example, network protocols used by the suspect network traffic and/or a trace of the network activity caused by the suspect network traffic. The network indicators may alternatively or additionally uniquely identify the suspect network traffic. The identification may include, for example, a source of the suspect network traffic, particularly when the source is distinctive (e.g., the source is not a proxy that was used to obfuscate the true source of the suspect network traffic). The identification may also include a destination within the high-interaction network that received the suspect network traffic. The source information can be used to track down the sender of the suspect network traffic. The destination information can be used to locate machines in the real network that may have been affected by the suspect network traffic. The network indicators may also describe any effect caused by the suspect network traffic, such as stolen credentials, files held for ransom, or servers being taken offline.

In some cases, suspect network traffic may be innocent. For example, the suspect network traffic may include an email with an attached image file that was poorly named (e.g. a file named “pleaseopenthis” with no extension, that is, in fact, a harmless photograph). Static analysis may identify that the attachment as an image file, where opening the file shows that the image file is, in fact, only an image file, and not hidden malware. Dynamic analysis of the email and the attached file may result in nothing happening. Network analysis of the email may result in determining that the email was from an innocent sender. The information generated from the static, dynamic, and network analysis may also be sent to the analytic engine 3318, so that the innocent network traffic can be identified as such.

FIG. 33B illustrates another example of a possible configuration of the high-interaction network 3316. In this example, the high-interaction network 3316 has been configured with only a part of the site network. This example also illustrates that the high-interaction network 3316 can be used to emulate multiple parts of the site network at the same time.

In the illustrated example, the high-interaction network 3316 has been configured with test devices emulating the file servers 3368 and the compute servers 3370. Test devices are also emulating a gateway 3362a, firewall 3364a, and one router 3366a, so that the file servers 3368 and compute servers 3370 are accessible to the Internet 3350. The high-interaction network 3316 may have been configured with only the file servers 3368 and compute servers 3370 because suspect network traffic appears to be a direct attack 3388 on the servers 3368, 3370. For example, the suspect network traffic may include an attack 3388 in the form of an exceptionally large volume of database queries to a database hosted by the compute servers 3370, accompanied by database data being uploaded 3382 to the Internet. Since the suspect network traffic in this example constitutes database queries, the release point 3380 for this suspect network traffic is an appropriate compute server 3370. Furthermore, since the attack 3388 in this example is not likely to transition to other parts of the site network, such as the user workstations, the other parts of the site network have not been emulated.

In this example, the high-interaction network 3316 is also emulating a subnet 3372, along with separate routers 3366b and a separate a firewall 3364b and gateway 3362b to provide the subnet 3372 with access to the Internet 3350. The subnet 3372 and its routers 3366b, firewall 3364b, and gateway 3362b are, in this example, not connected to the emulated hardware for the file 3368 and compute 3370 servers. The subnet 3372 and its accompanying infrastructure may be emulated separately so that suspect network traffic directed specifically at the subnet 3372 may be analyzed separate from suspect network traffic directed at the file 3368 and compute 3370 servers. Suspect network traffic directed to the subnet 3372 may constitute an attack 3390 that is unrelated to suspect network traffic directed to the file 3368 and compute 3370 servers. Hence, separate analysis may be more efficient. Separate analysis may also provide a more precise description of each stream of suspect network traffic.

Separate analysis may also lead to more efficient use of available resources. When only part of the site network is emulated, the high-interaction network 3316 may have idle resources, such as unused test devices and/or computing power. By using these resources to emulate another part of the site network, the high-interaction network 3316 can analyze more suspect network traffic at the same time. The result of the analysis provided by each individually emulated network part are provided to the analytic engine 3318 for analysis.

FIG. 33C illustrates another example of a possible configuration for the high-interaction network 3316. In this example, the high-interaction network 3316 has been configured to emulate the part of the site network that is accessible to a specific user. A user of the site network may have authorization to access only specific parts of the site network. Thus in this example, the high-interaction network 3316 has been configured with test devices emulating the specific user's workstation 3376, as well as the switch 3374, router 3366, firewall 3364, and gateway 3362 that connect the user's workstation 3376 to the Internet 3350. The high-interaction network 3316 may further be configured to with test devices emulating the one file server 3368 and one computer server 3370 that the user of this example is authorized to use.

Emulating only the part of the site network that is accessible to one user may be useful when suspect network traffic is directed at a specific user, or takes advantage of one user. For example, the user may be the target of a spoofing attack 3392. A spoofing attack 3392 may take the form of the user receiving email that appears to be from a person that the users knows, but that is, in fact, malicious email that is “spoofing,” or pretending, to be from a known person. The spoof email may further have a malicious attachment, such as a key logger. The user's workstation 3376 is treated as the release point 3380 for the spoof email: an automated process, acting as would the user, opens the email and causes the key logger to be downloaded 3384. The automated process may subsequently enter key strokes, including the user's credentials, for capture by the key logger. The key logger may then upload 3382 the user's credentials to a malicious actor on the Internet 3350. Now armed with one user's credentials, an outside actor may attack 3388 the compute server 3370 or attack 3386 files on the file server 3368, using the user's stolen credentials. All of this activity, including downloading 3384 of the key logger, uploading 3382 of the user's credentials, and lateral movement of the attack to the file 3368 and compute 3370 server may be captured and sent to the analytic engine 3318 for analysis.

In each of the various examples illustrated in FIGS. 33A-33C, the high-interaction network 3316 may collect data about the an attack that was released into the high-interaction network 3316. For example, the high-interaction network 3316 may collect web-based network protocol activity, other network protocol activity, file activity log files, memory snapshots, and/or records of lateral movement within the high-interaction network 3316. This data may include a large number of routine events, events related to the attack, and events that are unrelated to the attack. Events related to the attack may also appear to be to be harmless on their own. Thus a threat analysis engine may analyze the data, determine which events were related to the attack, and how the events relate to each other. To do this analysis, the threat analysis engine may use a correlation process.

FIG. 34 illustrates an example of a correlation process 3400. As discussed above, an analytic engine may receive, for a given incident, data 3424, 3428, 3426, 3430 of various types. In this example, the data includes network activity 3424, log files 3428, file activity 3426, and memory snapshots 3430.

The data 3424, 3428, 3426, 3430 of each type may further include many events 3434, 3438, 3436, 3432. Events are various things that occurred in the high-interaction network or on a particular emulated network device. For example, events may include files downloaded from the Internet, individual memory snapshots from a particular emulated network device, the entries in a log file, and/or packets received or sent. The data 3424, 3428, 3426, 3430 may include all the events that could be captured by the high-interaction network. Alternatively, the data 3424, 3428, 3426, 3430 may have been filtered to remove routine events, such as those related to maintenance of an emulated network device. Alternatively or additionally, the data 3424, 3428, 3426, 3430 may have been filtered to remove events known to be harmless. Even after filtering, the data 3424, 3428, 3426, 3430 may include a large number of events, many of which are probably unrelated to the attack. Additionally, many events may have been triggered by the attack, but may not have affected the ultimate outcome of the attack.

The various events 3434, 3438, 3436, 3432 may or may not be related to the attack. Some events may be malicious, but not have anything to do with the attack. Some events may be harmless by themselves, but be a direct cause of the harm intended by the attack. The correlation process 3400 attempts to connects events to each other to reconstruct the course of the attack, and ultimately to describe how the attack happened.

In the illustrated example, an attack may have resulted in servers crashing. A file analysis engine may have identified a malicious file event 3402a in the file activity 3426 data, specifically, downloading of a file identified as malware. The correlation process 3400 may thus attempt to find a connection between the malware file and the servers crashing.

In this example, the correlation process 3400 may look at memory snapshots 3430 of a crashed server. The correlation process 3400 may find that, between one snapshot and another, the crashed server suddenly ran out of memory, an event that occurred after the malware file was downloaded. The correlation process 3400 may further identify a memory event 3402b—specifically, the starting of a process that generated data—that occurred when the server started running out of memory. It may appear, at this point in the analysis, that the file event 3402a (downloading of the malware) lead to the memory event 3402b (launching of a process that consumed the memory of server), which lead to the server crashing.

The correlation process 3400 of this example may thus have determined how the servers crashed, but has not yet determined how the malware file came to be on the network in the first place. The malware may have gotten onto the network through a network vulnerability, which should be identified.

To determine how the malware file came to be on the network, the correlation process 3400, in this example, may generate a digital signature for the malware file, as an identifier for the file. The correlation process 3400 may next search log file 3428 data for the digital signature, and find a web event 3402c, here showing that the malware file was downloaded from a particular website. The website by itself may generally be safe, and the log file 3428 data may show many events 3438 related to the website. Thus, the correlation process 3400, in this example, may next search the log files for events related to both the website and the malware file. This search may locate a user event 3402d, here showing that a particular user visited the website and caused the malware file to be downloaded.

Now it may be desirable, in this example, to determine why the particular user visited the website and caused the malware file to be downloaded. While it may be possible to simply ask the particular user, the user may not be available, may not recall, may not have herself visited the website, may be a compromised account, or may be a non-existent account. Thus, as a next step in this example, may search network activity 3424 data for activity related to the particular user. In some cases, the network activity 3424 data may not have been captured as part of the incident, and may instead come from regular activity in the site network. In this example, the correlation process 3400 may identify a network event 3402e for this specific user, here identifying an email received by the use that contained a link to the website from which the malware was downloaded. The email may have been received by a trusted sender, and otherwise not have been flagged as suspect.

The correlation process 3700 may now have sufficient information to describe how the attack happened: first, a user received an innocent email with a link; second, the user followed the link to an otherwise legitimate website; third, following the link caused the malware file to be downloaded; fourth, the malware file launched processes that overloaded the memory of several servers, causing the servers to crash. The correlation process 3700 can further generate an incident report for this example attack. The incident report may include an indicator that describes each of the events in the attack.

Another example of a correlation process may include analysis of incident data collected from releasing suspect network traffic in a high-interaction network and data collected from the site network itself. In this example, the site network may have received an email, where the address of the sender of the email is a decoy email address. A decoy email address is an email address configured by a network security system to resemble an email address that could be used by a user of the site network, but which is, in fact, not presently in use. For example, decoy email addresses can be configured using the names of past employees, or variations of the names of present employees. In various implementations, decoy email addresses may be added to the email address books of legitimate users. Alternatively or additionally, decoy email addresses can be added to address books on emulated network devices that are acting as deceptions.

Generally, decoy email addresses are not used by legitimate users or processes in a site network. Thus, receiving an email that includes a decoy email address as the sender address automatically makes the email suspect. The email may be particularly suspect when it includes links and/or attachments. A suspect email with a decoy email address as the sender address may thus be routed to the threat intelligence system for analysis.

The threat intelligence system may generate incident data for the suspect email by detonating the email in the high-interaction network. Detonating the email may include following a link, executing an attachment, and/or analysis of a header part of the email. The incident data may show, for example, that detonating the email caused the user workstation at which the email was detonated to send emails to each address in an address book stored on the user workstation, where these emails each included the same suspect link and/or attachment. In other words, the incident data may show that the suspect email replicated and distributed itself, sending itself to each of the addresses in the address book.

Having learned the manner and mode of attack that could be triggered by the suspect email, the threat analysis engine may next attempt to correlate the events that lead to the initial receipt of the suspect email. For example, the threat analysis engine may determine which network devices in the site network had address books that included the decoy email address. Alternatively or additionally, the threat analysis engine may examine the path information in the suspect email's header to identify where the suspect email came from. The threat intelligence engine may next determine whether any network device in the site network received an email similar to the suspect email, and/or whether any network device sent a similar email to each of the addresses in the network device's own address book. From this information, the threat intelligence engine may be able to determine which specific network device or devices were the source of the suspect email. The threat intelligence engine may then produce an incident report, describing the manner of the attack and possibly also identifying where the suspect email came from initially.

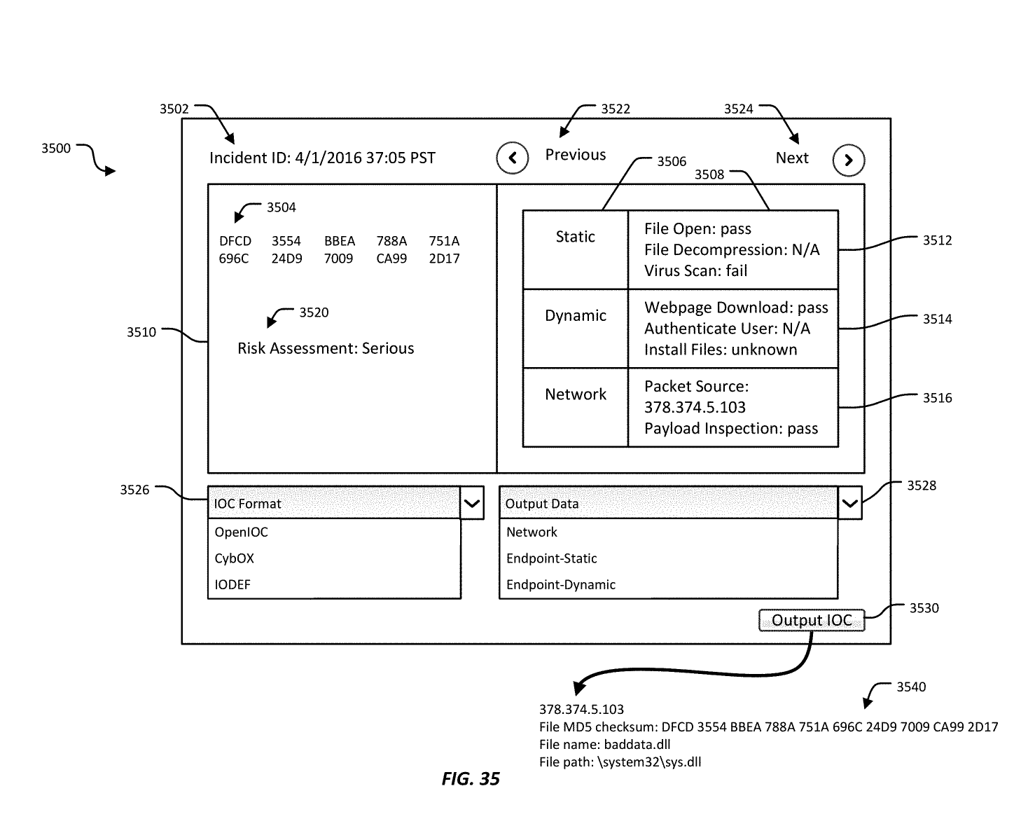

FIG. 35 illustrates an example of the information that may be available in an incident report, and how the information may be provided to a network administrator. FIG. 35 illustrates an example of a user interface 3500. The user interface 3500 may provide a way to display an incident report, search and view an incident report, and to produce indicators of compromise, which may be used to defend a network from a similar attack.

An incident report may include an incident identifier 3502. The incident identifier 3502 may be a time and/or date stamp, and/or a string (e.g. “michaelangelo”) that can be used to identify and/or describe the attack. The incident identifier 3502 may be used by the network security community to identify the attack should it appear in other networks.

The user interface 3500 in this example includes a display area 3510 for displaying the incident timeline, and individual events in the incident. In this example, the display area 3510 displays, on the left-hand side, an event identifier 3504, which may uniquely identify a particular event. In this example, an MD5 hash is used as the event identifier 3504. The left side of the display area 3510 also displays a risk assessment 3520 for the event. In various implementations, the user interface 3500 may also display a risk assessment for the whole incident.

The right-hand side of the user interface 3500 of this example displays tests 3508 run for each analysis type 3506, possibly also with each test's result. As discussed above, the threat analysis engine may conduct static 3512, dynamic 3514, and network 3516 analysis on a particular piece of data from suspect network traffic. Each analysis type 3506 may further various tests 3508. The user interface 3500 may display the results of each of these tests.

The user interface 3500 of this example may also provide a “Previous” button 3522 to display a preceding event and a “Next” button 3524 to display the next event.

The user interface 3500 of this example may also enable a network administrator to obtain indicators of compromise 3540 that describe one or multiple events. In this example, the user interface 3500 includes a dropdown menu 3526 that allows the network administrator to select a format for the indicators of compromise 3540. The formats may be those used by various network security companies, such as McAfee® and Symantec™, or various open source formats. The user interface 3500 may also include a dropdown menu 3528 that allows the network administrator to select which data to include in the indicators of compromise 3540. The user interface 3500 may further include a button 3530 that will cause the indicators of compromise 3540 to be generated.

As noted, the indicators of compromise 3540 may be formatted to include information used by antivirus tools, malware detectors, spam filters, and other network security tools. In this example, the indicators of compromise include an identity of the threat actor (here, the IP address of a website), and data related to a malicious file (here, a digital signature for the file, the name of the file, and where the file was found at the conclusion of the attack).

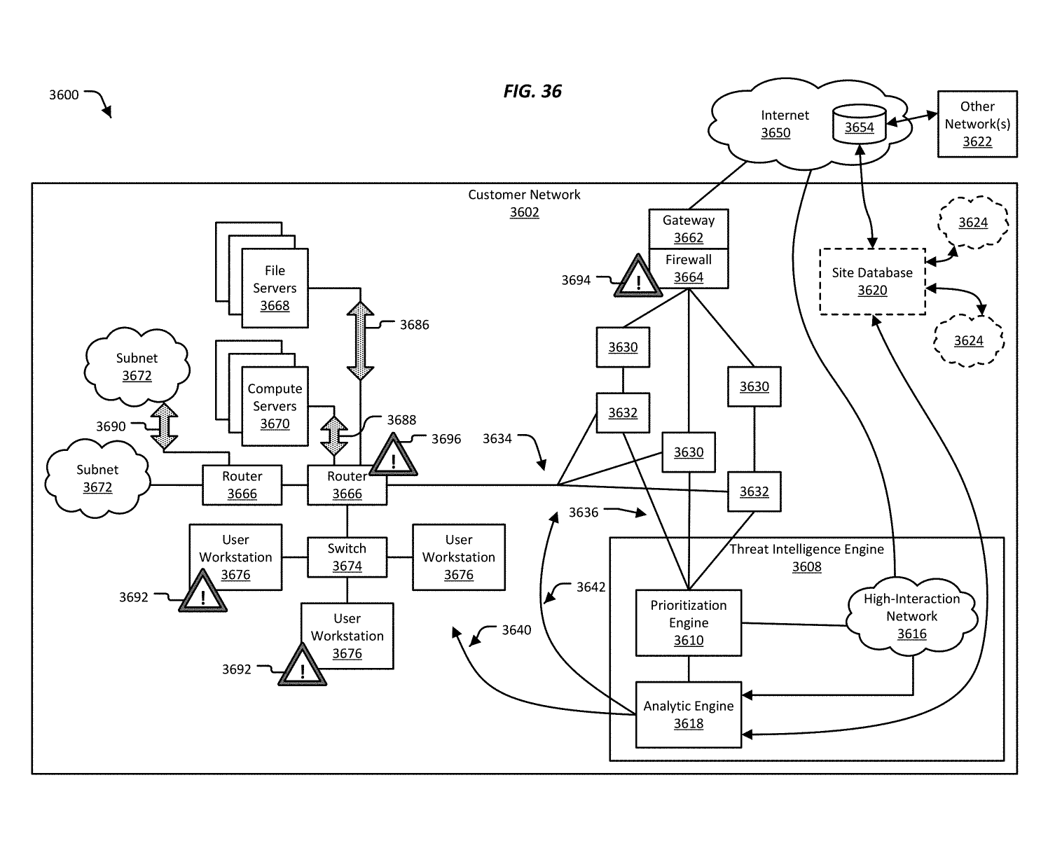

In addition to being provided to a network administrator, the indicators generated for an incident may be added to an indicators database. A threat intelligence engine may use the indicators in the indicators database in various ways. FIG. 36 illustrates examples of ways in which the threat intelligence engine 3608 may use indicators generated by its analytic engine 3618. FIG. 36 illustrates an example of a customer network 3602 that includes a threat intelligence engine 3608. The customer network 3602 in this example includes a gateway 3662 for communicating with other networks, such as the Internet 3650. The gateway 3662 may include an integrated firewall 3664, or may be attached to a firewall 3664 device. Generally, all network traffic coming into or going out of the customer network 3602 passes through the gateway 3662 and firewall 3664.

The firewall 3664 generally controls what network traffic can come into and go out of the customer network 3602. The customer network 3602 in this example includes additional network security tools 3630, 3632, such as anti-virus scanners, IPS, IDS, and others. The network security tools 3630, 3632 may examine network traffic coming into the customer network 3602, and allow network traffic that appears to be legitimate 3634 to continue to the site's network. The network security tools 3630, 3632 may direct suspect network traffic 3636 to the threat intelligence engine 3608.

The site network is where the hardware, software, and internal users of the customer network 3602 can be found, and where the operations of the customer network 3602 occur. In this example, the site network includes several routers 3666 that connect together a switch 3674, a group of file servers 3668, a group of compute servers 3670, and several subnets 3672. The switch 3674 further connects several user workstations 3676 to the site network.

As discussed above, the threat intelligence engine 3608 examines suspect network traffic and attempts to determine whether the suspect network traffic may, in fact, be malicious. The threat intelligence engine 3608 in this example includes a prioritization engine 3610, a high-interaction network 3616, and an analytic engine 3618. The prioritization engine 3610 analyzes suspect network traffic 3636 and attempts to determine whether the suspect network traffic 3636 represents a known threat. When the suspect network traffic 3636 is associated with a known threat, then the threat intelligence engine 3608 may log the occurrence of the suspect network traffic 3636, and do nothing more. In some implementations, the threat intelligence engine 3608 may be configured to provide suspect network traffic 3636 associated with a known threat to the high-interaction network 3616 for analysis. Doing so may be useful, for example, to see how well the customer network 3602 can handle the known threat.

Suspect network traffic 3636 that is not associated with a known threat may be provided to the high-interaction network 3616 to attempt to determine if the suspect network traffic 3636 constitutes a threat, and if so, what the nature of the threat is. Within the high-interaction network 3616, the suspect network traffic 3636 may be allowed to do whatever harm it was designed to do. The suspect network traffic 3636, or an entity that is driving the suspect network traffic 3636, may further be encouraged to act, for example by lowering security barriers within the high-interaction network 3616 and/or surreptitiously leaking credentials to the entity.

Any activity triggered by the suspect network traffic 3636 inside the high-interaction network 3616 may be recorded and provided to the analytic engine 3618. The analytic engine 3618 may analyze the recorded activity and generate indicators to describe and/or identify the suspect network traffic 3636, as described above.

The threat intelligence engine 3608 may use the indicators in several ways. For example, in some implementations, the threat intelligence engine 3608 may use the indicators to verify 3640 whether the site network has already been compromised. The site network may already be compromised if it has previously received suspect network traffic 3636 that has been analyzed by the threat intelligence engine 3608. For example, the threat intelligence engine 3608 may find that a virus 3692 has been downloaded to the user workstations 3676. Indicators may inform the threat intelligence engine which workstations 3676 to check, and where to find the virus. The indicators may further show that the virus was downloaded through interactions by the workstations' 3676 users, for example, with a malicious website.

As another example, the threat intelligence engine 3608 may find that ports at the firewall 3664 have been opened 3694. The threat intelligence engine 3608 may further find that a router's 3666 configuration has been changed 3696, making the site network accessible to an outside actor. Indicators may inform the threat intelligence engine 3608 to check the firewall 3664 and router 3666 for these changes.

As another example, the threat intelligence engine 3608 may be able to use indicators to trace lateral movement that was captured in the high-interaction network 3616. For example, the threat intelligence engine 3608 may, based on theft of credentials at a user workstation 3676, look for unauthorized access 3688 to resources provided by the compute servers 3670. The threat intelligence engine 3608 may also look for unauthorized access to the file servers 3668, and unauthorized downloading 3686 of files from the file servers 3668. The threat intelligence engine 3608 may further look for unauthorized logins 3690 into a subnet 3672.

Another way in which the threat intelligence engine 3608 may use the indicators is to update 3642 the network security tools 3630, 3632. For example, the threat intelligence engine 3608 may identify malware that is not known to an anti-virus tool, may find malicious IP addresses or websites that should be blocked by the firewall, or may identify attached files that should be removed from incoming network traffic.

In some implementations, the threat intelligence engine 3608 may also send its indicators to a site database 3620. The customer network 3602 may have a site database 3620 when the customer network 3602 has multiple additional site networks 3624. Each of these site networks 3624 may be provided with its own threat intelligence engine. The individual threat intelligence engines may also provide indicators to the site database 3620. Indicators from different site networks 3624 may be shared between the site networks 3624. Each site network may thereby be defended against attacks that it has not yet experienced.

In some implementations, the threat intelligence engine 3608 may also send its indicators to a central database 3654 located on the Internet 3650. In implementations that include a site database 3620, the site database 3620 may send indicators for all of the customer network 3602 to the central database 3654. The central database 3654 may also receive indicators from other networks 3622. The central database 3654 may share the indicators from the other networks 3622 with the customer network's 3602 threat intelligence engine 3608. By sharing indicators between the other networks 3622 and the customer network 3602, all of the networks 3602, 3622 may be made more secure.

Specific details were given in the preceding description to provide a thorough understanding of various implementations of systems and components for network threat detection and analysis. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for network threat detection and analysis.

As used below, any reference to a series of examples is to be understood as a reference to each of those examples disjunctively (e.g., “Examples 1-4” is to be understood as “Examples 1, 2, 3, or 4”).

Example 1 is a method, the method comprising monitoring, by a network device on a network, access to the network device. The method further includes determining that a condition has occurred, wherein the condition indicates a suspect access to the network device. The method further includes causing communication between the network device and the network to be redirected to a high-interaction network, wherein redirecting disables communication between the network device and the network and enables communication between the network device and the high-interaction network.

Example 2 is the method of examples 1, wherein the condition includes modification of an access privilege, wherein the modification increases the access privilege.

Example 3 is the method of examples 1-2, wherein the condition includes use of a decoy password at the network device.

Example 4 is the method of examples 1-3, wherein the condition includes installation of administrative tools on the network device.

Example 5 is the method of examples 1-4, wherein the condition includes remote execution of code to gain access to the network device.

Example 6 is the method of examples 1-5, wherein causing the communication between the network device and the network to be redirected includes directing a network interface of the network device to redirect the communication.

Example 7 is the method of examples 1-6, wherein causing the communication between the network device and the network to be redirected includes transmitting a request from the network device, the request including instructions to redirect the communication.

Example 8 is the method of examples 1-7, wherein the suspect access occurred at the network device.

Example 9 is the method of examples 1-8, wherein the suspect access occurred over the network device's connection to the network.

Example 10 is the method of examples 1-9, wherein the network device includes a kernel process for monitoring access to the network device, determining that a condition has occurred, and causing communication between the network device and the network to be redirected.

Example 11 is a network device, which includes one or more processors and a non-transitory computer-readable medium. The non-transitory compute readable medium includes instructions that, when executed by the one or more processors, cause the one or more processors to perform operations according to the method(s) of examples 1-10.

Example 12 is a computer-program product tangibly embodied in a non-transitory machine-readable storage medium, including instructions that, when executed by one or more processors, cause the one or more processors to perform steps according to the method(s) of examples 1-10.

Example 13 is a method, the method, comprising monitoring, by a network device on a network, access to a second network device on the network, wherein the network device is configured to control communication between the second network device and the network.

The method further includes detecting a suspect access to the second network device. The method further includes redirecting communication between the second network device and the network to a high-interaction network, wherein redirecting disables communication between the second network device and the network.

Example 14 is the method of examples 13, wherein the suspect access occurred at the second network device.

Example 15 is the method of examples 13-14, wherein the suspect access occurred over the second network device's connection to the network.

Example 16 is the method of examples 13-15, wherein redirecting communication between the second network device and the network includes enabling communication between the second network device and the high-interaction network.

Example 17 is the method of examples 13-16, wherein redirecting communication between the second network device and the network includes determining that the suspect access originated in another network connected to the network. The method further includes redirecting communication related to the suspect access to the high-interaction network.

Example 18 is the method of examples 13-17, wherein detecting a suspect access includes detecting modification of an access privilege at the second network device, wherein the modification increases the access privilege.

Example 19 is the method of examples 13-18, wherein detecting a suspect access includes detecting use of a decoy password at the second network device.

Example 20 is the method of examples 13-19, wherein detecting a suspect access includes detecting installation of administrative tools on the second network device.

Example 21 is the method of examples 13-20, wherein detecting a suspect access includes detecting remote execution of code at the second network device.

Example 22 is the method of examples 13-21, wherein the second network device includes decoy data, and wherein detecting a suspect access includes detecting access to the decoy data.

Example 23 is a network device, which includes one or more processors and a non-transitory computer-readable medium. The non-transitory compute readable medium includes instructions that, when executed by the one or more processors, cause the one or more processors to perform operations according to the method(s) of examples 13-22.

Example 24 is a computer-program product tangibly embodied in a non-transitory machine-readable storage medium, including instructions that, when executed by one or more processors, cause the one or more processors to perform steps according to the method(s) of examples 13-22.

Example 25 is a method, the method comprising configuring, by a network device, decoy data for the network device, wherein the decoy data includes a file, a directory, a link, or an application. The method further comprises associating the decoy data with a high-interaction network, wherein access to the decoy data is redirected to data in the high-interaction network. The method further comprises monitoring access to the decoy data.

Example 26 is the method of examples 25, wherein the decoy data includes a link, wherein the link identifies a file in the network, and wherein the link links to a file in the high-interaction network.

Example 27 is the method of examples 25-26, wherein the decoy data includes a shared directory, where shared directory identifies a directory in the network, and wherein the shared directory is a directory in the high-interaction network.

Example 28 is the method of examples 25-27, wherein the decoy data includes a link to an application for logging into a virtual private network, wherein the link identifies a virtual private network in the network, and wherein the virtual private network logged into by the application is in the high-interaction network.

Example 29 is the method of examples 25-28, wherein the decoy data includes a link to an application for logging into a remote desktop, wherein the link identifies a remote desktop on a server in the network, and wherein the remote desktop logged into by the application is on a server in the high-interaction network.

Example 30 is the method of examples 25-29, wherein the decoy data includes an application. In this example, the method further includes detecting an access to the network device using a decoy password. The method further includes redirecting the access to the application, wherein the application directs activity resulting from the access to the high-interaction network.

Example 31 is the method of examples 25-30, wherein the decoy data includes a decoy username, decoy password, and a website address, wherein the decoy password, decoy username, and website address are stored in the data for a web browser application on the network device, and wherein accessing the website, using the web browser application, decoy username, and decoy password, connects the web browser application to a website in the high-interaction network.

Example 32 is the method of examples 25-31, wherein the decoy data includes a username, password, and decoy website address, wherein the username and password are credentials for logging into the decoy website address, and wherein the decoy website address is for a decoy website in the high-interaction network.

Example 33 is the method of examples 25-32, wherein the username, password, and decoy website address are stored in the data for a web browser.

Example 34 is the method of examples 25-33, wherein monitoring access to the decoy data includes detecting an access to the decoy data. In this example, the method further includes causing communication between the network device and the network to be redirected to the high-interaction network, wherein redirecting disables communication between the network device and the network and enables communication between the network device and the high-interaction network.

Example 35 is the method of examples 25-34, wherein causing the communication between the network device and the network to be redirected includes directing a network interface of the network device to redirect the communication.

Example 36 is the method of examples 25-35, wherein causing the communication between the network device and the network to be redirected includes transmitting a request from the network device, the request including instructions to redirect the communication.

Example 37 is a network device, which includes one or more processors and a non-transitory computer-readable medium. The non-transitory compute readable medium includes instructions that, when executed by the one or more processors, cause the one or more processors to perform operations according to the method(s) of examples 25-36.

Example 38 is a computer-program product tangibly embodied in a non-transitory machine-readable storage medium, including instructions that, when executed by one or more processors, cause the one or more processors to perform steps according to the method(s) of examples 25-36.

What is claimed is:

1. A method, comprising:
monitoring, by a network device on a network, access to the network device;
determining that a condition has occurred, wherein the condition indicates a suspect access to the network device;
determining a new access protocol for the network device; and
using the new access protocol to cause communication between the network device and the network to be redirected to a high-interaction network, wherein redirecting disables communication between the network device and the network and enables communication between the network device and the high-interaction network.

2. The method of claim 1, further comprising:
configuring decoy data for the network device, wherein the decoy data includes a file, a directory, a link, or an application; and
associating the decoy data with a high-interaction network, wherein access to the decoy data is redirected to data in the high-interaction network.

3. The method of claim 1, wherein determining that a condition has occurred includes receiving a message over the network.

4. The method of claim 1, wherein determining the new access protocol includes receiving the new access protocol over the network.

5. The method of claim 1, wherein an access control controls external access to the network device.

6. The method of claim 1, wherein an access control controls access by the network device to the network.

7. The method of claim 1, wherein causing the communication between the network device and the network to be redirected includes directing a network interface of the network device to redirect the communication.

8. The method of claim 1, wherein causing the communication between the network device and the network to be redirected includes transmitting a request from the network device, the request including instructions to redirect the communication.

9. A network device on a network, comprising:
one or more processors; and
a non-transitory computer-readable medium including instructions that, when executed by the one or more processors, cause the one or more processors to perform operations including:
monitoring access to the network device;
determining that a condition has occurred, wherein the condition indicates a suspect access to the network device;
determining a new access protocol for the network device; and
using the new access protocol to cause communication between the network device and the network to be redirected to a high-interaction network, wherein redirecting disables communication between the network device and the network and enables communication between the network device and the high-interaction network.

10. The network device of claim 9, wherein the non-transitory computer-readable medium further includes instructions that, when executed by the one or more processors, cause the one or more processors to perform operations including:
configuring decoy data for the network device, wherein the decoy data includes a file, a directory, a link, or an application; and
associating the decoy data with a high-interaction network, wherein access to the decoy data is redirected to data in the high-interaction network.

11. The network device of claim 9, wherein the instructions for determining that a condition has occurred include instructions that, when executed by the one or more processors, cause the one or more processors to perform operations including:
receiving a message over the network.

12. The network device of claim 9, wherein the instructions for determining the new access protocol include instructions that, when executed by the one or more processors, cause the one or more processors to perform operations including:
receiving the new access protocol over the network.

13. The network device of claim 9, wherein an access control controls external access to the network device.

14. The network device of claim 9, wherein an access control controls access by the network device to the network.

15. The network device of claim 9, wherein the instructions for causing the communication between the network device and the network to be redirected include instructions that, when executed by the one or more processors, cause the one or more processors to perform operations including:
directing a network interface of the network device to redirect the communication.

16. The network device of claim 9, wherein the non-transitory computer-readable medium further includes instructions that, when executed by the one or more processors, cause the one or more processors to perform operations including:
transmitting a request from the network device, the request including instructions to redirect the communication.

17. A computer-program product tangibly embodied in a non-transitory machine-readable storage medium, including instructions that, when executed by one or more processors, cause the one or more processors to:
monitor access to a network device on a network;
determine that a condition has occurred, wherein the condition indicates a suspect access to the network device;
determine a new access protocol for the network device; and
use the new access protocol to cause communication between the network device and the network to be redirected to a high-interaction network, wherein redirecting disables communication between the network device and the network and enables communication between the network device and the high-interaction network.

18. The computer-program product of claim 17, further comprising instructions that, when executed by the one or more processors, cause the one or more processors to:
configure decoy data for the network device, wherein the decoy data includes a file, a directory, a link, or an application; and
associate the decoy data with a high-interaction network, wherein access to the decoy data is redirected to data in the high-interaction network.

19. The computer-program product of claim 17, wherein the instructions for determining that a condition has occurred include instructions that, when executed by the one or more processors, cause the one or more processors to:
receive a message over the network.

20. The computer-program product of claim 17, wherein the instructions for determining the new access protocol include instructions that, when executed by the one or more processors, cause the one or more processors to:
receive the new access protocol over the network.
